(19) United States
(12) Patent Application Publication
(10) Pub. No.: US 2026/0159717 A1
(43) Pub. Date: Jun. 11, 2026

(54) Sulfur-Containing Surface Polymers

(71) Applicant: Yield Engineering Systems, Inc., Fremont, CA (US)

(72) Inventors: Nicolaj Inunnguaq Jessen, Hinnerup (DK); Jakob Pagh Nikolajsen, Horning (DK); Joydeb Mandal, Lystrup (DK)

(21) Appl. No.: 19/410,608

(22) Filed: Dec. 5, 2025

Related U.S. Application Data
(60) Provisional application No. 63/729,101, filed on Dec. 6, 2024.

(51) Int. Cl. C09D 133/14; C08F 8/12; C08F 8/34; C08F 8/42; C09D 133/10; C09D 133/12

(52) U.S. Cl. CPC C09D 133/14; C08F 8/12; C08F 8/34; C08F 8/42; C09D 133/10; C09D 133/12; C08F 2810/20; C08F 2810/50

(57) ABSTRACT

Disclosed herein are surface polymers having sulfur in at least some of the repeating units of the surface polymer. The sulfur-containing surface polymers may provide binding to metals, and/or facilitate self-healing surface polymer coatings. The sulfur-containing surface polymers may be useful in certain applications.

### CROSS-REFERENCE TO RELATED APPLICATIONS

This application claims the benefit of U.S. Provisional Patent Application No. U.S. 63/729,101, titled “Sulfur-Containing Surface Polymers”, filed Dec. 6, 2024, the entire contents of which is incorporated by reference herein.

### FIELD

Disclosed herein are surface polymers having sulfur in at least some of the repeating units of the surface polymer. The sulfur-containing surface polymers may provide binding to metals, and/or facilitate self-healing surface polymer coatings. The sulfur-containing surface polymers may be useful in certain applications.

### BACKGROUND

Forming polymeric structures on surfaces have become increasingly important in many technologies and applications. “Surface polymers”, “surface bound polymers” or “polymers on a surface” all describe a polymeric structure having polymer chains that are chemically bonded to a surface at one end through covalently bound polymerization initiators. Two methods, known by persons skilled in the art, can be used to achieve such polymeric structure, namely the “grafting to”-approach and the “grafting from”-approach (see FIG. 1 and FIG. 2). In the “grafting to”-approach (FIG. 1), polymers are pre-prepared in solution and then deposited onto the surface in question, since the pre-prepared polymers are designed in such a way that one of the chain-ends has some affinity for the surface of interest. Upon contact with the surface of interest, the polymers will self-assemble on said surface forming surface bound polymers. In the “grafting from”-approach (FIG. 2), small molecules capable of acting as polymerization initiators are covalently bound to the surface of interest in a pre-polymerization step. Subsequently, polymerization is initiated via the polymerization initiators bonded on the surface. Accordingly, surface polymers are formed from the surface monomer-by-monomer.

While the “grafting to” approach allows for simple preparation procedures and detailed characterization, in that one can prepare the polymers using conventional polymerization methods that can maintain the bonding-to-surface property at the one end of the pre-formed polymer, before initiating the self-assembly procedure, the “grafting to”-approach lacks the ability to form high density surface bound polymeric structures nor flexibility in polymer structures, composition, etc. Main equilibrium conformation of long polymeric structures in solution is a contracted, or a coiled polymer chain, unless the polymer solution is extremely diluted with highly solvating solvent or other means employed to stabilize extended conformation (e.g., pH for ionic polymers). Such extra means to stabilize extended polymer chain conformation may complicate and interfere with the “grafting to” process conditions and make the approach less practical. Therefore, the self-assembly process is being halted by the steric repulsion between the coils of pre-made polymer chains as they self-assemble on the surface leading to loosely packed polymer coils on the surface (see FIG. 1). The “grafting from”-approach allows for the formation of highly dense surface bound polymer structures, as the small initiating molecules can form a much more densely packed layer on the surface (compared to large polymer molecules, see FIG. 2). Such a densely packed layer of initiating molecules is guiding monomer molecule-by-monomer molecule formation of polymer chains, where the extended conformation of growing polymer chains is sterically stabilized by their close proximity to each other. As such, the surface bound polymer structure formed by a “grafting from” approach results in a much higher density of polymer chains. Additionally, as the “grafting from”-approach allows for highly dense surface bound polymer structures, a brush-like structure can be achieved, thus, the name “polymer brush”. In these structures, the polymers are stretched and forced to stand upright due to the steric repulsion between neighboring polymers creating a unique structure known by people skilled in the art as a “polymer brush” structure. On surfaces, these structures are tethered/attached, usually covalently, at one end to the surface, typically to a solid or semisolid surface, thereby differing from polymers formed in solution and subsequently deposited onto a surface.

As mentioned above, surface polymers are prepared by one of the following two main strategies: “grafting to” or “grafting from”. In the “grafting to”-approach, polymer chains are deposited onto the surface in question. The “grafting to”-approach suffers from several drawbacks and limitations making it difficult to produce thick and dense surface polymers. In the “grafting from”-approach, the surface polymer growth (surface polymer chain propagation, extension of the chain by monomer units) is initiated from initiator-functionalized surfaces, using, for example, a controlled/“living” polymerization technique, such as anionic polymerization, cationic polymerization, ring-opening polymerization, and controlled radical polymerization.

Surface polymers within the present context are, thus, polymeric structures having polymer chains that are chemically bonded to a surface at one end via polymerization initiators. Such polymers may be tailored to provide specific chemical and/or physical properties and may produce precisely tailored chemical structures on a molecular scale. They may be used, for example, for storing certain chemical species, controlling transport properties, improving surface stability and properties, creating an interface in which dissimilar materials can bind or interact, and other functions. Surface polymers may subsequently join otherwise incompatible materials such as metals and plastics and improve adhesion between such otherwise incompatible materials (see, e.g., WO 2014/075695 A1).

Different polymerization techniques have facilitated the specific design and synthesis of surface polymers with strict molecular control and desired properties. In particular, the surface polymers can be viewed as nanoscale “building blocks” with a wide range of uses, varying from redox activity to biocompatibility and surface alteration, and due to the flexibility of the surface polymers, highly tailored thin films of surface polymers can be created with respect to chemical composition, thickness, density and architecture.

Thus, specific applications may require specific design of surface polymers. Such design of surface polymers may result in improved surface properties.

### SUMMARY

In an aspect, the present disclosure relates to a surface polymer comprising a plurality of repeating units, wherein some of the plurality of repeating units may comprise a sulfur-containing group. The surface polymer may be such, wherein the sulfur-containing group is a polysulfide group, a thiol group, a thioether group, a thionoester group, or a thioester group. The sulfur-containing group may be expressed by the formula (I); RR′ (I), wherein RR′ is covalently bound to the surface polymer, and wherein R is selected from —(S)ₙ, wherein n is an integer from 1 to 8, —S—C(O), or —C(S)—O, with R′ being selected from a bond (“−”), —H, —CH₃, —CH₂CH₃, —CH₂CH₂OH, and —C(O)—. When the sulfur-containing group is a polysulfide, such may be expressed by the formula (Ia): —(S)ₙ— (Ia), corresponding to formula (I) with R being —(S)ₙ, where n=2 to 8, and R′ being a bond. When the sulfur-containing group is a thiol group, such may be expressed by the formula (Ib): —S—H (Ib), corresponding to formula (I) with R being —(S)ₙ (n=1), and R′ being —H. When the sulfur-containing group is a thioether, such may be expressed by the formula (Ic): —S—CH₂CH₃ (Ic), corresponding to formula (I) with R being —(S)ₙ (n=1), and R′ being —CH₂CH₃. When the sulfur-containing group is a thionoester, such may be expressed by the formula (Id): —C(S)—O—CH₃ (Id), corresponding to formula (I) with R being —C(S)—O, and R′ being —CH₃. When the sulfur-containing group is a thioester group, such may be expressed by the formula (Ie): —S—C(O)— (Ie), corresponding to formula (I) with R being —(S)ₙ (n=1), and R′ being —C(O)—. Some of the repeat units of the plurality of repeating units may be selected from methyl methacrylate (MMA), 2-hydroxyethyl methacrylate (HEMA), glycidyl methacrylate (GMA), 2,3-dihydroxypropyl methacrylate (DHPMA), and/or allyl methacrylate (AMA). Some of the repeat units of the plurality of repeating units are selected from 2-mercaptoethyl methacrylate, 2,3-bis(acetylthio)propyl methacrylate, 2-hydroxy-3-(acetylthio)propyl methacrylate, 3-hydroxy-2-(acetylthio)propyl methacrylate, 2,3-dimercaptopropyl methacrylate, 3-hydroxy-2-mercap-topropyl methacrylate, disulfanediylbis(2-hydroxypropane-3,1-diyl)bis(2-methylacrylate), tri-sulfanediylbis(2-hydroxypropane-3,1-diyl)bis(2-methylacrylate), tetrasulfanediylbis(2-hydroxy-propane-3,1-diyl)bis(2-methylacrylate), and/or pentasulfanediylbis(2-hydroxypropane-3,1-diyl)bis(2-methylacrylate), 2-hydroxy-3-mercaptopropyl methacrylate, 2-acetylthioethyl meth-acrylate, 2-(ethylthio)ethyl methacrylate, O-methyl 2-methylprop-2-enethioate and/or O-(2-hydroxyethyl) 2-methylprop-2-enethioate. Metal atoms and/or metal ions are bound to sulfur of at least some of the sulfur-containing groups. The metal atoms may be selected from copper (Cu), silver (Ag), palladium (Pd), or gold (Au).

In an aspect of the present disclosure, a device structure is provided, the device structure comprising a substrate with a first surface, a surface polymer film comprising surface polymer molecules on at least a portion of a first surface, the surface polymer molecules comprising a plurality of repeating units, wherein at least some of the plurality of repeating units comprise a sulfur-containing group, and wherein at least some of the sulfur-containing groups bind to metal atoms, and a layer of metal at least partially within, and also over, the surface polymer film, wherein the layer of metal is attached to the surface polymer through bonding of metal atoms of the metal layer to metal atom-bound sulfur in the sulfur-containing groups of the surface polymer. The metal atoms of the sulfur-containing groups may be selected from copper (Cu), silver (Ag), palladium (Pd) and/or gold (Au). The metal layer may be selected from copper (Cu), silver (Ag), palladium (Pd) and/or gold (Au). The metal atoms of the sulfur-containing groups and the metal layer within and over the surface polymer film may be bonded through an electroless process. The metal layer may copper (Cu). The sulfur-containing group may be a polysulfide group, a thiol group, a thioester group, a thionoester group, or a thioether group. The sulfur-containing group may be expressed by the formula (I); RR′ (I), wherein RR′ is covalently bound to the surface polymer, and wherein R is selected from —(S)ₙ, wherein n is an integer from 1 to 8, —S—C(O), or —C(S)—O, with R′ being selected from a bond (“−”), —H, —CH₃, —CH₂CH₃, —CH₂CH₂OH, and —C(O)—. When the sulfur-containing group is a polysulfide, such may be expressed by the formula (Ia): —(S)ₙ— (Ia), corresponding to formula (I) with R being —(S)ₙ, where n=2 to 8, and R′ being a bond. When the sulfur-containing group is a thiol group, such may be expressed by the formula (Ib): —S—H (Ib), corresponding to formula (I) with R being —(S)ₙ (n=1), and R′ being —H. When the sulfur-containing group is a thioether, such may be expressed by the formula (Ic): —S—CH₂CH₃ (Ic), corresponding to formula (I) with R being —(S)ₙ (n=1), and R′ being —CH₂CH₃. When the sulfur-containing group is a thionoester, such may be expressed by the formula (Id): —C(S)—O—CH₃ (Id), corresponding to formula (I) with R being —C(S)—O, and R′ being —CH₃. When the sulfur-containing group is a thioester group, such may be expressed by the formula (Ie): —S—C(O)— (Ie), corresponding to formula (I) with R being —(S)ₙ (n=1), and R′ being —C(O)—. Some of the repeat units of the plurality of repeating units may be selected from methyl methacrylate (MMA), 2-hydroxyethyl methacrylate (HEMA), glycidyl methacrylate (GMA), 2,3-dihydroxypropyl methacrylate (DHPMA), and/or allyl methacrylate (AMA). Some of the repeat units of the plurality of repeating units are selected from 2-mercaptoethyl methacrylate, 2,3-bis(acetylthio)propyl methacrylate, 2-hydroxy-3-(acetylthio)propyl methacrylate, 3-hydroxy-2-(acetylthio)propyl methacrylate, 2,3-dimercaptopropyl methacrylate, 3-hydroxy-2-mercap-topropyl methacrylate, disulfanediylbis(2-hydroxypropane-3,1-diyl)bis(2-methylacrylate), tri-sulfanediylbis(2-hydroxypropane-3,1-diyl)bis(2-methylacrylate), tetrasulfanediylbis(2-hydroxy-propane-3,1-diyl)bis(2-methylacrylate), and/or pentasulfanediylbis(2-hydroxypropane-3,1-diyl)bis(2-methylacrylate), 2-hydroxy-3-mercaptopropyl methacrylate, 2-acetylthioethyl meth-acrylate, 2-(ethylthio)ethyl methacrylate, O-methyl 2-methylprop-2-enethioate and/or O-(2-hydroxyethyl) 2-methylprop-2-enethioate.

In an aspect of the present disclosure, a method for preparing a surface polymer comprising a plurality of repeating units, wherein some of the plurality of repeating units comprises a sulfur-containing group is provided, the method comprising providing surface polymer comprising plurality of repeating units, where some of the plurality of repeating units comprises an —OH group, a carbonyl group, an allyl group, or an epoxide group, and post-modifying at least some of the —OH groups, carbonyl groups, allyl groups, or epoxide groups to polysulfide groups, thiol groups, thioester groups, thionoester groups, or thioether groups. The sulfur-containing group may be expressed by the formula (I); RR′ (I), wherein RR′ is covalently bound to the surface polymer, and wherein R is selected from —(S)ₙ, wherein n is an integer from 1 to 8, —S—C(O), or —C(S)—O, with R′ being selected from a bond (“−”), —H, —CH₃, —CH₂CH₃, —CH₂CH₂OH, and —C(O)—. When the sulfur-containing group is a polysulfide, such may be expressed by the formula (Ia): —(S)ₙ— (Ia), corresponding to formula (I) with R being —(S)ₙ, where n=2 to 8, and R′ being a bond. When the sulfur-containing group is a thiol group, such may be expressed by the formula (Ib): —S—H (Ib), corresponding to formula (I) with R being —(S)ₙ (n=1), and R′ being —H. When the sulfur-containing group is a thioether, such may be expressed by the formula (Ic): —S—CH₂CH₃ (Ic), corresponding to formula (I) with R being —(S)ₙ (n=1), and R′ being —CH₂CH₃. When the sulfur-containing group is a thionoester, such may be expressed by the formula (Id): —C(S)—O—CH₃ (Id), corresponding to formula (I) with R being —C(S)—O, and R′ being —CH₃. When the sulfur-containing group is a thioester group, such may be expressed by the formula (Ie): —S—C(O)— (Ie), corresponding to formula (I) with R being —(S)ₙ (n=1), and R′ being —C(O)—. Some of the repeat units of the plurality of repeating units may be selected from methyl methacrylate (MMA), 2-hydroxyethyl methacrylate (HEMA), glycidyl methacrylate (GMA), 2,3-dihydroxypropyl methacrylate (DHPMA), and/or allyl methacrylate (AMA). Some of the repeat units of the plurality of repeating units are selected from 2-mercaptoethyl methacrylate, 2,3-bis(acetylthio)propyl methacrylate, 2-hydroxy-3-(acetylthio)propyl methacrylate, 3-hydroxy-2-(acetylthio)propyl methacrylate, 2,3-dimercaptopropyl methacrylate, 3-hydroxy-2-mercaptopropyl methacrylate, disulfanediylbis(2-hydroxypropane-3,1-diyl)bis(2-methylacrylate), trisulfanediylbis(2-hydroxypropane-3,1-diyl)bis-(2-methylacrylate), tetrasulfanediylbis(2-hydroxypropane-3,1-diyl)bis(2-methylacrylate), and/or pentasulfanediylbis(2-hydroxypropane-3,1-diyl)bis(2-methylacrylate), 2-hydroxy-3-mercapto-propyl methacrylate, 2-acetylthioethyl methacrylate, 2-(ethylthio)ethyl methacrylate, O-methyl 2-methylprop-2-enethioate and/or O-(2-hydroxyethyl) 2-methylprop-2-enethioate.

In an aspect of the present disclosure, the method for preparing a surface polymer comprising a plurality of repeating units, wherein some of the plurality of repeating units comprises a sulfur-containing group, may comprise providing a substrate, exposing at least a portion of the surface of the substrate to a polymerization initiator; and exposing the substrate to a reaction composition comprising a monomer, a catalyst, a ligand, a catalyst activator, and a solvent, to form surface polymers on at least the portion of the surface of the substrate, and post-modifying the surface polymer to form sulfur-containing groups on at least some of the plurality of the repeating units. The surface polymer may comprise —OH groups, carbonyl groups, allyl groups, or epoxide groups. In the method, at least some of the —OH groups, carbonyl groups, allyl groups, or epoxide groups of the surface polymer may be post-modified to polysulfide groups, thiol groups, thioester groups, thionoester groups, or thioether groups. Following post-modification, at least some of the sulfur-containing group may be a thiol group, a thioester group, a thionoester group, or a thioether group. The sulfur-containing group may be expressed by the formula (I); RR′ (I), wherein RR′ is covalently bound to the surface polymer, and wherein R is selected from —(S)ₙ, wherein n is an integer from 1 to 8, —S—C(O), or —C(S)—O, with R′ being selected from a bond (“−”), —H, —CH₃, —CH₂CH₃, —CH₂CH₂OH, and —C(O)—. When the sulfur-containing group is a polysulfide, such may be expressed by the formula (Ia): —(S)ₙ— (Ia), corresponding to formula (I) with R being —(S)ₙ, where n=2 to 8, and R′ being a bond. When the sulfur-containing group is a thiol group, such may be expressed by the formula (Ib): —S—H (Ib), corresponding to formula (I) with R being —(S)ₙ (n=1), and R′ being —H. When the sulfur-containing group is a thioether, such may be expressed by the formula (Ic): —S—CH₂CH₃ (Ic), corresponding to formula (I) with R being —(S)ₙ (n=1), and R′ being —CH₂CH₃. When the sulfur-containing group is a thionoester, such may be expressed by the formula (Id): —C(S)—O—CH₃ (Id), corresponding to formula (I) with R being —C(S)—O, and R′ being —CH₃. When the sulfur-containing group is a thioester group, such may be expressed by the formula (Ie): —S—C(O)— (Ie), corresponding to formula (I) with R being —(S)ₙ (n=1), and R′ being —C(O)—. Some of the repeat units of the plurality of repeating units may be selected from methyl methacrylate (MMA), 2-hydroxyethyl methacrylate (HEMA), glycidyl methacrylate (GMA), 2,3-dihydroxypropyl methacrylate (DHPMA), and/or allyl methacrylate (AMA). Some of the repeat units of the plurality of repeating units are selected from 2-mercaptoethyl methacrylate, 2,3-bis(acetylthio)propyl methacrylate, 2-hydroxy-3-(acetylthio)propyl methacrylate, 3-hydroxy-2-(acetylthio)propyl methacrylate, 2,3-dimercaptopropyl methacrylate, 3-hydroxy-2-mercap-topropyl methacrylate, disulfanediylbis(2-hydroxypropane-3,1-diyl)bis(2-methylacrylate), tri-sulfanediylbis(2-hydroxypropane-3,1-diyl)bis(2-methylacrylate), tetrasulfanediylbis(2-hydroxy-propane-3,1-diyl)bis(2-methylacrylate), and/or pentasulfanediylbis(2-hydroxypropane-3,1-diyl)bis(2-methylacrylate), 2-hydroxy-3-mercaptopropyl methacrylate, 2-acetylthioethyl meth-acrylate, 2-(ethylthio)ethyl methacrylate, O-methyl 2-methylprop-2-enethioate and/or O-(2-hydroxyethyl) 2-methylprop-2-enethioate.

In an aspect of the present disclosure, a system for forming a surface polymer comprising a plurality of repeating units, wherein some of the plurality of repeating units comprises a sulfur-containing group is provided, the system comprising a reaction composition container containing a reaction composition, said reaction composition comprising a monomer, a catalyst, a ligand, a catalyst activator, optionally a solvent, and a substrate displacement device for bringing at least a portion of a polymerization initiator-modified substrate into contact with the reaction composition in the reaction composition container for a controlled time, wherein the controlled time is sufficient for surface polymers to be formed on the portion of the polymerization initiator-modified substrate, and one or more post-modification containers, each post-modification container holding a chemistry for converting some of the plurality of repeating units into sulfur-containing groups, and a substrate displacement device for bringing the surface polymer covered substrate into contact with the post-modification composition in the post-modification composition container for a controlled time, wherein the controlled time is sufficient for at least a partial conversion of groups present in the surface polymer to sulfur-containing groups. The substrate displacement device may comprise any one of a conveyor system, a programmable mechanical arm, or a roll-to-roll mechanism. The system may further comprise a polymerization initiator container containing a polymerization initiator agent, wherein the substrate displacement device is configured to bring the at least a portion of the substrate for attachment of polymerization initiators into contact with the polymerization initiator agent to form polymerization initiators at the substrate surface, prior to bringing the at least a portion of the polymerization initiator-modified substrate into contact with the reaction composition. The polymerization initiator container may be a vacuum oven. The system may comprise one or more cleaning containers, the cleaning containers containing cleaning agents, wherein the substrate displacement device is configured to bring the at least a portion of the polymerization initiator-modified substrate into contact with the cleaning agents of the one or more cleaning containers prior to, or subsequent to, bringing the at least a portion of the polymerization initiator-modified substrate into contact with the reaction composition, and/or the substrate displacement device is configured to bring the at least a portion of substrate into contact with the cleaning agents in the one or more cleaning agents prior to, or subsequent to, bringing the at least a portion of the substrate into contact with the polymerization initiator. The system may further comprise a container for pre-wetting the at least a portion of the substrate prior to bringing the at least a portion of the substrate into contact with the reaction composition. The system may further comprise a reaction composition management system. The reaction composition management system may comprise one or more sensors in relation to the reaction composition container. The sensors may be configured to measure the pH of the reaction composition and/or the molecular oxygen concentration in the reaction composition. The system may further comprise one or more flow control devices.

### DESCRIPTION OF THE DRAWINGS

Certain embodiments of the matter disclosed herein are illustrated in the accompanying drawings.

The drawings are, however, in no way intended to limit the scope of the disclosure. In the drawings:

FIG. 1 illustrates the “grafting to” principle.

FIG. 2 illustrates the “grafting from” principle.′

FIG. 3 illustrates the principle of grafting density of polymerization initiators to “dummy” initiators (non-polymerization initiators).

FIG. 4 is a schematic illustration of polysulfides,

FIG. 5 is a schematic illustration of thiols,

FIG. 6 is a schematic illustration of thioethers,

FIG. 7 is a schematic illustration of thionoesters.

FIG. 8 is a schematic illustration of thioesters.

FIG. 9 is an example of a polysulfide of formula (Ia). The curved line to the left illustrates the binding on the surface polymer.

FIG. 10 is an example of a polysulfide of formula (Ia). The curved line to the left illustrates the binding on the surface polymer.

FIG. 11 is an example of a thiol of formula (Ib). The curved line to the left illustrates the binding on the surface polymer.

FIG. 12 is an example of a thiol of formula (Ib). The curved line to the left illustrates the binding on the surface polymer.

FIG. 13 is an example of a thioether of formula (Ic). The curved line to the left illustrates the binding on the surface polymer.

FIG. 14 is an example of a thionoester of formula (Id). The curved line to the left illustrates the binding on the surface polymer.

FIG. 15 is an example of a thionoester of formula (Id) The curved line to the left illustrates the binding on the surface polymer.

FIG. 16 is an example of a thioester of formula (Ie) are illustrated in FIG. 28. The curved line to the left illustrates the binding on the surface polymer.

FIG. 17A shows a schematic cross-sectional representation of a device structure with a surface polymer film 350, including surface polymer molecules 330 and sulfur-containing groups 340 suitable for bonding with a metal (such as silver (Ag), copper (Cu) or a palladium (Pd) catalyst for an electroless copper deposition), the surface polymer film 350 being formed on a substrate 310 from polymerization initiators 320 on the substrate 310.

FIG. 17B shows a schematic cross-sectional representation of the device structure of FIG. 6A where metal (such as silver (Ag), copper (Cu), or a palladium (Pd) catalyst for an electroless copper deposition) and sulfur-containing groups of the surface polymer form a sulfur-metal inclusion site 360. Metal may be bonded to all or to some of the sulfur-containing groups. The sulfur-containing groups are present on the surface polymer molecules 330 formed from polymerization initiators 320 on the substrate 310.

FIG. 17C shows a schematic cross-sectional representation of the device structure of FIG. 6B with the addition of metal layer 400 (such as copper) deposited by an electroless process, the electroless metal being deposited both within 410 and over 420 the surface polymer film 350 of FIGS. 6A and 6B. The metal-sulfur inclusion sites 360 on the surface polymer molecules 330 (formed from polymerization initiators 320 on the substrate 310) facilitates the deposition of the metal layer 400.

FIG. 18 shows a substrate with a surface polymer film. The surface polymer comprises glycidyl methacrylate (GMA) repeat units.

FIG. 19 shows the GMA repeat units of FIG. 18 post-modified so as to establish polysulfide bridges between adjacent post-modified sulfur-containing repeat units.

FIG. 20 shows a partial post-modification of ring-opened GMA repeat units (black circles) to form a plurality of sulfur-containing thiol repeat units (gray circles).

FIG. 21 shows metal binding to the polysulfide bridges of FIG. 19.

FIG. 22 shows metal bonded to thiol repeat units of the surface polymer.

FIG. 23 is a schematic illustration of a system for forming surface polymers on at least a portion of a substrate, according to embodiments of the present invention.

FIG. 24 is a schematic illustration of an exemplary substrate displacement device, the substrate displacement device comprising a roll-to-roll processing device, in accordance with an embodiment.

FIG. 25 shows T-FTIR spectra, recorded for Si-PHEMA substrates before and after the post-modification with AcSH, see Example 5.

FIG. 26 shows T-FTIR spectra, recorded for the Si-(PHEMA-co-APTEMA) substrate before and after the modification to Si-(HEMA-co-PMEMA), see Example 6.

FIG. 27 shows the T-FTIR spectrum of PGMA, see Example 7.

FIG. 28 shows the T-FTIR spectra of the PGMA and the post-modification PoSDHPDMA, see Example 8.

FIG. 29 shows the combined T-FTIR spectra of the surface polymers PGMA, PoSDHPDMA, and POHMPMA, see Example 9.

FIG. 30 shows the T-FTIR spectra of POHMPMA and POHMPMA-Ag surface polymers, see Example 16.

FIG. 31 shows the T-FTIR PoSDHPDMA and PoSDHPDMA-Ag surface polymers, see Example 16.

FIG. 32 is a picture of an EG-POHMPMA-Ag surface polymer substrate following electroless Cu-deposition, see Example 19. The box (shown with black dashed lines) indicates part of the substrate that was only partially submersed into the electroless deposition solution.

FIG. 33 is a picture of a PoSDHPDMA-Ag surface polymer substrate (left—marked “PS-Ag” POHMPMA-Ag surface polymer substrate (right—marked “POHMPMA-Ag”) following electroless Cu-deposition and annealing, see Example 20.

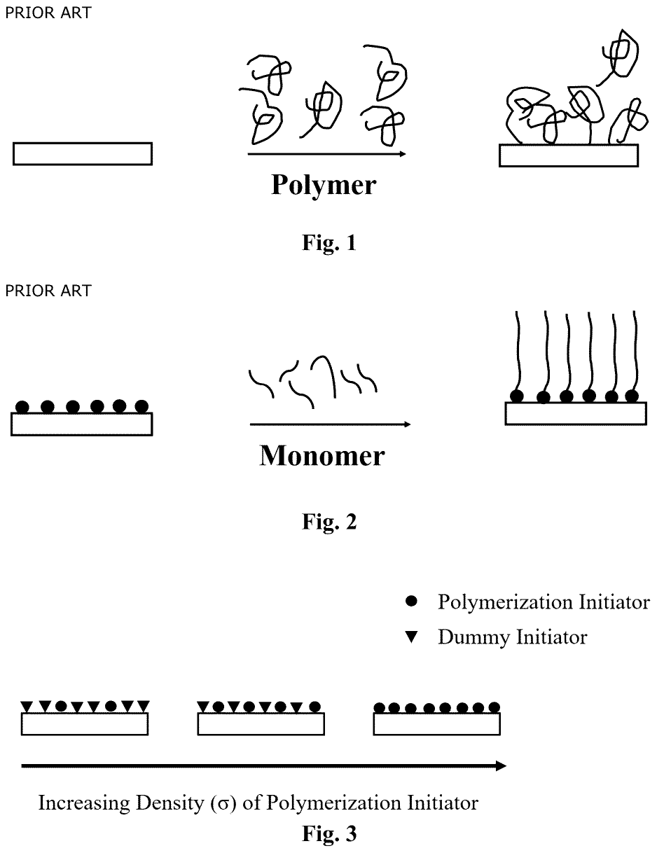

### DETAILED DESCRIPTION

In an aspect of the present disclosure, sulfur-containing surface polymers are provided. The sulfur-containing surface polymers may be obtained by polymerizing sulfur-containing monomers, using the “grafting from”-approach. The sulfur-containing surface polymers may be obtained by polymerizing monomers having a group suited for post-modification (conversion) into a sulfur-containing group, using the “grafting from”-approach.

In the “grafting from”-approach, surface polymers are propagated from polymerization initiators on a surface of a substrate. Various polymerization procedures are suited for such surface polymer propagation.

Several procedures for forming surface polymers are known, including SI-ATRP (surface-initiated atom transfer radical polymerization), SI-RAFT (surface-initiated reversible-addition frag-mentation chain transfer), SI-NMP (surface-initiated nitroxide-mediated polymerization), SI-PIMP (surface-initiated photoiniferter-mediated polymerization), and SI-A(R)GET (surface-initiated activators (regenerated) by electron transfer) ATRP. A review is given in Chem. Rev. 2009, 109, 5437-5527. Other approaches include SET-LRP (single-electron transfer living radical polymerization) and SARA ATRP (supplemental activator and reducing agent atom transfer radical polymerization).

Among the known procedures for formation of surface polymers, (ARGET) ATRP and SET-LRP are widely used. For the polymerizing chains to propagate, monomer, catalyst, ligand and solvent are needed. In (ARGET) ATRP and SET-LRP polymerizations, some reactions activate the catalyst, thereby, promoting polymerization, and at the same time, other reactions deactivate the catalyst to impede polymerization. SARA-ATRP and SET-LRP are described, e.g., in https://www.cmu.edu/maty/atrp-how/procedures-for-initiation-of-ATRP/SARA-ATRP-or-SET-LRP.html.

The SET-LRP and (ARGET) ATRP methods rely on the formation of a complex between the ligand and a halide formed with a transition metal (the Periodic Table), usually CuCl₂ or CuBr₂ in the case of ARGET ATRP, and Cu(0) in the case of SET-LRP.

The ARGET ATRP procedure involves a halogen transfer between a dormant halogen capped species, Pₙ-X, and Cu(I)X/L catalyst, resulting in the formation of a propagating radical (Pₙ radical) and Cu(II)X₂. The propagating radical undergoes polymerization with monomers, forming the growing polymer chain. Controlling the ratio between Cu(I)X/L and Cu(II)X₂/L in ARGET ATRP allows control of the polymerization itself. The classical ARGET ATRP procedures is very sensitive to atmospheric oxygen, causing quenching of the polymerization, as oxygen “drives” the formation of catalytically inactive copper species, and polymerization conditions involve keeping the polymerization shielded against oxygen.

From WO 2019/196999 A1, which is incorporated by reference in its entirety, as if fully set forth herein, an alternative oxygen-tolerant method for forming surface polymers is disclosed. The catalyst/ligand complex described in WO 2019/196999 A1 is halogen free in so far as the catalyst/ligand complex formed is not complexed with a halogen anion. An advantage is that the complex (pre-)formed between the transition metal and the ligand is inactive (i.e., not available for initiating polymerization of the monomer) and furthermore stable (oxygen-insensitive), but the system can be activated “on demand”, thus, initiating polymerization and propagation of the surface polymer.

Surface polymers propagate from polymerization initiators present on the surface of a substrate in the presence of suitable monomer, catalyst, ligand and, in most cases, a solvent. Polymerization initiators may firstly be attached to a portion of the surface of interest for surface polymer formation. Attachment of polymerization initiators to a surface of a substrate, from which surface polymers may be propagated, may be performed by various procedures. Polymerization initiators are covalently bonded to the surface of the material, see, e.g., WO 2014/0075695. The polymerization initiators may be provided with a predefined surface chemistry to enable attachment onto the surface of the substrate, depending on the nature of the substrate. Non-limiting examples of suitable chemistries for attaching polymerization initiators on surfaces include aryl diazonium salts, organosilanes, organothiols, organophosphonic acids, organophosphonates, catechols, iodonium salts, alkenes, alkynes, and sol-gel coatings. Surface anchored polymerization initiators can be prepared as multilayer films or monolayer films. Monolayer films can be densely packed (full monolayer coverage) or partly packed, covering all or only a part of the available surface. The density of the polymerization initiator influences the density and may possibly in some instances influence the growth rate of the subsequently formed surface polymer. Density of polymerization initiators would be understood by persons of ordinary skill as the number of polymerization initiators per unit area of the substrate.

The attachment of polymerization initiators usually follows a 1-step or a 2-step process. The 1-step process applies grafting of benzyl halide (like benzyl chloride) or secondary or tertiary halide moieties onto the surface of the substrate either by diazonium or silane grafting. The benzyl halide and secondary and tertiary halide moiety act as the polymerization initiator for the following surface-initiated polymerization. The 2-step process usually applies surface grafting of an initial organic compound with a nucleophilic group, and in a second step using the nucleophilic group to attach an initiator moiety. The nucleophilic group may include a hydroxyl or amine group. Then, the nucleophilic group may be reacted with an electrophile to add an initiator moiety, forming a covalent bond between the two. The initiator moiety may be, e.g., benzyl halide and tertiary halide moieties.

The attachment process is further described below. The procedures may in general apply to all types of substrates. Prior to attachment of polymerization initiators to form the polymerization initiator layer, the surface of the substrate may be cleaned using various techniques, including sonication in ammonia, ABC-clean A200, a solution of DI-water:NH₃:H₂O₂ (5:1:1), acetone, and/or water, to mention some. In some instances, the substrate may be subjected to the polymerization initiator forming process without any prior cleaning steps. Following attachment of polymerization initiators, the substrate may be rinsed and/or annealed at ambient conditions or at elevated temperatures.

### Silane Grafting 1-Step:

Polymerization initiators may be attached to a surface in one step by silane grafting of trialkoxysilane with benzyl halide or tertiary halide groups. The silane grafting may be done by vapor deposition, in solution, by spray coating, or paint-on coating.

### Diazonium Grafting 1-Step:

Polymerization initiators may be attached to a surface in one step by grafting aryl diazonium salts with benzyl halide groups. The diazonium grafting may be done either by activating the aryl diazonium salt electrochemically or chemically or by letting it react spontaneously. Diazonium salts may be pre-synthesized before being used for grafting reaction or formed in-situ during grafting reaction from a set of precursors added to the grafting reaction solution.

### Diazonium Grafting 2-Step:

Another route of polymerization initiator attachment is by a two-step process. The first step being grafting of an aryl diazonium salt that contains a nucleophilic group (alcohol or amine). In a second step, a nucleophilic acyl substitution reaction adds a halogen containing group, giving the attached polymerization initiator.

### Silane Grafting 2-Step:

The first step being grafting of a silane that contains a nucleophilic group (alcohol or amine). In a second step, a nucleophilic acyl substitution reaction adds a halogen containing group, giving the attached polymerization initiator.

Other processes for forming the polymerization initiator layer may be applied. An example is the polymerization initiator p-(chloromethyl)phenyltrimethoxysilane (CPTMS) which may be attached using a vapor deposition method or a dipping method. Another example is the poly-merization initiator p-(chloromethyl)phenyltrimethoxysilane (CPTMS) in combination with a “dummy” initiator phenyltrimethoxysilane (PTMS) or (3-glycidyloxypropyl)trimethoxysilane (GPTMS), the latter which display an epoxy (epoxide) group suited for further modification by ring-opening of the epoxy (epoxide) group. Within the present context, the term “dummy initiator”, “non-polymerization initiator” or “initiator not initiating polymerization” is a chemical entity which does not initiate surface polymer formation in the presence of an active polymerization catalyst.

The presence of polymerization initiators in the polymerization initiator layer may be “diluted” by the simultaneous presence of “dummy” initiators to form a polymerization initiator layer containing polymerization initiators active for surface polymer formation and chemical entities (the “dummy” initiator) not active for surface polymer formation. The “dummy” initiator may be added in a certain percentage together with the polymerization initiator, thus, competing with the polymerization initiator about available attachment sites on the substrate surface. Dilution of the polymerization initiator with a “dummy” initiator may be used to adjust the density of the polymerization initiators on the surface of the substrate, thus, aiding in controlling density (“grafting density”, i.e. the number of surface polymer chains per unit area of the substrate) of subsequently formed surface polymers. Here “grafting” means monomer-by-monomer propagation of surface polymers from the polymerization initiators. The density of the initiators (both polymerization initiators and non-polymerization/“dummy” initiators) influences the density of the subsequently formed surface polymer propagated from the polymerization initiator sites. As mentioned above, the density of polymerization initiators is intended to mean the number of polymerization initiators per unit area. Non-limiting examples of suitable percentage ratios (molecular-% (mol %) of polymerization initiator to non-polymerization initiator) may be in the range 100:0 (no non-polymerization initiator), 90:10, 80:20, 70:30, 60:40, 50:50, 40:60, 30:70, 20:80, and 10:90. The principle of adjusting the grafting density of polymerizations with “dummy” initiators is shown schematically in FIG. 3. FIG. 3 shows a varying dilution of the polymerization initiator with a non-polymerization initiator (“dummy” initiator). FIG. 3 is not intended to be an exact representation of the grafting density nor the distribution of the polymerization initiators as compared to the “dummy” initiators. In FIG. 3, “right” schematically shows the polymerization initiator is present at all available sites, i.e. no “dummy” polymerization initiator present. In FIG. 3, “middle” and “left” schematically shows increasing presence of “dummy” initiators, with the “left” image showing a higher presence of “dummy” initiators as compared to the “middle” image.

For forming surface polymers as described herein, suited polymerization initiators may be CPTMS or BiBB (2-bromoisobutyryl bromide).

It is expected that a wide range of different substrates will be useful in connection with the disclosure herein, however, suited substrates should provide a surface, allowing firstly attachment of first polymerization initiators, and secondly formation of surface polymers of first polymer molecules from said first polymerization initiator sites. Substrates may wholly or partly be composed of metal (like aluminum, steel, nickel, gold, silver, platinum, chrome, copper, iron and alloys), glass, carbon, graphite, graphene, carbon black, monoclays, ceramics, composite materials, plastics, polymer materials, semiconductors, compound semiconductors (e.g., gallium arsenide (GaAs), gallium nitride (GaN), germanium sulfide (GeS), and indium phosphide (InP)), and particles (e.g., Si, metal, metal alloys and coated particles). Substrates may be patterned or unpatterned. If patterned, substrate surface(s) may comprise one or more of the mentioned substrate materials. The substrate may be composed of several layers of different materials, optionally being attached together, e.g., using a glue, or be a blend of different materials. The substrate may have any size, shape and structure, including an elongated structure, and may be in the form of pieces, threads, fibers, cables, wires, hollow structures, particles, nanoparticles, monolayers etc. Particles and nanoparticles may be uncoated or coated with another material and may further be in the form of aggregates (multiple (nano)particles forming an assembly of individual (nano)particles). Aggregates may in some cases be viewed as one (nano)particle. Substrates may also be composed of one or more of the above mentioned, e.g., the substrate may be a base material comprising glass, silicon, GaAs, GaN, GeS, InP, dielectric material, ceramic, composite, as well as layered and patterned structures thereof. Substrates may have any form and shape, be elongated, be hollow, have protrusions or recesses, etc.

A portion or portions of a substrate may be “masked” so as to only attach polymerization initiators to unmasked areas on the substrate. Different techniques may be used to accomplish such specific attachment of polymerization initiators. For example, the portion or portions of the substrate may be covered by a film or layer during polymerization initiator attachment. Alternatively, contact between a portion or portions of a substrate and the reaction composition for forming surface polymer may be limited by, e.g., a masking with for example a film or a layer covering the portion or portions of the substrate on which surface polymers are not to be formed, or by immersing, into the reaction composition, only those portions of the substrate onto which surface polymers are to be formed. In general, any masking should be non-reactive with other chemistries to which the substrate is exposed and should be easily removable from the substrate.

The surface polymers as disclosed herein may in general be formed by bringing into contact the substrate including one or more surfaces of the substrate, or portions of one or more surfaces of the substrate with the reaction composition for surface polymer formation. It is understood that the surfaces or portions of the surfaces of the substrate may have been subjected to attachment of polymerization initiators prior to contact with the reaction composition. It is to be understood that the components of the reaction composition may be mixed and subsequently be brought into contact with the substrate. In another embodiment, the components of the reaction composition may be prepared as discrete compositions and mixed prior to or following contact with the substrate. E.g., the monomer may be prepared as a discrete component (solvated in the solvent if needed), and the catalyst/ligand complex may be brought into contact with the catalyst activator, whereafter the activated catalyst/ligand complex may be brought into contact with the substrate, followed by addition of the monomer. E.g., the monomer, the catalyst, the catalyst/ligand complex, and the solvent may be brought into contact with the substrate, and the catalyst activator may be dissolved in the solvent and subsequently be added. E.g., the monomer, the catalyst/complex, the solvent, and the catalyst activator may be pre-mixed, and subsequently be brought into contact with the substrate.

Following surface polymer formation, the substrate may be analyzed to determine the thickness of the formed surface polymers. It is to be understood that by the term “thickness of a surface polymer” or “thickness of a polymer on a substrate surface” is meant the surface polymer film formed on the substrate and composed of surface polymer molecules, i.e., the surface polymer as defined herein. The thickness is often measured as the dry film thickness by ellipsometry but may be measured by other means such as reflectometry or by measuring a step edge in the coating by atomic force microscopy or profilometry. To determine the dry film thickness, several ellipsometry measurements are taken in evenly spaced positions on the substrate surface. At a beam incidence angle of 65° the beam spot of the ellipsometer, i.e., the area from which each measurement collects data for the thickness calculation, is approximately 0.16 cm². E.g., for a quadrant of a 4″ silicon wafer (A ¼ 4″ silicon wafer, total area of ˜31.7 cm²), different data collection routines may include 10, 36, 45, or more measurement spots, meaning that the area from which thickness data is collected ranges from 1.6 cm² to 7.2 cm² or more, corresponding to thickness data being obtained from 5.0% to 22.7% of the total surface area. Adding more measurement points to the measurement routine would mean that average dry film thickness data would be obtained from a larger fraction of the surface area, although the inventors generally find that the good homogeneity of the surface polymers presented herein may suffice for determining the average dry film thickness of a surface polymer. Generally speaking, a substrate with a surface polymer film may be considered dry when no visible solvent film, droplets, or residues are observed, by visual inspection, on the surface of the substrate. Measurements such as atomic force microscopy and profilometry demand that a step edge is made in the coating from the outer edge of the coating and all the way to the surface of the substrate, by e.g. scratching. In the dry state, the surface-tethered polymer molecules acquire a conformation between fully collapsed and stretched conformation where the degree of stretching depends on the grafting density.

Ellipsometry provides a measurement of the average dry film thickness of the surface polymer across the substrate or a portion of a substrate. In addition to the drying methods above, other methods of obtaining a dry substrate may be used, some of which include withdrawal of the substrate(s) from the reaction composition, followed by rinsing by sonication in DI-water for 5 minutes, followed by sonication in acetone for 5 minutes, and drying in ambient air 1-30 minutes. In some cases, the substrates may be flushed with acetone after withdrawal from the reaction composition, followed by air-drying in an oven at 80° C. for 15 minutes. Still, in some cases, the substrate(s) may be flushed with acetone, then sonicated in acetone for 5 minutes and left to dry at 80° C. for 10 minutes. Alternatively, the substrate(s) may be flushed with isopropanol (iPrOH), then sonicated in iPrOH for 5 minutes, and left to dry under nitrogen flow for 10 to 30 minutes.

Following formation of the surface polymer, the formed surface polymer is indicated with a “P” as prefix to the monomer. By way of example, methyl methacrylate monomer is denoted MMA, and after polymerization, the polymer molecule is denoted PMMA. Likewise, 2-hydroxyethyl methacrylate is denoted HEMA, and after polymerization, the polymer molecule is denoted PHEMA. The surface polymer comprises a plurality of repeating units formed from the monomers used during the formation of the surface polymer. By way of example, surface polymers being co-polymers are denoted PHEMA-co-PSt (co-polymer of 2-hydroxyethyl methacrylate (HEMA) and styrene (St) monomers). A co-polymer may sometimes be a block polymer, and, by way of example, a block of PHEMA followed by a block of PSt is denoted PHEMA-b-PSt, and, by way of example, a random co-polymer of a mixture of HEMA and PSt monomers is denoted PHEMA-r-PSt.

In an aspect of the present disclosure, surface polymers are provided, the surface polymers comprising a plurality of repeating units, wherein some of the plurality of repeating units comprises a sulfur-containing group.

In some instances, the sulfur-containing group may be a polysulfide, a thiol group, a thioether group, a thionoester group, or a thioester group.

A polysulfide has the general form —(S)ₙ—, wherein n is an integer of a certain number, and, by way of example, if n is 2, a disulfide is formed, and if n is 3, a trisulfide is formed. A thiol group has the general form —SH. A thioether has the general form —S—CH₂—. A thionoester has the general form —C(S)—O—CH₃, where C(S) indicate carbon (C) double bound to sulfur (S). A thioester has the general form —S—C(O)—, where C(O) indicate carbon (C) double-bond to oxygen (O).

Thus, the sulfur-containing group may be expressed by the formula (I):

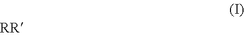

wherein RR′ may covalently be bound to the surface polymer, and wherein R may be selected from —(S)ₙ, wherein n may be an integer from 1 to 8, —S—C(O), or —C(S)—O, with R′ being selected from a bond (“−”). —H, —CH₃, —CH₂CH₃, —CH₂CH₂OH, and —C(O)—.

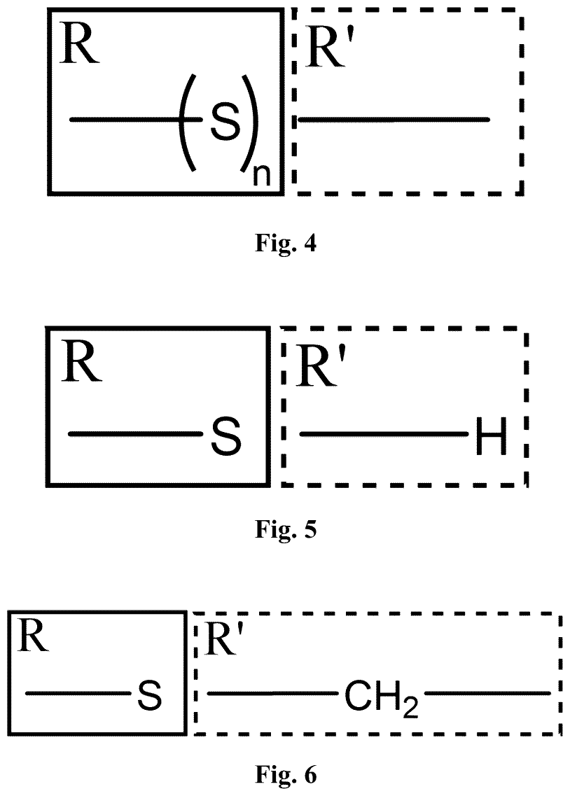

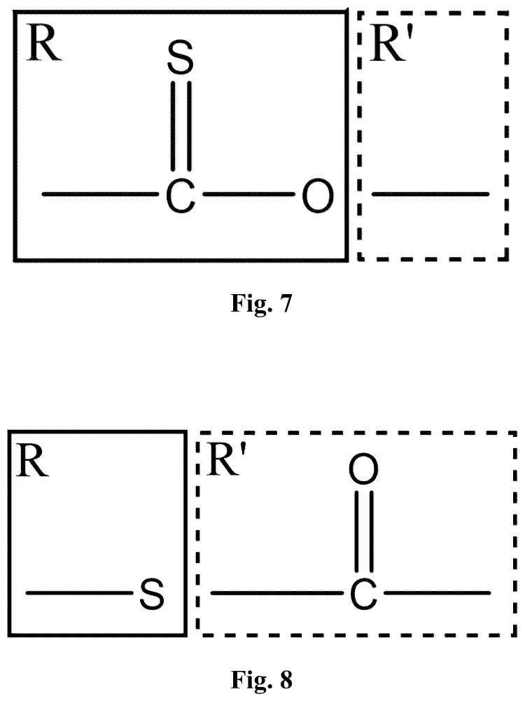

The general formulas are shown in FIG. 4 to FIG. 8. with FIG. 4 illustrating polysulfides, FIG. 5 illustrating thiols, FIG. 6 illustrating thioethers, FIG. 7 illustrating thionoesters, and FIG. 8 illustrating thioesters.

By way of example, the sulfur-containing group may be a polysulfide of the formula (Ia):

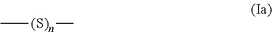

corresponding to formula (I) with R being —(S)ₙ, where n=2 to 8, and R′ being a bond.

By way of example, the sulfur-containing group may be a thiol group of the formula (Ib):

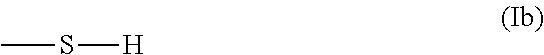

corresponding to formula (I) with R being —(S)ₙ (n=1), and R′ being —H.

By way of example, the sulfur-containing group may be a thioether group with the formula (Ic): —S—CH₂CH₃ (Ic)

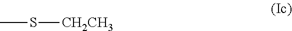

corresponding to formula (I) with R being —(S)ₙ (n=1), and R′ being —CH₂CH₃.

By way of example, the sulfur-containing group may be a thionoester of the formula (Id):

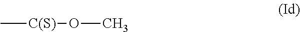

corresponding to formula (I) with R being —C(S)—O, and R′ being —CH₃. By way of example, the sulfur-containing group may be a thioester group of the formula (Ie):

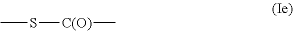

corresponding to formula (I) with R being —(S)ₙ (n=1), and R′ being —C(O)—.

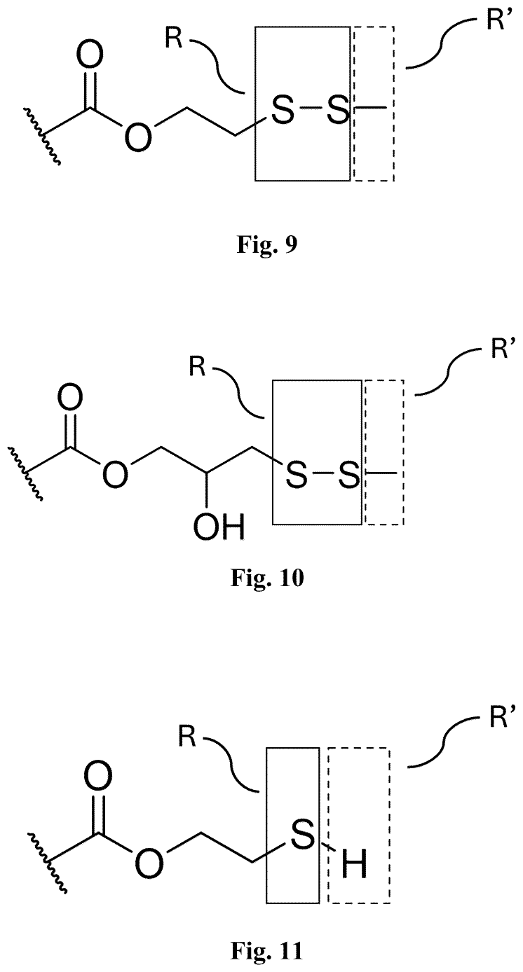

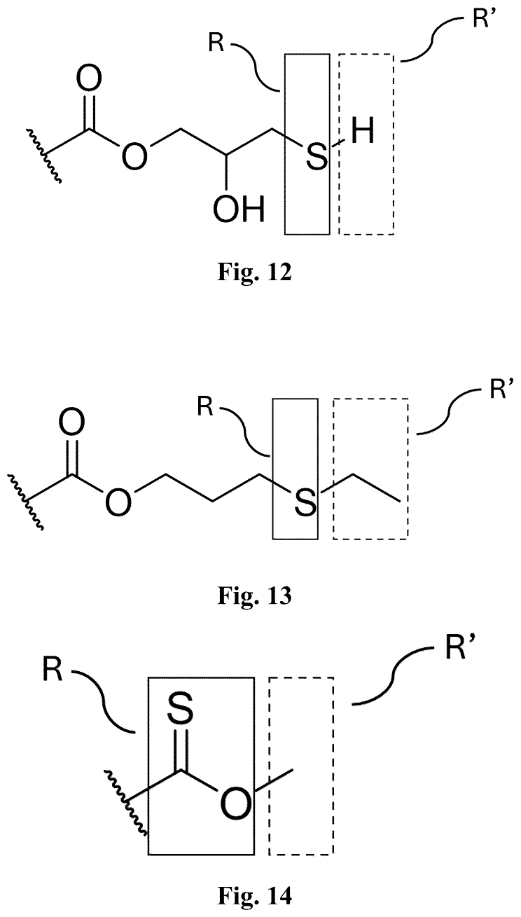

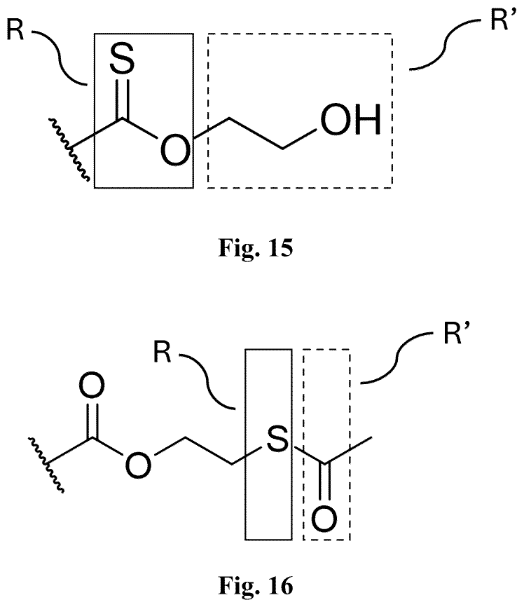

Structures of formula (Ia) are illustrated in FIG. 9 and FIG. 10. Structures of formula (Ib) are illustrated in FIG. 11 and FIG. 12. Structures of formula (Ic) are illustrated in FIG. 13. Structures of formula (Id) are illustrated in FIG. 14 and FIG. 15. Structures of formula (Ie) are illustrated in FIG. 16. The curved line to the left in FIG. 9 to FIG. 16 illustrates the binding on the surface polymer.

In general, non-limiting examples of polysulfides (formula (Ia)) include pentasulfanediylbis(2-hydroxypropane-3,1-diyl) bis(2-methylacrylate), tetrasulfanediylbis(2-hydroxypropane-3,1-diyl) bis(2-methylacrylate), trisulfanediylbis(2-hydroxypropane-3,1-diyl) bis(2-methylacrylate) and disulfanediylbis(2-hydroxypropane-3,1-diyl) bis(2-methylacrylate).

In general, non-limiting examples of thiols (formula (Ib)) include 2-hydroxy-3-mercaptopropyl methacrylate, and 2-mercaptoethyl methacrylate.

In general, non-limiting examples of thioethers (formula (Ic)) include 3-(methylthio)propyl methacrylate, 3-(ethylthio)propyl methacrylate, 3-(ethylthio)-2-hydroxypropyl methacrylate, and 2-hydroxy-3-(methylthio)propyl methacrylate.

In general, non-limiting examples of thionoesters (formula (Id)) include O-(2-hydroxyethyl) 2-methylprop-2-enethioate, 0-(2-mercaptoethyl) 2-methylprop-2-enethioate, and O-methyl 2-methylprop-2-enethioate.

In general, non-limiting examples of thioesters (formula (Ie)) include S-(2-hydroxyethyl) 2-methylprop-2-enethioate, and 2-(acetylthio)ethyl methacrylate.

As mentioned above, the sulfur-containing surface polymer as described herein may be prepared by polymerizing sulfur-containing monomers by the methods described herein. In some instances, sulfur-containing monomers may be polymerized with a monomer not containing sulfur so as to control the presence of sulfur-containing groups in the resulting surface polymer (i.a., a random co-polymer of a sulfur-containing monomer and a monomer not containing sulfur). The sulfur-containing surface polymers may be prepared by polymerizing two monomers, wherein one of the monomers contains a group suitable for post-modifying into a sulfur group. In general, different monomers may have different reactivities in polymer formations, that is, a 50:50 mixture (whether mol %, weight %, or vol %) does not necessarily result in a 50:50 incorporation of the monomers into the surface polymer, however, experimentation may result in a “profile” for a given mixture of monomers, making possible predicting the ratio of each of the monomers incorporated into the surface polymer. An alternative method of obtaining a surface polymer with repeat units containing sulfur and repeat units not containing sulfur may be to prepare a block copolymer by two consecutive polymerizations. The obtained sulfur-containing surface polymer may be post-modified to alter at least some of the repeat units having sulfur-containing groups, or, to alter some of the repeat units not having sulfur-containing groups.

The sulfur-containing surface polymer as described herein may be prepared by polymerizing a monomer so as to form a surface polymer, followed by post-modification of at least some of the plurality of modifiable groups in the surface polymer. Examples of post-modifiable groups include, but are not limited to, —OH groups, allyl groups, and epoxide groups.

Methods for forming the surface polymers as disclosed herein are also an aspect of the present disclosure. The method for forming the surface polymer comprises providing a substrate having polymerization initiators on at least a portion of a surface of the substrate, and exposing the substrate to a polymerization composition comprising monomer(s), catalyst(s), ligand(s), catalyst activator(s), and optionally a solvent for a suitable time sufficient for surface polymers to be formed from polymerization initiator sites on the substrate.

In some instances, the method may comprise exposing at least a portion of a surface of the substrate to polymerization initiators to form polymerization initiator-modified sites on the substrate, and exposing the substrate to a polymerization composition comprising monomer(s), catalyst(s), ligand(s), catalyst activator(s), and optionally a solvent for a suitable time sufficient for surface polymers to be formed from polymerization initiator sites on the substrate.

It is to be understood that the components of the reaction composition, that is the monomer, the catalyst, the ligand, optionally the solvent, and the catalyst activator, may be mixed and subsequently be brought into contact with the substrate. In another embodiment, the components of the reaction composition may be prepared as discrete compositions and mixed prior to or following contact with the substrate. E.g., the monomer may be prepared as a discrete component (solvated in the solvent if needed), and the catalyst/ligand complex may be brought into contact with the catalyst activator, whereafter the activated catalyst/ligand complex may be brought into contact with the substrate, followed by addition of the monomer. E.g., the monomer, the catalyst/ligand complex, and the solvent may be brought into contact with the substrate, and the catalyst activator may be dissolved in the solvent and subsequently be added. E.g., the monomer, the catalyst/complex, the solvent, and the catalyst activator may be pre-mixed, and subsequently be brought into contact with the substrate.

For forming surface polymers, the substrate and the reaction composition as defined herein are typically kept in contact with each other for a suitable period (residence time or polymerization time), sufficiently to form surface polymers essentially having an average dry film thickness within a desired range. The polymerization time may be as long as needed. Suited polymerization times include, but is not limited to, up to 24 hours, e.g., 2 seconds, 5 seconds, 10 seconds, 20 seconds, 30 seconds, 40 seconds, 50 seconds, 1 minute, 5 minutes, 30 minutes, 1 hour, 2 hours, 3 hours, 4 hours and 5 hours. For a manufacturing perspective, polymerization times between 20 seconds and 20 minutes may be suitable. The surface polymer formation may take place at ambient temperature (room temperature), or with cooling or heating. Suitable temperatures include, but are not limited to, such from 5° C. up to 120° C., such as from room temperature (approximately 20° C.) to 120° C. Specific temperatures include, but are not limited to, 5° C., 10° C., 15° C., 20° C., room/ambient temperature (approximately 20° C.), 30° C., 50° C., 60° C., 70° C., 80° C., 90° C., 100° C., 110° C., and 120° C. The polymerization time and temperature during the polymerization time may suitably be computer controlled. Following formation of surface polymers, the substrate may be subjected to optionally multiple rinsing and cleaning processes, typically involving flushing with a suitable solvent, sonicating, and/or drying at room temperature or elevated temperature (“annealing”).

For forming surface polymers, the solvent of the reaction composition may be aqueous. Thus, the solvent may be a mixture of water and an organic solvent. The water and the organic solvent may be miscible with each other. Suitable solvents include, but are not limited to, alcohols, dipolar aprotic solvents (for example, tetrahydrofuran, methyl acetate, ethyl acetate, butyl acetate, dimethyl sulfoxide, dimethyl formamide), methylene carbonate, ethylene carbonate, propylene carbonate, ethyl lactate alcohol, toluene, ionic liquids, and supercritical CO₂. The solvent may be chosen so as to provide sufficient solubility and/or miscibility of the components of the reaction composition. The ratio (volume-% (vol %)) between water and organic solvent may be 10:90, 20:80, 30:70, 40:60, 50:50, 60:40, 70:30, 80:20, or 90:10 as well as range therebetween.

The solvent may be a combination of water and methanol, water and ethanol, or water and isopropanol. The solvent may be a combination of water and methanol, ethanol, and/or isopropanol.

The solvent may solubilize the other components of the reaction composition. Some of the components may be solubilized in the solvent prior to the surface polymer formation and mixed with the remaining components. Thus, any of the monomer, the catalyst and the ligand, and the catalyst activator may be solubilized in the solvent prior to surface polymer formation. Non-limiting ways of mixing include: mixing of catalyst, ligand and solvent prior to mixing with catalyst activator optionally solubilized in solvent, or mixing of catalyst, ligand, solvent, and catalyst activator prior to addition of monomer optionally solubilized in solvent, or mixing of catalyst, ligand, solvent, and monomer prior to addition of catalyst activator solubilized in solvent. It is to be understood that “solvent” in the aforementioned cases may include water alone, or a mixture of water and organic solvent. Other ways of mixing of the components of the reaction composition may be envisaged, and, thus, the order of mixing of the components should not be restricted to the disclosure of the Examples.

Catalysts to be used herein for forming surface polymers may be selected from several different metals, e.g., transition metals as given in the Periodic System. Examples of such transition metals are, e.g., copper (Cu), iron (Fe), and ruthenium (Ru). Specific examples of such catalysts include Cu₂O, CuO, CuCl, CuCl₂, CuBr, CuBr₂, FeCl₂ and FeCl₃, RuCl₂, RuCl₃ as well as combinations thereof. Some halogenide salts may be used as hydrates. The catalyst concentration in the reaction composition is typically in the range 0.001-1 mM. The concentration of catalyst in the reaction composition is preferrable in the range 0.02-0.32 mM, for example 0.02 mM, 0.04 mM, 0.08 mM, 0.16 mM, or 0.32 mM. The activator for the catalyst (e.g., an oxygen scavenger) may be used in excess compared to the catalyst. Excess catalyst activator may, e.g., be 10-500 times. The catalyst activator is responsible for the turnover between oxidized deactivating and/or activating catalyst states. It is presently believed that the principal reaction pathway for catalyst activation is reduction, that is, the catalyst activator is a species which is capable of reducing the catalyst of the complex between the catalyst and the ligand from its inactive state to its catalytically active state, where surface polymer formation can take place. Examples of suited catalyst activators are sodium ascorbate, ascorbic acid, hydrazine, hydrazine hydrate, sodium hypophosphite, glucose, tin 2-ethylhexanoate, sodium phenoxide, sodium dithionite, and a mixture of iron powder and sodium chloride.

Ligands to be used herein include, but are not limited to, nitrogen-containing ligands. Non-limiting examples of such nitrogen-containing compounds are bi-, tri-, or tetradentate amine ligands (containing two, three or four amine substituents) which are aliphatic and/or aromatic in nature. In particular, such ligands include N,N,N′,N″,N″-pentamethyldiethylene-triamine (PMDETA), tris[2-(dimethylamino)ethyl]amine (Me₆TREN), tris(2-aminoethyl)amine (TREN), tris(2-pyridylmethyl)amine (TPMA), 1,1,4,7,10,10-hexamethyltriethylenetetramine (HMTETA), tetramethylethylenediamine (TMEDA), 1,4,8,11-tetramethyl-1,4,8,11-tetraazacyclotetradecane (Me₄Cyclam), and/or 2,2′-bipyridyl (BiPy). Other ligands may include 1,4,8,11-tetra-azacyclotetradecane (Cyclam), 1,8-dimethyl-1,4,8,11-tetraazacyclotetradecane (Me₂Cyclam), 1,4,7,10-tetraazacyclododecane (Cyclen), and different methylated Cyclen derivatives, and combinations thereof. The amount of ligand in the reaction composition is defined as a ratio to the concentration of catalyst in the reaction composition. The ratio of ligand to catalyst in the reaction composition is in the range 0.001:1 to 1000:1. The ratio of ligand to catalyst in the reaction composition may be in the range 0.005:1 to 100:1, for example 0.13:1, 0.5:1, 1.0:1, 2.0:1, 3.5:1, 7.5:1 or 12:1. In general, an excess amount of ligand as compared to amount of catalyst is preferred.

The catalyst and the ligand form a complex. One, two, three or even four ligands may form complexes with one catalyst. Suitable catalyst/ligand complexes include, but are not limited to, Cu/PMDETA, Cu/Me₆TREN, Cu/TREN, Cu/TPMA, Cu/HMTETA, Cu/TMEDA, Cu/Me₄Cyclam, and Cu/BiPy. If, e.g., iron (Fe) or ruthenium (Ru) is used as catalyst, Cu in the beforementioned is replaced by Fe or Ru, respectively.

The reaction composition may in some cases comprise a halide compound for increasing the “livingness” of the polymerization. A “living” polymerization refers to a polymerization where the rate of termination is minor in comparison to the rate of propagation of polymer molecules from the polymerization initiators. As a result, living polymerizations show a more linear relationship between polymer chain length and time. The halide compound to be used herein is a compound capable of providing a halide anion. Non-limiting examples of such compounds are NaCl, NaBr, KCl, KBr, MgCl₂, MgBr₂, CaCl₂, HCl, HBr, LiCl, LiBr, CaBr₂, as well as combinations thereof. Halide compounds may disassociate in the reaction composition, generating halide anions which may form complexes with and/or bind to catalysts in solution, resulting in an increased concentration of catalyst/ligand-X (X is the halide anion) complexes which are responsible for end-capping, and thus deactivating, propagating surface polymer chain-end radicals to deliver alkyl halides. Consequently, the number of propagating surface polymer chain-end radicals at any given time is lowered, which may result in at least the following effects; (1) a lowering of the rate with which polymer molecules grow initially due to a lower number of propagating chains, and (2) a lowering of the rate with which chain termination between two propagating polymer molecule chain-end radicals occur (through recombination or dispro-portionation), leading to an increased living character of the polymerization. The halide compound may suitably be used in the range of from 0.1 M to 2 M.

Monomers may suitably be used in an amount corresponding to a percentage of the total volume of the reaction composition. For example, a liquid monomer may constitute e.g. 0.5 vol %, 2 vol %, or 10 vol % of a reaction composition. In accordance with the present disclosure, an amount of monomer may be chosen to obtain desired surface polymerization kinetics, solubility of the monomer, and cost of the monomer. The monomer may suitably be used in the range 0.5 vol % to 50 vol %.

As mentioned above, the formation of surface polymers may be performed at ambient temperature, at a temperature above ambient temperature, or at a temperature below ambient temperature. The temperature during surface polymer formation may be controlled automatically. The polymerization time may vary depending on components of the reaction composition, the targeted average dry film thickness of the surface, process optimization, etc.

As mentioned above, surface polymers may be surface block co-polymers. The procedures described above for the methods may be repeated in order to form surface block co-polymers. Accordingly, it is envisaged that each layer or block of surface polymer formed on the substrate may be formed by bringing a desired portion of the surface of a substate into contact with a reaction composition comprising a monomer which may differ from the monomer applied in the first polymerization. Repeating the steps of the methods multiple times may provide formation of multiple layers (blocks) of surface polymers. In some instances, random co-polymers of surface polymer may be formed. Random surface polymer can be formed applying a reaction composition with multiple different monomers. Random surface polymer may be formed either as first surface polymer layer (block) or further surface polymer layer (block). The post-modification of the surface polymer to convert some of the plurality of repeating units to a sulfur-containing group, or to convert a sulfur-containing group into another sulfur-containing group, may be achieved by forming a random co-polymer of surface polymer.

The reaction composition for formation of surface polymers may comprise a buffer. The term “buffer” is defined herein as an agent which, when added to the reaction composition, can within a certain pH range withstand changes in pH when acidic or alkaline substances/components are added to the reaction composition or is formed in the reaction composition. Buffer systems include combinations of a weak acid and its conjugate base, or a weak base and its conjugate acid. Buffers may suitably be prepared as an aqueous solution but may in some cases involve adding a non-aqueous solution or solid/semi-solid formulation to the reaction composition. Non-limiting examples of buffers are carbonate buffer, glycine buffer, citrate buffer, phosphate buffer, acetate buffer, ammonium buffer (ammonium chloride/ammonia), formate buffer, sodium ascorbate/ascorbic acid buffer, and/or zwitterionic buffers. Zwitterionic buffers may comprise Good's buffers selected from MES, PIPES, MOPS, HEPES, CHES, CAPSO and/or CAPS.

The formed surface polymer chains may be cross-linked to other adjacent surface polymer chains or internally to a repeat unit in the surface polymer chain (the polymer molecule). Cross-linking may be a useful tool in certain applications, and likewise so, when there is a lower density of polymerization initiator sites. Chains of the formed surface polymer may be cross-linked via several pathways, depending on their structure and chemical functionalities. Generally, a cross-linking molecule must be able to either react at least with two reactive groups present on one or more repeat units on the surface polymer chain (internally or adjacent), or, be able to react at least once with reactive groups present on one or more of the repeat units of the surface polymer chain (internally or adjacent) and generate, in this reaction, at least one new reactive group, which may react further with adjacent groups, leading to cross-linking. As an example of the latter, surface polymer of glycidyl methacrylate (GMA) (poly(glycidyl methacrylate) (PGMA)) contains a reactive epoxide (or oxirane)-moiety, which upon reaction with a nucleophile yields a hydroxyl group, and a carbon-nucleophile covalent bond. The formed hydroxyl group may itself be considered a nucleophile which may then react with another epoxide group of an adjacent group, resulting in formation of a carbon-O covalent bond, thus forming the cross-link. Suitable nucleophiles for reaction with PGMA surface polymer include but are not limited to amines, thiols, halide anions such as iodide, and hydroxyls. Examples of nucleophiles which may react only once with a PGMA repeat unit include alcohols such as ethanol and phenol, secondary amines such as diethylamine, and thiols such as 1-decanethiol. Examples of nucleophiles that may react at least twice with PGMA repeat units include primary amines such as allyl amine and propyl amine, diamines such as 1,2-diaminoethane, diols such as ethylene glycol and bisphenol A, and dithiols such as ethylene bis(thioglycolate). Cross-linkers which may react e.g. at least three times may be conceptualized by e.g. branched triamines such as propane-1,2,3-amine, and glycerol. In general, if the repeat unit has nucleophilic functional groups such as hydroxyl groups and amine groups, the cross-linker molecule should have at least two reactive electrophilic sites. Examples thereof include di-acid halides such as succinyl chloride, sebacoyl chloride (SCL), adipoyl chloride, fumaryl chloride and azealoyl chloride, or dicarboxylic acids such as maleic acid, glutaric acid, and terephthalic acid, which may be activated by suitable reagents such as carbodiimides like 1-ethyl-3-(3-dimethylaminopropyl)carbodiimide, diisopropylcarbodiimide, or N,N′-dicyclohexyl-carbodiimide, di-isocyanate, di-thioisocyanate or acid halide forming species such as thionyl chloride. Other suited cross-linking agents include ammonium dichromate, poly(melamine-co-formaldehyde) (PMF), poly(methylated melamine-co-formaldehyde) (PMMF), trimethylol-propane triglycidyl ether (TTE), and ethylenediaminetetraacetic dianhydride (EDT).

In some instances, a monomer may be co-polymerized with another monomer to generate the cross-linking. Nonlimiting example of this is the monomer include ethylene glycol dimethacrylate (EGDMA), bisacrylamide, 1,4-butnediol diacrylate, 1,6-hexanediol diacrylate, trimethylolpropane triacrylate, and pentaerythritol tetraacrylate which may copolymerize with, e.g., GMA to generate cross-linking between repeat units in the formed surface polymer. The degree of cross-link may not readily be determined, and thus, the cross-linking may depend on chemistries that makes possible and make likely the cross-linking events taking place.

In an aspect of the present disclosure and in accordance with the above, a method for preparing a surface polymer comprising a plurality of repeating units, wherein some of the plurality of repeating units comprises a sulfur-containing group is provided, said method comprising providing surface polymer comprising plurality of repeating units, where some of the plurality of repeating units may comprise an —OH group, an allyl group, an ester group or an epoxide group, and post-modifying a at least some of the plurality of the —OH groups, allyl groups, ester groups or epoxide groups to a sulfur-containing group.

The post-modification may result in the formation of a sulfur-containing group being a polysulfide, a thiol group, a thioester group, a thionoester, or a thioether group. The sulfur-containing group may be generally expressed by the formula (I) indicated above. Specifically, the sulfur-containing group may be a polysulfide as expressed by formula (Ia) indicated above. Specifically, the sulfur-containing group may be a thiol group as expressed by formula (Ib) indicated above. Specifically, the sulfur-containing group may be a thioether as expressed by formula (Ic) above. Specifically, the sulfur-containing group may be a thionoester as expressed by formula (Id) above. Specifically, the sulfur-containing group may be a thioester as expressed by formula (Ie) above.

The method for preparing a surface polymer comprising a plurality of repeating units, wherein some of the plurality of repeating units comprises a sulfur-containing group, may be such where the method comprises providing a substrate, exposing at least a portion of the surface of the substrate to a polymerization initiator, and exposing the substrate to a reaction composition comprising a monomer, a catalyst, a ligand, a catalyst activator, and a solvent, to form surface polymers on at least the portion of the surface of the substrate, and post-modifying the surface polymer to form sulfur-containing groups on at least some of the plurality of the repeating units. In some cases, the monomer may act as the solvent.

As mentioned above, surface polymers may be formed from sulfur-containing monomers by the methods described above. Non-limiting examples of sulfur-containing monomers may be those which feature thiol, disulfide, thioester, or thioether moieties. In particular, such monomers include phenyl vinyl sulfide, 2-(methylthio)ethyl methacrylate, bis(2-methacryloyl)oxyethyl disulfide, 2-acetylthioethyl methacrylate, 3-sulfopropyl methacrylate potassium salt, and 2-mercaptoethyl methacrylate.

As mentioned above, surface polymers may be formed from monomers featuring a moiety which may be converted into a sulfur-containing group by post-modification of the surface polymer by the methods described above. Monomers may include acrylates and methacrylates. Non-limiting examples of acrylate monomers include, but are not limited to, methyl acrylate, ethyl acrylate, tert-butyl acrylate (tBA), 2-hydroxyethyl acrylate, lauryl acrylate, poly(ethylene glycol) methyl ether acrylate, poly(ethylene glycol) acrylate, acrylic acid, lithium acrylate, and sodium acrylate. Non-limiting examples of methacrylate monomers include but are not limited to methacrylic acid, lithium methacrylate, sodium methacrylate, methyl methacrylate (MMA), potassium 3-sulfpropyl methacrylate, 2-hydroxyethylmethacrylate (HEMA), glycidyl methacrylate (GMA), ethyl methacrylate, n-butyl methacrylate, tert-butyl methacrylate (tBMA), lauryl methacrylate, allyl methacrylate, 2-((triethoxysilyl)oxy)ethyl methacrylate, and 2-(3-(triethyoxsilyl)propoxy)-ethyl methacrylate. Moieties that may be converted into a sulfur-containing group include, but are not limited to, hydroxyl groups, epoxide groups, and allyl groups. Typically, such groups will be present in the surface polymer as a side chain. Non-limiting examples of such monomers may be 2-hydroxyethyl methacrylate (HEMA), glycidyl methacrylate (GMA), 2,3-dihydroxypropyl methacrylate, and/or allyl methacrylate (AMA).

The methods described above may be such, wherein some of the repeating units of the plurality of repeating units may be selected from methyl methacrylate, 2-hydroxyethyl methacrylate, glycidyl methacrylate, and/or allyl methacrylate.

The methods described above may be such, wherein the sulfur-containing group may be selected from 2-mercaptoethyl methacrylate, 2-acetylthioethyl methacrylate, and/or 3-(ethylthio)propyl methacrylate.

Sulfur-containing monomers and monomers with a moiety convertible to a sulfur-containing group may be co-polymerized with other monomers to obtain a surface polymer displaying a plurality of repeated units with the desired feature. A sulfur-containing group present in a surface polymer may also be post-modified to another sulfur-containing group.

The strategy of polymerizing sulfur-containing monomers and the strategy of polymerizing monomers with convertible groups each possess different potential benefits. For some applications, it may be desirable to incorporate sulfur-modification via the monomer. In other applications, it may be desirable to post-modify the surface polymer so as to obtain the desired sulfur-modification.

### Polysulfide Post-Modification

Surface polymers having a plurality of repeat units being polysulfides may generally be prepared by bringing a surface polymer having a group suited for post-modification in contact with a mixture of Na₂S, elemental sulfur, ethanol, and NaHCO₃ in suitable amounts for a suitable period of time. Groups on the repeat units of the surface polymer suited for polysulfide post-modification include epoxide groups.

### Thiol Post-Modification

For example, a disulfide linkage of the repeat units may be reduced by submersing a substrate with surface polymers into a solution of DI-water, DTT and triethylamine to break the disulfide linkage and form free thiol groups. For example, thiol groups may be formed by firstly forming a surface polymer having OH-groups, followed by submersion of substrate into a solution of PH₃P, THF, DIAD and thioacetic acid, resulting in the post-modification of at least some of the OH-group-containing repeat units, followed by submersion of the into a solution of DTT, triethylamine and DMF to deacetylate formed thioether groups into thiol groups (MEMA repeat units).

### Thioether Post-Modification

For example, a surface polymer having a plurality of allyl groups may be post-modified by submersing the surface polymer substrate into a solution of ethanethiol, azobisisobutyronitril and DMF, resulting in the addition of ethanthiol groups to at least some of the allyl groups in the repeat units, thus, forming thioether-containg repeat units.

### Thionoester Post-Modification

For example, a thionoester-containing surface polymer may be formed by post-modifying PMMA and/or PHEMA repeat units by thionation of carbonyl groups in the surface polymer by submersing the surface polymer substrate into a solution of Lawesson's reagent and DCM to form the thionoester.

### Thioester Post-Modification

For example, a thioester-containing surface polymer may be formed by post-modification of OH-groups of a surface polymer by submersion of the surface polymer substrate into a solution of PH₃P, THF, DIAD and thioacetic acid, forming acetyl thioethyl repeat units.

Having a view to the above, examples of monomers which feature a “handle” or moiety for introducing sulfur after surface polymer formation include 2-hydroxyethyl methacrylate (HEMA) (via the alcohol group (OH group)), glycidyl methacrylate (GMA) (via the epoxide), and/or allyl methacrylate (AMA) (via the allyl group). By way of example, 2-hydroxyethyl methacrylate (HEMA) monomer may following formation of surface polymers be post-modified at the OH group, through thioesterification, to yield a thioester, optionally followed by further post-modification (deprotection) to deliver a thiol. By way of example, the epoxide group of the glycidyl methacrylate (GMA) monomer may be post-modified by ring-opening of the epoxide group by sodium sulfide and optionally elemental sulfur to yield thiol or polysulfide at a plurality of the repeating units of the surface polymer. By way of example, surface polymers formed from allyl methacrylate (AMA) monomer may be modified through a thiolene reaction to comprise thioether-post-modifications at least some of the repeating units of the surface polymer.

Post-modification to introduce a sulfur-modification may allow for modulation of the amount of sulfur introduced through controlled reaction conversion. By way of example, a surface polymer may be subjected to a sulfur-introducing post-modification step with a specific conversion, which may effectively lead to the formation of an acquired copolymer comprising unmodified repeating units as well as repeating units comprising the sulfur-post-modification. Sulfur-containing surface polymers may, thus, be tailored to accommodate a specific application.

Thus, in some instances, some of the repeating units of the plurality of repeating units may be selected from 2-hydroxyethyl methacrylate (HEMA), glycidyl methacrylate (GMA), 2,3-dihydroxypropyl methacrylate (GMA-OH or DHPMA), and/or allyl methacrylate (AMA), followed by a post-modification to convert at least some of the repeating units to a sulfur-containing repeat unit.

In some instances, some of the repeating units of the plurality of repeating units may be selected from 2-mercaptoethyl methacrylate, 2,3-bis(acetylthio)propyl methacrylate, 2-hydroxy-3-(acetylthio)propyl methacrylate, 3-hydroxy-2-(acetylthio)propyl methacrylate 2,3-dimercaptopropyl methacrylate, 3-hydroxy-2-mercaptopropyl methacrylate, 2-hydroxy-3-mercaptopropyl methacrylate, 2-acetylthioethyl methacrylate, and/or 3-(ethylthio)propyl methacrylate. These repeat units are already sulfur-containing, however, post-modification may be performed so as to convert at least some of the sulfur-containing repeat units to another sulfur-containing repeat unit.

The sulfur-containing surface polymers may be capable of coordinating or binding to a metal through interaction between the metal and the sulfur-containing groups. The metal may be selected from copper (Cu), silver (Ag), gold (Au) or palladium (Pd). Other metals may be nickel (Ni) and platin (Pt).

Sulfur-containing surface polymers, wherein some of the plurality of repeating units comprises a sulfur-containing group being a —SH group may have self-healing properties through cross-linking of at least some of the —SH groups. It is hypothesized that formed sulfur-bridges (e.g. —S—S— or —S—S—S— bonds) may break and reform under certain conditions, e.g., temperature increase and temperature decrease (such as under annealing). This effect may provide a stress-accommodating feature to the sulfur-containing surface polymer.

The adhesion between materials of different composition, such as metals and polymers, is desired in various applications due to the possibility of combining the properties of both metals and polymers. While metal may provide strength, a polymer may provide protection against corrosion and thereby may enhance the durability of the combined material in harsh environments. In addition, polymers may also provide insulation and flexibility, while metals may provide thermal and electrical conductivity. As a result, polymer-metal composite materials have found some applications in various industries such as electronics, automotive, aerospace and medical devices. However, a major concern in bonding metal to another material such as polymer, silicon, glass etc. is a significant mismatch in their coefficient of thermal expansion as well as the potential delamination of the various materials. For example, when a polymer is spin coated onto a certain material and when a large enough change in the temperature this mismatch between metal and spin coated polymer arise, it will lead to the generation of stress at the interface between the metal and the spin coated monomer, which may result in failure in function or properties. It is anticipated that sulfur-containing surface polymers as described herein may improve the adverse effects of coefficient of thermal expansion (CTE) mismatches due to the nature of binding between, on the one hand, the surface polymer to the substrate (covalent binding) acting a stress-accommodating layer, and, on the other hand, the bonding (or interaction) of the metal with the sulfur-containing groups, possibly providing an interlocking of the metal bound to sulfur of the sulfur-containing groups.

Electroless metal deposition plays an important role in the fabrication of electrical circuits in complex devices and for instance on non-electrically conducting substrates because of the ability to produce metal coatings of controllable thickness on complex geometries. The electroless process can generally be divided into four steps: substrate activation by infiltration of catalysts in ionic form like palladium(+2), generation of metallic catalyst sites by reduction of their ionic states like palladium, pre-loading of substrate with a reducing agent like formaldehyde, and finally electroless deposition of metal such as copper (Cu), silver (Ag), or gold (Au) as well as other metals. The process may include multiple cleaning steps, for instance in between the various process steps. There have been efforts to improve the quality of the electroless metal-layer and the adhesion strength between the metal layer and the underlying device substrate. The research has mainly focused on creation of a chemistry at the device substrate surface to promote metal ion bonding/depositing and/or roughening of the device substrates surface to promote adhesion between a copper-layer and the underlying device substrate to increase mechanical interlocking. Two major limitations of these approaches are the absence of a stress buffering layer, and roughness-induced limitation to thin film thicknesses in the device.

In aspects of the present disclosure, a device structure is provided, the device structure comprising: a substrate with a first surface, a surface polymer film comprising surface polymer molecules on at least a portion of a first surface, wherein the surface polymer molecules may comprise a plurality of repeating units, wherein some of the plurality of repeating units may comprise a sulfur-containing group, and a layer of metal at least partially within, and also over, the surface polymer film, wherein the layer of metal may be attached to the surface polymer through bonding of metal atoms of the metal layer to metal atom bound to sulfur in the sulfur-containing groups of the surface polymer.

The device structure may comprise: a surface polymer film formed on a substrate, the surface polymer film comprising surface polymer molecules including sulfur-containing groups, the surface polymer molecules being covalently bonded to polymerization initiation sites on the substrate, a first metal, and a second metal, and a metal layer formed on the surface polymer film by an electroless deposition process. The first metal may be silver (Ag) or copper (Cu) bonded or coordinated to the sulfur-containing groups of the surface polymer. The second metal may be palladium (Pd) deposited during the electroless process. The metal layer may be of copper (Cu) deposited during the electroless process. The substrate may suitably be such specified herein, for example, glass, silicon, a dielectric material, a ceramic, a composite material, or a polymer.

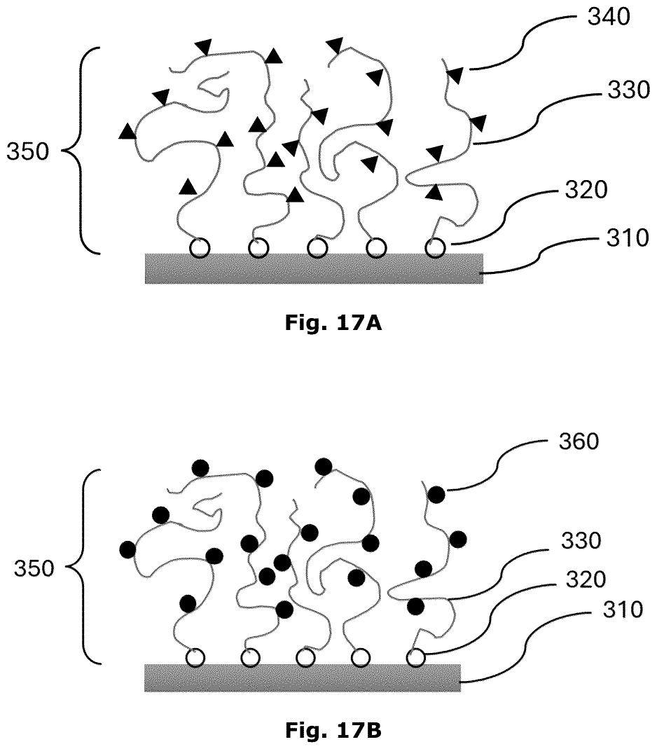

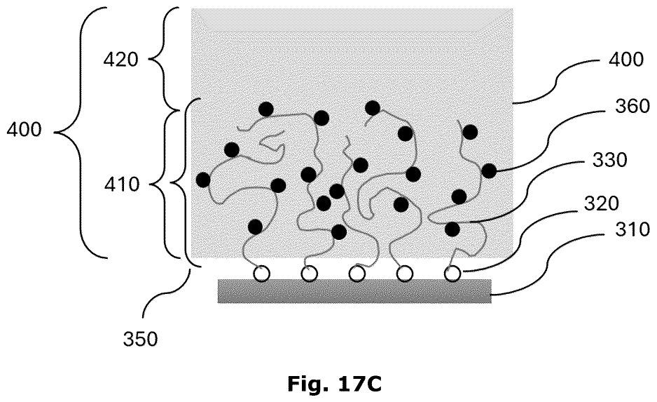

FIG. 17A, FIG. 17B, and FIG. 17C schematically illustrates a device structure. FIG. 17A shows a schematic cross-sectional representation of a device structure with a surface polymer film 350, including surface polymer molecules 330 and sulfur-containing functional groups 340 suitable for bonding with a metal (such as palladium (Pd), copper (Cu), silver (Ag), gold (Au), etc.), formed on a substrate 310 from polymerization initiation sites 320. FIG. 17B shows a schematic cross-sectional representation of the device structure of FIG. 17A with metal-sulfur-inclusion sites 360 (the metal being palladium (Pd), copper (Cu), silver (Ag), gold (Au), etc.). It is to be understood that the metal may bind to all or to some of the sulfur-containing groups on the surface polymer. FIG. 17C shows a schematic cross-sectional representation of the device structure of FIG. 17B with the addition of metal layer 400 (such as copper (Cu)) deposited by an electroless process, the electroless metal being deposited both within 410 and over 420 the surface polymer film 350 of FIG. 17A and FIG. 17B. The surface polymer film 350 is formed from polymerization initiator sites 320 on the substrate 310.

In an aspect of the present disclosure, a device structure is provided. The device structure may comprise: a substrate with a first surface, a sulfur-containing surface polymer as described herein on at least a portion of the first surface, and a layer of metal over the first surface of the substrate, wherein the surface polymer may formed by: providing a substrate, exposing the substrate to a polymerization initiator, exposing the substrate to a reaction composition comprising a monomer, a catalyst, a ligand, an activator, and optionally a solvent, and optionally post-modifying the surface polymer on the substrate so as to provide a surface polymer having a plurality of sulfur-containing repeat units. Non-limiting examples of sulfur-containing chemistries and monomers are those described above.

It is anticipated that the sulfur-containing surface polymers described herein may provide a zone between a substrate and a deposited metal layer due to the conformal coating ability provided by surface polymers formed by the “grafting from” approach, the zone being able to reduce the thermo-mechanical stress at the interface between a substrate and a metal layer as well as facilitate absorption of palladium ions due to the sulfur atom's metal ion binding ability in an activation step before electroless deposition of copper. It is further believed that the sulfur-containing polymer brushes may be able to bind various metals (like copper (Cu), silver (Ag), gold (Au), palladium (Pd), nickel (Ni) and platinum (Pt)) in wet electroless processes due to interaction between the sulfur and the metal. It is believed that the mentioned features may provide an improved copper layer with regard to achieving uniform thickness and low defect densities. Furthermore, it is anticipated that thermo-mechanical stress between the substrate and the copper layer may be reduced by modulating the thickness and/or the elastic modulus of the surface polymer.

Below, the inventors propose a mechanism of binding of metal to the sulfur-containing repeat units of the surface polymer.

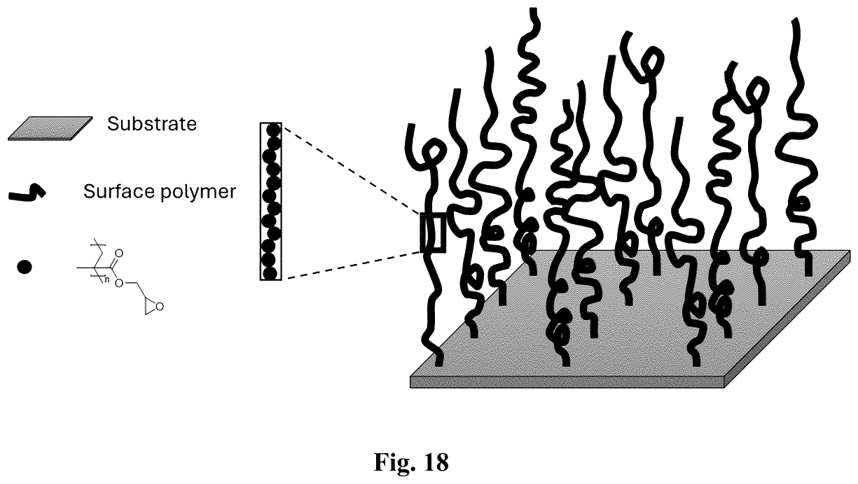

In FIG. 18, a substrate with a surface polymer is shown. The surface polymer is composed of surface polymer molecules (the individual polymer chains) comprising repeat units of glycidyl methacrylate (GMA) having an epoxide group (shown as the enlarged area), the epoxide group. The epoxide group is suitable for post-modification into a sulfur-containing group.

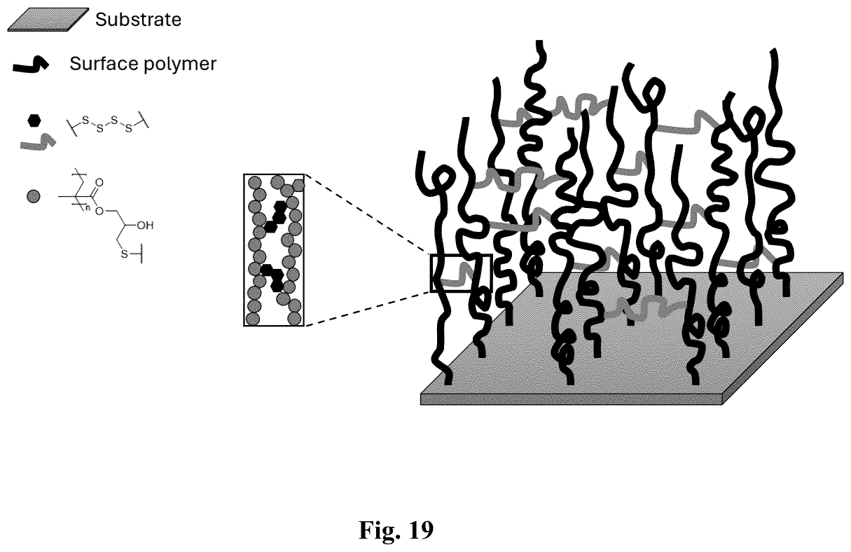

In FIG. 19, the GMA repeat units of FIG. 18 have been post-modified so as to establish polysulfide bridges between adjacent post-modified sulfur-containing repeat units.

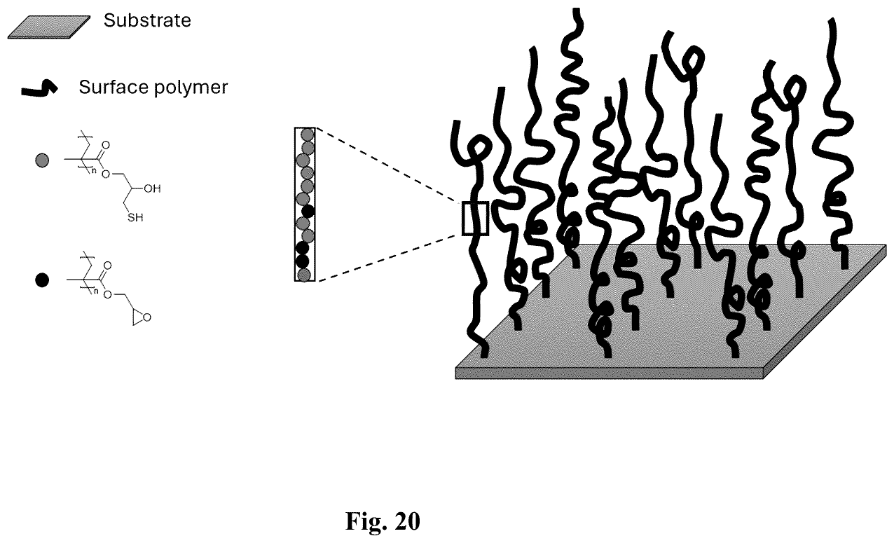

FIG. 20 shows a partial post-modification of ring-opened GMA repeat units (black circles) to form a plurality of sulfur-containing thiol repeat units (gray circles).

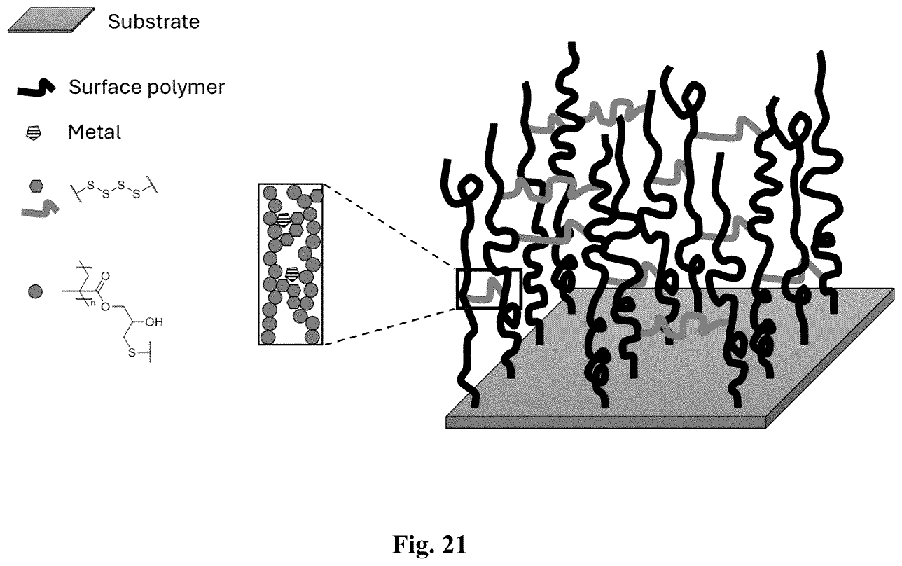

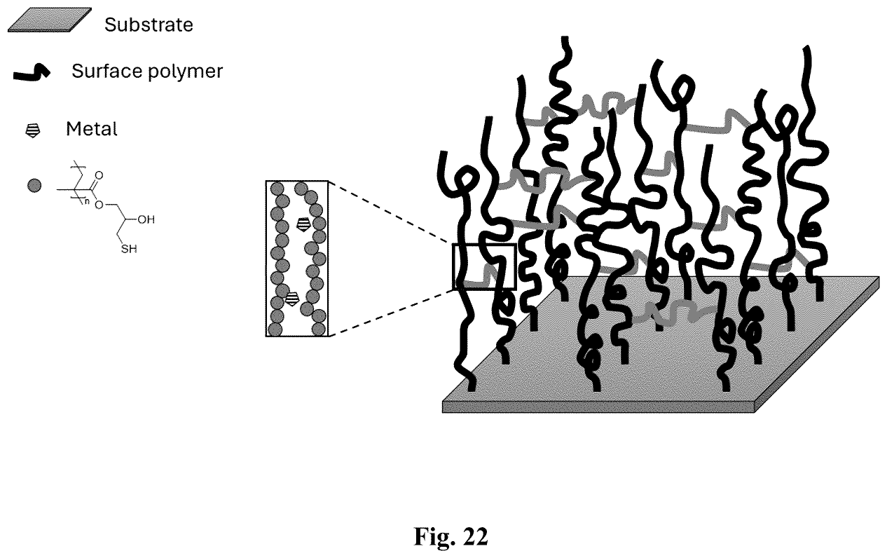

In the case of polysulfur-bridges (as illustrated in FIG. 19), the inventors propose a mechanism of metal binding as illustrated in FIG. 21. In FIG. 21, metal is bonded or coordinated to the polysulfide bridges, thus, possibly interlocking the metal into the surface polymer. Post-modification of the surface polymer having polysulfide bridges to a surface polymer having sulfur-containing thiol repeat units may change the metal from metal in ionic form to metal particles, bonded or coordinated to at least some of the thiol repeat units as illustrated in FIG. 22. The inventors propose that when metal(+) (M(+)) may be reduced to metal particles (M(0)), either by post-modification of polysulfide bridges, or by reaction of metal salt with surface polymer comprising a plurality of thiol-containing repeat units). A non-limiting example might include a metal ion (M(+)) in form of Ag salt (Ag(+)), that reacts with at least some of the plurality of thiol groups, resulting in formation of metal atoms (Ag(0)) interlocked in disulfide crosslinks formed between the plurality of oxidized thiol groups. The mechanism of metal binding/coordination as illustrated in FIG. 22 is believed to be similar in case of other sulfur-containing repeat units (like thioether groups, thionoester groups, and thioester groups). Thus, a method for binding metal to at least some of the plurality of sulfur-containing groups of the surface polymer may comprise forming a surface polymer according to the method described herein, post-modifying, as described herein, the surface polymer so as to convert at least some of the repeat units on the surface polymer to sulfur-containing groups, reacting the surface polymer with a Ag-containing reagent, and optionally post-modifying, as described herein, the sulfur-containing surface polymer reacted with Ag to a thiol group-containing surface polymer.

In the literature, surface functionalization with metal-coordinating moieties have been described. The purpose being to facilitate electroless metal deposition on various materials, however, the chemistry investigated relies on the coordination ability with metal ions in their positive-oxidation state, and consequently, the adhesion between the material and metal layer relies on nonspecific interaction between the metal-coordinating moiety and the metal ion. The present inventors have recognized that sulfur-containing surface polymers described herein may provide metal-thiolate bonds (—S-M, where “M” is the metal) between sulfur-containing groups provided in some of the repeat units of the surface polymer and a metal, e.g., gold (Au), silver (Ag), cobber (Cu), platin (Pt), palladium (Pd), iron (Fe), and nickel (Ni) as well as alloys. It is anticipated that the strong adhesion capability of the sulfur-containing surface polymers may reduce thermo-mechanical stress arising from manufacturing of device packaging or operational temperature of, e.g., semiconductor chips.

A system for preparing the surface polymers as described herein is also disclosed.

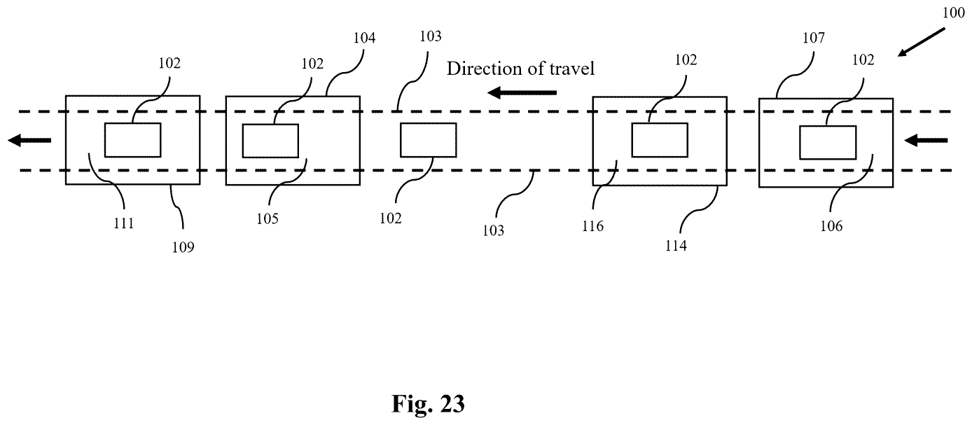

FIG. 23 is a non-limiting schematic illustration of a system 100 for forming surface polymers on at least a portion of a substrate. The methods described herein may be operable on a system 100 as illustrated in FIG. 23 and further described in the following. The system 100 comprises a reaction composition container 104 containing the aforementioned reaction composition 105. Container 104 may relate to any vessel or chamber suitable for holding the reaction composition. At least a portion of a polymerization initiator-modified substrate 102 is brought into contact with the reaction composition 105, for example by at least partly immersing a desired surface of substrate 102 into the reaction composition, thereby enabling surface polymers to form on the substrate.

Optionally, system 100, may comprise one or more further containers, each container comprising different compositions and/or agents for treating the substrate 102, either prior to the substrate being brought into contact with the reaction composition 105, or afterwards, e.g., for post-modifying the obtained surface polymer. Where substrate 102 has not been pre-treated with a polymerization initiator, system 100 may further comprise a container 107 holding a polymerization initiator chemistry, thus, forming the polymerization initiator-modified substrate 102 in said container 107. In some instances, the container 107 may be a vacuum oven and the polymerization initiator chemistry 106 may be a substance volatilized in the vacuum oven or introduced into the vacuum oven in vapor form, where an example polymerization initiator chemistry is CPTMS. Post-modification may include conversion of at least some groups present in the surface polymer to sulfur-containing groups. Post-modification is described above and may include the bringing a surface polymer comprising —OH groups, carbonyl groups, allyl groups, or epoxide groups in the repeat units in contact a post-modification composition. In some instances, the post-modification composition may comprise a thiocarboxylic acid, an azodicarboxylate, a phosphine, and a solvent, or an alkanethiol, a radical initiator, and a solvent, or elemental sulfur, sodium sulfide or a thiolate compound, and a solvent. The specific chemistries are described above.

When FIG. 23 relates to an embodiment in which the substrate has been pre-modified with a polymerization initiator. In such embodiments, and as illustrated in FIG. 23, a cleaning container (or containers, as needed) 114 may be provided, comprising a cleaning agent(s) or a cleaning device(s) 116. The cleaning agent(s)/device(s) 116 may be used to clean the surface of substrate 102 prior to bringing it into contact with reaction composition 105 held by the reaction composition container 104. This may be achieved by, at the very least, subjecting at least a portion of the substrate 102 on which it is desired to form surface polymers on, to cleaning procedures in container(s) 114 using cleaning agent/device 116. In this way, any impurities which may interfere with the formation of the surface polymers, are removed from the surface of substrate 102, prior to bringing substrate 102 into contact with the reaction composition 105. System 100 may additionally include a substrate displacement device 103 for bringing the substrate 102 at least partly into contact with the reaction composition 105 held by the reaction composition container 104 for a controlled time to ensure surface polymers form. The term “at least partly” is intended to mean that a portion or portions of substrate 102 is brought into contact with the reaction composition 105. Alternatively, as mentioned above, the portion or portions of substrate 102 may be covered (“masked”) by, e.g., a film or a layer suited for avoiding contact between the reaction composition 105 and the substrate 102. The displacement device 103 may be used to remove the substrate 102 from the reaction composition 105 following surface polymer formation. Thus, the substrate displacement device 103 may be configured to maintain the surface of substrate 102 at least partly in contact with the reaction composition 105 to enable surface polymers to form on at least a portion of the surface of the substrate, and the substrate displacement device 103 may be configured to maintain the substrate 102 in contact with the reaction composition 105 for a predetermined amount of time.

In instances where the system 100 may comprise two or more containers, such as illustrated in FIG. 23, in addition to bringing substate 102 into contact with the compositions contained by each container, the substrate displacement device 103 is configured to transport substrate 102 to and from each container. For example, as illustrated in FIG. 23, the substrate displacement device 103 is configured to first transport substrate 102 into contact with cleaning agent/device 116 in container 114, and/or a polymerization initiator composition 106 if the substrate is not pre-modified with a polymerization initiator as mentioned previously, held in the polymerization initiator container 107, and subsequently to transport the substrate 102 from the polymerization initiator container 107 to the reaction composition container 104, where the substrate is brought at least partly into contact with the reaction composition 105 held by the reaction composition container 104. In the latter example, the substrate may in embodiments be cleaned between initiator coating and surface polymer formation. In some instances, system 100 may comprise multiple cleaning containers in sequence (not shown).

System 100 as shown in FIG. 23 may further be equipped with a reaction composition management system (not shown). The reaction composition management system may include one or more sensors in relation to the reaction composition container 104. The one or more sensors may be configured to measure a characteristic of the reaction composition 105, which characteristic may relate to a physical or chemical characteristic of the reaction composition 105, such as the pH of the reaction composition and/or the molecular oxygen concentration in the reaction composition. The sensor data may be used to determine whether a value of the measured characteristic lies within a predetermined threshold for the surface polymer formation process. If the measured characteristic is determined to lie outside the predetermined threshold, then the chemistry of the reaction composition 105 may be adjusted by dispensing different chemistries to reaction composition container 104 to adjust the value of the measured characteristic, e.g., an acidic or an alkaline substance to adjust the pH value of the reaction composition 105 or a substance to control the oxygen concentration of the reaction composition 105. In this way, it is possible to ensure that the values of the one or more characteristics of the reaction composition are within a range suitable for forming desired surface polymers on the substrate 102. A control unit operatively connected to the one or more sensors, may be used to control one or more dispensers for dispensing one or more chemistries to control the chemistry of the reaction composition 105.

Similarly, the chemistry of the reaction composition 105 may be adjusted by dispensing any one or more of the components of the reaction composition into the reaction composition 105. For example, the components may relate to any one or more of: at least one monomer, at least one ligand, at least one catalyst, at least one catalyst activator, and at least one solvent. In some embodiments, the control unit may be configured to output a control signal for controlling operation of a dispenser for dispensing one or more components of the reaction composition into the reaction composition 105, in response to the measured characteristic of the reaction composition 105, or in response to an observed time variance of the characteristic. For example, a value of the measured characteristic may be monitored over a time period using the one or more sensors. The control unit may determine to output a control signal to control operation of one or more dispensers to dispense the one or more components on the basis of an observed variation over time of the measured characteristic. The observed variation may be indicative that the chemistry of the reaction composition 105 is varying such that the surface polymer formation process is falling out of specification—for example, surface polymer formation is reduced and/or compromised. The dispensing of one or more components of the reaction composition into the reaction composition 105 may help to maintain one or more chemical properties of the reaction composition 105, to enable the formation of surface polymers. In some instances, dispensing of the one or more control agents and/or components of the reaction composition may occur periodically. In such embodiments, sensor measurement data may be used to ensure the chemical and/or physical characteristics of the reaction composition 105 are as desired. However, dispensing of the one or more control agents and/or components of the reaction composition, and more specifically the outputting of one or more control signals by the control unit to control the dispensers, may be independent of any specific sensor measurement. (The latter method of maintaining the reaction composition 105 may be based on known rates of consumption of components of the reaction composition or on known variation over time of pH or molecular oxygen concentration, for example.) In yet further embodiments, dispensing of the one or more agents and/or components of the reaction composition, and more specifically the outputting of one or more control signals by the control unit, may be directly dependent on one or more measured characteristics of the reaction composition 105. Similarly, the outputting of one or more control signals by the control unit to control dispensing of the one or more control agents and/or components of the reaction composition may be dependent on a measured sensor signal indicative of a change in a measured characteristic of the reaction composition 105. Combinations of some of these different methods may also be advantageous, for example using dispensing of agents and/or components for maintenance of the reaction composition 105 over shorter time intervals without use of sensor measurements, combined with adjustments being made based on regular sensor measurements made at longer time intervals.

In some instances, it may be beneficial to control the environmental conditions in which the system 100 is implemented, and in particular in which the surface polymers are formed. For example, this may help to reduce contaminants and other impurities contaminating the reaction composition 105 and/or the substrate 102. Non-limiting examples of contaminants and impurities may include bulk polymers or metals. Similarly, controlling environmental conditions such as, but not limited to, pressure, temperature, humidity, and/or inert atmosphere, may be beneficial to the process for forming surface polymers. To achieve this, in some embodiments, system 100 may be implemented in an environmentally controlled chamber. For example, the aforementioned containers may sit within one or more environmentally controlled chambers. In some embodiments all of the containers may sit within one or more chambers. In some embodiments a subset of the containers may sit within one or more chambers. For example, it is envisaged that in some embodiments the polymerization initiator container may sit within a chamber, whilst the reaction composition container 104, may sit outside a chamber. Similarly, in some embodiments it is envisaged that cleaning of the substrate prior to polymerization initiator formation may also occur in an environmentally controlled chamber, in which case the associated cleaning agent container also could sit within an environmentally controlled chamber.

The substrate displacement device 103 may relate to any device capable of transporting the substrate from one container to another container. For example, the substrate displacement device 103 may relate to a mechanical device. In particular, it is envisaged that the substrate displacement device 103 may comprise any one of: a conveyor system; a programmable mechanical arm or arms; and/or a roll-to-roll processor/mechanism.

A conveyor system as used herein may refer to a mechanical system that is used to move a material, such as the substrate, which in embodiments may be in a substrate holder on its own or with other substrates, from one process container to another, typically comprising a movable conveyor, powered by a drive system and having a series of rollers or pulleys that support and guide the belt. In use, the substrate may be placed on the conveyor which passes the substrate through the one or more containers comprised in the system. In this way, as the conveyor is powered, the substrate is passed through the component(s) held by each container within the system. Furthermore, in some embodiments the containers are enclosures in which the reaction composition, or other appropriate wet chemistry, is uniformly applied over the substrate using spray nozzles.

In some instances, a programmable mechanical arm, such as a robotic arm, may be used to transport the substrate, which may be in a holder as described above. The programmable mechanical arm, in embodiments, has the capability to move substrate holders horizontally and vertically in and out of containers and from container to container. The programmable mechanical arm may be equipped with gripping devices comprising suction devices, enabling handling of larger substrates. Such gripping device is, e.g., disclosed in WO 2019/114893.

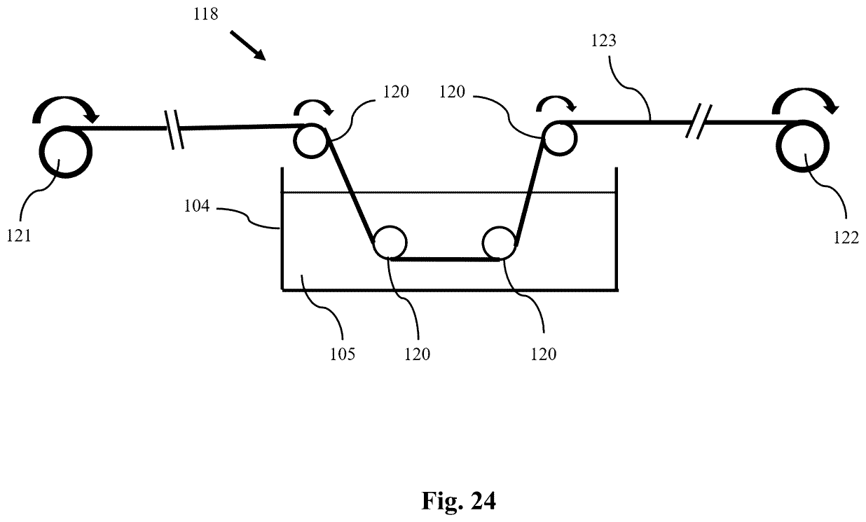

A roll-to-roll processor or mechanism may be particularly b for use where the substrate may be flexible and elongated, such as a cable, wire, foil, or any other elongated flexible substrate. FIG. 24 illustrates such an embodiment, in which the substrate displacement device relates to a roll-to-roll processor 118, comprising a sending roll 121, a receiving roll 122 and a plurality of rollers 120. At least some of the rollers 120 and the receiving roll 122 are driven, thereby enabling a flexible elongated substrate 123 to be passed from sending roll 121 through the reaction composition 105 in container 104 to the receiving roll 122. The roll-to-roll mechanism can be utilized as a replacement to the substrate displacement device 103 in FIG. 24 when elongated flexible substrates are being processed. In some instances, the substrate may be masked in certain areas to form surface polymers only from unmasked polymerization initiator. In some embodiments, polymerization initiator sites may only be attached at certain portion(s) on the substrate as described above. In some embodiments, only the portion(s) of the substrate is immersed into the reaction composition to form surface polymers on the portion(s) of the substrate being in contact with the reaction composition. In some embodiments, forming surface polymers on portion(s) of the substrate may be a combination of masking and bringing only the desired portion(s) of the substrate in contact with the reaction composition. The substrate displacement device or another type of substrate displace device may be suited for carrying out the specific contact between the substrate and the reaction composition.

In some instances, at least one of the plurality of containers may comprise an annealing oven for annealing the formed surface polymers. In a similar manner as described previously, the substrate displacement device 103 may be configured to transport the substrate with the formed surface polymers to the annealing oven 109 and to bring the substrate with surface polymers into position for annealing. The annealing oven is equipped with a heating device for annealing the formed surface polymers and the gas environment 111 in the oven may be controlled as needed—for example, to avoid oxidation by using only non-oxidizing gases.

According to a specific instance, a system for forming surface polymers on a substrate may comprise: a reaction composition container containing a reaction composition, said reaction composition comprising: a monomer, a catalyst, a ligand, a catalyst activator, and a solvent, and a substrate displacement device for bringing at least a portion of a polymerization initiator-modified substrate into contact with the reaction composition in the reaction composition container for a controlled time, wherein the controlled time is sufficient for surface polymers to be formed on the portion of the polymerization initiator-modified substrate, and a post-modification container containing a post-modification composition, said post-modification composition comprising: a thiocarboxylic acid, an azodicarboxylate, a phosphine, and a solvent, or an alkanethiol, a radical initiator, and a solvent, or elemental sulfur, sodium sulfide or a thiolate compound, and a solvent, and a substrate displacement device for bringing the surface polymer covered substrate into contact with the post-modification composition in the post-modification composition container for a controlled time, wherein the controlled time is sufficient for conversion of at least some of the groups present on repeat units in the surface polymer to sulfur-containing groups. Furthermore, the substrate displacement device may comprise any one of: a conveyor system, a programmable mechanical arm, or a roll-to-roll mechanism. Furthermore, the system may comprise a polymerization initiator container containing a polymerization initiator agent, wherein the substrate displacement device is configured to bring the portion of the substrate for attachment of polymerization initiators into contact with the polymerization initiator agent to form polymerization initiators at the substrate surface, prior to bringing the portion of the polymerization initiator-modified substrate into contact with the reaction composition. Furthermore, the system may comprise a cleaning container, the cleaning container containing a cleaning agent, wherein the substrate displacement device is configured to bring the portion of the polymerization initiator-modified substrate into contact with the cleaning agent prior to, or subsequent to, bringing the portion of the polymerization initiator-modified substrate into contact with the reaction composition; or the substrate displacement device is configured to bring the portion of substrate into contact with the cleaning agent prior to, or subsequent to, bringing the portion of the substrate into contact with the polymerization initiator. Furthermore, extra containers may be added as needed for rinsing or cleaning, etc. between processes. The substrate displacement device may be one or more robots or a conveyor system with the capability to move substrate holders horizontally and vertically in and out of containers and from container to container.

The disclosure as provided herein is illustrated by the following, non-limiting examples.

### EXAMPLES

### List of Materials Used in the Examples

Throughout the examples, DI-water refers to tap water deionized using the deionizing equipment (Silhorko with M22-F softening plant, RO B1-2 Reverse Osmosis plant and Silex 2BS mixed bed plant). The DI-water has a conductivity of <0.5 μS/cm, indicating an ultrapure quality with very low presence of ions, below 0.1 mg/L. The quality of the DI-water is confirmed at least weekly.
Silicon wafer substrates, Test CZ—Si wafer, 4 inch, thickness=525±25 μm, (100), p-type (Boron), were purchased from MicroChemicals GmbH (r=5.08 cm) and cut into ¼th of a wafer.
Corning Eagle Glass XG (Eagle glass, EG) 100×100×0.7 mm, 2-side polished was purchased from MTI Corporation. Cut into 100×25×0.7 mm pieces.
Ammonia (NH₃, 25% p. a) was purchased from Chemsolute.
Acetone (>99%) was purchased from Chemsolute.
Acetonitrile (MeCN) (≥99.9%) was purchased from Chemsolute
Dimethylsulfoxide (DMSO) (≥99%) was purchased from Tokyo Chemical Industr Dichloromethane (DCM) (99.9%) was purchased from ChemSolute.
Dimethylformamide (DMF) (99.9%) was purchased from Chemsolute.
Toluene (99.8%) was purchased from Chemsolute.
ABC clean A200 was purchased from ABC-Clean ApS.
Isopropanol (iPrOH) (≥99.8%) was purchased from Chemsolute.
Sodium hydroxide (NaOH) (≥99.0%) was purchased from Chemsolute.
p-(chloromethyl)phenyltrimethoxysilane (CPTMS) (95%) was purchased from Gelest.
tris[2-(dimethylamino)ethyl]amine (Me₆TREN) (≥98%) was purchased from from abcr or Alfa Aesar.
tris(2-pyridylmethyl)amine (TPMA) (98%) was purchased from Tokyo Chemical Industry.
N,N,N′,N″,N″-Pentamethyldiethylenetriamine (PMDETA) (99%) was purchased from Sigma Aldrich.
Copper(II)chloride dihydrate (CuCl₂·2H₂O) (99.0%) was purchased from Sigma Aldrich.
Copper hydroxide (CuOH₂) (≥97.5%) was purchased from Carl Roth GmbH.
Sodium ascorbate (NaAsc) (98%) was purchased from Sigma Aldrich.
Triethylamine (Et₃N) (≥99.0%) was purchased from Tokyo Chemical Industry.
Dithiothreitol (DTT) (≥99.5%) was purchased from ITW Reagents.
Triphenylphosphine (Ph₃P) (99%) was purchased from Sigma Aldrich.
Tetrahydrofuran (THF) (≥99.9%) was purchased from Chemsolute.
Diisopropyl azodicarboxylate (DIAD) (98%) was purchased from Sigma Aldrich.
Thioacetic acid (AcSH) (96%) was purchased from Sigma Aldrich.
Sodium sulfide (Na₂S) (98.0% min) was purchased from Thermo scientific.
Sulfur powder (Elemental sulfur, Ss) (99%, sublimed) was purchased from abcr Gmbh.
Sodium bicarbonate (NaHCO₃) (≥99.7) was purchased from Chemsolute.
Sodium carbonate (Na₂CO₃) (min 99.8%) was purchased from Chemsolute
Allyl methacrylate (AMA) (98%, containing 50-185 ppm MEHQ) was purchased from Sigma-Aldrich.
2-hydroxyethyl methacrylate (HEMA) (99%, <250 ppm MEHQ inhibitor) was purchased from Sigma Aldrich Methyl methacrylate (MMA) (99%, 30 ppm MEHQ inhibitor) was purchased from Sigma Aldrich (lot no. STBK8834).
Glycidyl methacrylate (GMA) (≥97%) was purchased from Sigma Aldrich.
Hydrazine hydrate solution (N₂H₄) (50-60%) was purchased from Sigma-Aldrich.
Ethylenediaminetetraacetic acid (EDTA) (≥99.4%) was purchased from Sigma-Aldrich.
Paraformaldehyde (95%) was purchased from Sigma-Aldrich.
“1 M carbonate buffer” was made as follows: NaHCO₃ (1.53 kg) and Na₂CO₃ (0.220 kg) was dissolved in 20 kg DI-water.

### List of Equipment Used in the Examples

“Big sonicator” refers to an ULTRASONIC CLEANER PROCLEAN 28.0 from Ulsonix (40 kHz, 480 W).
“Sonicator” refers toto a Bandelin Sonorex Super RK100 sonicator (35 kHz ultrasound frequency, 80 W nominal ultrasonic power).
“Vacuum oven” refers to a Faithful Vacuum Drying Oven-DZ-BCII.
“Oven” refers to a Binder model FD 56.

Ellipsometry was measured on a J. A. Woollam M-2000 Ellipsometer. This instrument was set to measure 10 points on each substrate. Each point was analyzed using a Cauchy model providing a thickness and a Mean Square Error (MSE), the latter referring to the goodness of the fit. Thicknesses are thus given as the average of all measured points on the substrate. Unless specifically stated otherwise, 10 data points were obtained on each substrate. Standard deviation is the standard deviation based on the entirety of the measured thicknesses. The standard deviation is an estimate of the homogeneity of a surface polymer formed.

Transmission Fourier-transform infrared spectroscopy was (T-FTIR) measured on a PerkinElmer Spectrum Two instrument. The IR beam was shined through a substrate placed at an 45° angle and the data reported as an average of 32 scans. A blank Si wafer flushed in iPrOH was used as a background. Baselining of the spectra was done manually using a linear relation. Water contact angles (WCA) were measured on a Kruss Mobile Surface Analyzer. In 5 separate points, the contact angle of a DI-water and a CH₂I₂ drop is measured. Using the software ADVANCED v. 1.14, the surface free energy (SFE) can be calculated. The SFE indicates the maximum surface tension of a liquid that wets a solid surface, under ideal conditions. Accordingly, a material with a high SFE is easier to wet than a material with a lower SFE, and low SFE materials will generally exhibit higher water contact angles than those materials with a higher SFE.

XPS was recorded on a Thermo Fischer NEXSA instrument, with a monochromated A1 K-alpha X-ray. For all measurements a flood gun was utilized for charge compensation. For survey spectra the pass energy was 200 eV, the dwell time was 10 ms, and the energy step size (binding energy resolution) was 1 eV. For high resolution XPS (HR XPS) the pass energy was 50 eV, the dwell time was 50 ms, and the energy step size was 0.1 eV. Reported elemental compositions are based on measurements in 3 spots on each substrate.

### Example 1

### Pre-Cleaning of Silicon Substrates

The total number of substrates pre-cleaned at a time may vary.

Racks holding the substrates were placed in a 3.75% aqueous solution of NH₃ and sonicated for 10 minutes in a big sonicator. Then, the substrates were flushed with DI-water and sonicated in DI-water for 10 minutes using the big sonicator. Thereafter, the racks holding the substrates were transferred to a 5% solution of ABC clean A200 and sonicated for 10 minutes in the big sonicator. This step was followed by flushing the substrates in DI-water and sonicating the substrates in DI-water for 5 minutes in the big sonicator. Finally, the substrates were flushed with acetone and left to dry at ambient conditions (room temperature, ambient pressure).

### Example 2

### Pre-Cleaning of Glass Substrates

The total number of substrates pre-cleaned at a time may vary.

Eagle glass (EG) substrates (100×25×0.7 mm) were placed in a slide rack in a vertical orientation throughout the entire cleaning and drying process. The rack with substrates were dipped in isopropanol (iPrOH) to remove of any adsorbed dust particles and other residues, and then air-dried at ambient conditions (ambient pressure, ambient temperature). Following drying, the substrates were immersed in 5M NaOH solution at a temperature of approximately 60° C. and sonicated in the big sonicator for 10 minutes. The substrates were then washed by dipping in DI-water, flushing with DI-water, and sonicating in the big sonicator in fresh DI-water. Then, the substrates were flushed in iPrOH followed by 5-minute sonication in the big sonicator in fresh iPrOH. Finally, the substrates were dried in the oven at 80° C. for 15 minutes.

### Example 3

Chemical Vapor Deposition of Polymerization Initiator (p-chloromethyl)phenyltrimethoxysilane)

Substrates (silicon wafer (Si) substrates, or Eagle glass (EG) substrates), pre-cleaned as described in Example 1 or Example 2, respectively, were used for polymerization initiator-modification with CPTMS using a chemical vapor deposition method as described below.

The substrates were placed in a rack and placed in a vacuum oven with 16 vials of 100 μL CPTMS (polymerization initiator liquid) at approximately 100° C. for 30 minutes. The gauge pressure was lowered to −1.0 bar, whereby the CPTMS evaporated, and the substrates were left for 30 minutes in the vapor. The surface modification was verified using WCA. The surface free energy (SFE) for both blank substrates and CPTMS-modified substrates are provided in Table 1. Compared to the blank substrate, the CPTMS-modified substrate displays lowered SFE, indicative of an increased hydrophobicity caused by the successful attachment of the organic CPTMS layer.

TABLE 1
Contact angles (CA) of water and diiodomethane and surface free
energy (SFE) of untreated (blank) and a CPTMS-modified substrate.

| Substrate type | CA (H₂O) [°] | CA (CH₂I₂) [°] | SFE [mN/m] |
|---|---|---|---|
| Si (Blank) | 56 ± 3 | 48 ± 1 | 51 ± 3 |
| Si (CPTMS-modified) | 65 ± 3 | 53 ± 1 | 45 ± 2 |

The inventors believe that a lower surface free energy following the CPTMS-modification in indicative of the Cl-moiety being covalently attached to the substrate. Furthermore, it is expected that essentially all available binding sites on the substrate surface became modified with polymerization initiators due to the large excess of CPTMS in the vapor phase.

### Example 4

Formation of poly(2-hydroxyethyl methacrylate) Surface Polymers (PHEMA)

This example illustrates the formation of surface polymers of 2-hydroxyethyl methacrylate monomer (HEMA). The PHEMA surface polymer has —OH groups in the plurality of repeat units which may subsequently be post-modified to introduce sulfur-containing groups into the surface polymer.

The catalyst/ligand solution was prepared as follows: 14.0 mg TPMA and 1.17 mL HEMA was mixed in Container C and sonicated until homogeneous (approximately 3 minutes). Then, 1.55 mL of a copper solution (1513.9 mg CuCl₂·2H₂O in 1000 mL DI-water) was added to Container C, and the mixture was vortexed until homogeneous (approximately 1 minute).

The reaction composition was prepared as follows: To a glass container (Container A), catalyst/ligand solution (2.67 mL) was added followed by HEMA monomer (51.3 mL), DI-water (55.0 mL), and 0.6 M carbonate buffer (pH 8.9, 55.0 mL). In a separate container (Container B) a solution of sodium ascorbate (NaAsc) (667 mg in 2.50 mL DI-water) was prepared. The content of Container B was poured into Container A, and the reaction composition was left for 5 minutes to activate the catalyst/ligand complex. During the 5 minutes of activation time, the pH was adjusted to 8.9 by addition of concentrated H₂SO₄.

CPTMS-modified substrates (2 Si substrates and 8 EG substrates, pre-cleaned as described in Example 1 or Example 2, respectively, and modified with polymerization initiator CPTMS as described in Example 3) were placed in a reaction container and the content of Container A was poured into the reaction container. To adjust volume, DI-water (10 mL) and HEMA monomer (5 mL) were added and the reaction container was slightly stirred. The substrates were left in the reaction composition for 40 minutes and were subsequently dipped in DI-water, then sonicated in DI-water for 5 minutes, before being flushed by acetone, then sonicated for 5 minutes in acetone. Subsequently, the substrates were left to dry at ambient conditions (atmospheric temperature and ambient pressure). After cleaning and drying, the Si substrates were subjected to ellipsometry to measure the average dry film thickness of the formed surface polymers. The average dry film thicknesses of the Si substrates were 112±2 nm for both Si substrates. Due to poor ellipsometric fitting of the glass substrates (EG glass) caused by similarities in optical properties between the EG substrates and the surface polymer, as well as a reflection aspect, ellipsometric analysis was performed only for Si substrates. As both types of substrates were polymerized in the same reaction composition for the same polymerization time, it was assumed that formation of PHEMA surface polymers on the EG substrates were also successful.

### Example 5

Post-Modification of PHEMA Surface Polymer to Form Sulfur-Containing Surface Polymers with PHEMA and PATEMA Repeat Units

In this example, PHEMA surface polymer (Example 4) was post-modified to obtain sulfur-containing repeat units. The post-modification procedure involved thioesterification of some of the HEMA repeat units of the PHEMA surface polymer. Thus, by the thioesterfication post-modification, some of the plurality of HEMA repeat units were modified to the sulfur-containing ATEMA (2-acetylthioethyl methacrylate) repeat unit.

In a glass slide holder, triphenylphosphine (Ph₃P) (18.04 g) was added, and the vessel was closed with a septum-lid. A nitrogen atmosphere was introduced, and THF (177.6 mL) was added. The vessel was sonicated in a sonicator until all Ph₃P was dissolved (approximately 1 minute). Diisopropyl azodicarbodylate (DIAD) (14.2 mL) was added through the septum, and the mixture was agitated on a shaking table (80 rpm) for 1.5 hour. Then, the mixture was cooled to 0° C. in an ice bath. The septum-lid was briefly opened, and substrates (8 EG substrates, 2 Si substrates), prepared as described in Example 4) were added to the post-modification mixture. The septum-lid was closed, and a nitrogen atmosphere was introduced. Thioacetic acid (AcSH) was added through the septum, and the mixture with substrates was agitated on a shaking table (80 rpm) for 1 hour with continued cooling. The substrates were recovered from the mixture and were post-cleaned by flushing with saturated aqueous NaHCO₃, sonicating in saturated aqueous NaHCO₃ for 5 minutes, flushing with DI-water, sonicating in DI-water for 5 minutes, flushing with acetone, and sonicating in acetone for 5 minutes.

The water contact angle (WCA) for both Si and EG substrates, before and after the modification, are shown in Table 2. From these, it was concluded that all substrates display significantly increased hydrophobicity after the AcSH post-modification which was expected following conversion of a plurality of highly polar OH-groups of PHEMA to the less polar SAc group of PATEMA. By the post-modification, the PHEMA surface monomer was converted to a random block co-polymer of PHEMA and PATEMA (PHEMA-co-PATEMA).

TABLE 2
Water contact angle (WCA) data of Si-PHEMA and
EG-PHEMA substrates before and after post-modification
and formation of PHEMA-co-PATEMA).

| Substrate | WCA [°] (PHEMA) | WCA [°] (PHEMA-co-PATEMA) |
|---|---|---|
| Si_1 | 55.9 | 69.3 |
| Si_2 | 53.6 | 67.7 |
| EG_1 | 48.9 | 65.0 |
| EG_2 | 51.0 | 70.0 |
| EG_3 | 51.7 | 68.6 |
| EG_4 | 51.5 | 67.0 |
| EG_5 | 51.6 | 70.3 |
| EG_6 | 51.9 | 71.1 |
| EG_7 | 52.1 | 69.4 |
| EG_8 | 52.4 | 69.3 |

The ellipsometry data, recorded for Si-PHEMA substrates, before and after the post-modification with AcSH, are given in Table 3. Due to poor ellipsometric fitting of EG substrates (caused by similarities in optical properties between the EG substrates and the surface polymer, as well as reflection issues), ellipsometric analysis was performed only for Si substrates, and a similar outcome was surmised for the EG substrates based on the highly similar WCA data of Si substrates and EG substrates before and after post-modification with AcSH. From the data shown in Table 3, it was concluded that post-modification was successful as the substrates have significantly higher average dry film thicknesses of the surface polymer following the post-modification, implying that a plurality of the OH-groups of PHEMA was post-modified to the larger SAc group of PATEMA via the thioacetylation post-modification procedure.

TABLE 3
Ellipsometric data of Si-PHEMA substrates before and after post-
modification to form Si-P(HEMA-co-ATEMA) surface polymers.

| | | Average Dry Film |
|---|---|---|
| | Average Dry Film | Thickness (nm) |
| Substrate | Thickness (nm) (PHEMA) | (PHEMA-co-PATEMA) |
| Si_1 | 112.2 ± 2.2 | 137.0 ± 9.9 |
| Si_2 | 112.1 ± 2.0 | 135.4 ± 7.9 |

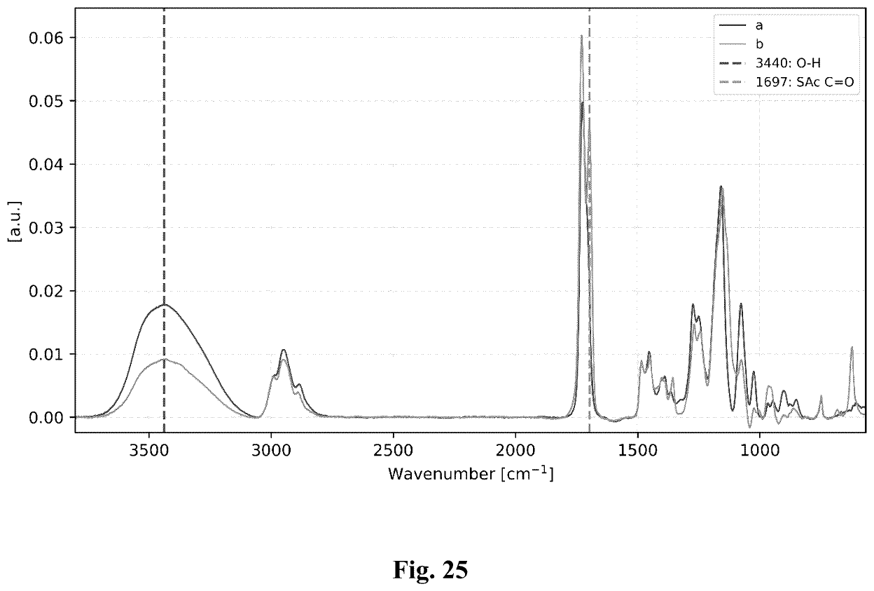

The T-FTIR spectra, recorded for Si-PHEMA substrates before and after the post-modification with AcSH, are provided in FIG. 25. FIG. 25 confirms that the post-modifications as the Si substrates display significantly altered IR spectra following the post-modification (reduced O—H stretch band and a new SAc carbonyl stretch band at 1695 cm⁻¹). The inventors interpret the spectra as an indication of 5-30% conversion of PHEMA —OH groups into S-containing ATEMA groups. Furthermore, the inventors expect that the procedure can be optimized to specifically control the conversion ratio of PHEMA OH-groups.

Due to the highly absorbing nature of Si—O bonds in the infrared region, the EG substrates (glass is rich in Si—O bonds) could not be analyzed by T-FTIR, but a similar post-modification outcome was assumed based on the highly similar WCA data of Si and EG substrates before and after post-modification with AcSH.

### Example 6

### Formation of PHEMA-Co-PMEMA Surface Polymer

In this example, the P(HEMA-co-ATEMA) surface polymer of Example 5 was converted into poly(2-hydroxyethyl methacrylate-co-2-mercaptoethyl methacrylate) (PHEMA-co-PMEMA) surface polymer by cleavage of the thioester groups (SAc groups) of the ATEMA repeat units.

In a 200 mL glass vessel with a septum-lid, dithiothreitol (DTT) (0.692 g) was dissolved in N,N-dimethylformamide (DMF) (15 mL). One Si-PHEMA-co-PATEMA substrate, prepared as described in Example 5, was added, and an N₂ atmosphere was introduced. Triethylamine (Et₃N) (41.7 μL) was added, and the mixture and the substrate were shaken on a shaking table (80 rpm) overnight. The substrate was post-cleaned by flushing with saturated aqueous NaHCO₃, sonicating in saturated aqueous NaHCO₃ for 5 minutes, flushing with DI-water, sonicating in DI-water for 5 minutes, flushing with acetone, and sonicating in acetone for 5 minutes.

The water contact angles (WCA) for the Si-PHEMA-co-PATEMA substrate before and after the post-modification to Si-PHEMA-co-PMEMA are shown in Table 4. From the WCA data, it was concluded that the substrate displayed increased hydrophilicity after the post-modification which corresponded to the conversion of SAc groups of the ATEMA repeat units to the more polar SH-groups of the MEMA repeat units. Thus, the modification was considered successful.

TABLE 4
Water Contact Angle (WCA) data of Si-PHEMA-co-PATEMA substrate
before and after post-modification to Si-PHEMA-co-PMEMA.

| | WCA [°] | WCA [°] |
|---|---|---|
| Substrate | (PHEMA-co-PATEMA) | (PHEMA-co-PMEMA) |
| Si_3 | 74.9 | 53.7 |

The ellipsometry data, recorded for the Si—P(EMA-co-PATEMA substrate before and after the post-modification to Si-PHEMA-co-PMEMA, are shown in Table 5. Lower average dry film thickness was observed following the post-modification, confirming conversion of the SAc-group of ATEMA repeat units to the smaller SH-groups of MEMA repeat units, and the data, thus, confirm successful post-modification.

TABLE 5
Ellipsometric data of a Si-PHEMA-co-PATEMA substrate before
and after post-modification to Si-PHEMA-co-PMEMA.

| | Thickness (nm) | Thickness (nm) |
|---|---|---|
| Substrate | (P(HEMA-co-ATEMA)) | (P(HEMA-co-MEMA)) |
| Si_3 | 112.4 ± 1.5 | 103.9 ± 0.9 |

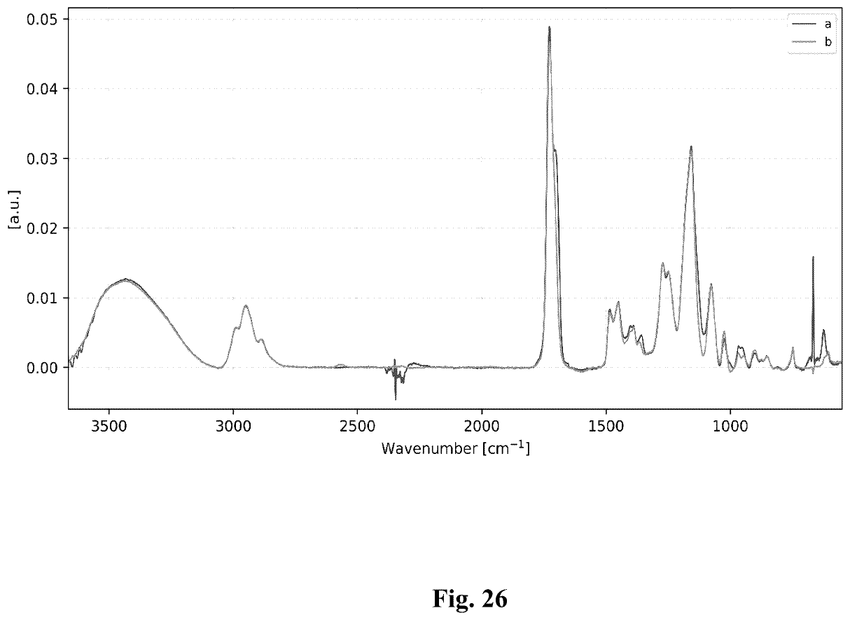

The T-FTIR spectra, recorded for the Si—P(HEMA-co-ATEMA) substrate before and after the modification to Si—P(HEMA-co-MEMA), are shown in FIG. 26. The substrate displays an altered IR spectra following the post-modification (appearance of an S—H stretching band at 2565 cm⁻¹ and the disappearance of the SAc carbonyl peak at 1695 cm⁻¹, both being indicative of cleaving off the acetyl group (Ac) of PATEMA to generate the SH group) indicating almost full conversion of from one sulfur containing group to another.

### Example 7

### Formation of Poly(Glycidyl Methacrylate) (PGMA) Surface Polymers

In this example, PGMA surface polymers were formed. The formed PGMA surface polymers were used for selective post-modification to replace a number of the epoxide groups of the plurality of GMA repeat units with a sulfur-containing group.

The catalyst solution was made as follows: To a vial, TPMA (84.5 mg), CuCl₂ solution (9 mL from a solution of CuCl₂·2H₂O (34.2 mg) and DI-water (90 mL)) and EtOH (7 mL) were added, and the vial was capped and sonicated in a sonicator for 5 minutes.

The reaction composition for forming the surface polymer on the substrates was prepared as follows: To a glass container (Container A), DI-water (554 mL), catalyst solution (16 mL), EtOH (340 mL) and GMA monomer (75 mL) were added. In a separate container (Container B) a solution of NaAsc (4001 mg in 15 mL DI-water) was prepared. The content of Container B was poured into Container A, and the reaction composition was left for 5 minutes to activate the catalyst/ligand complex.

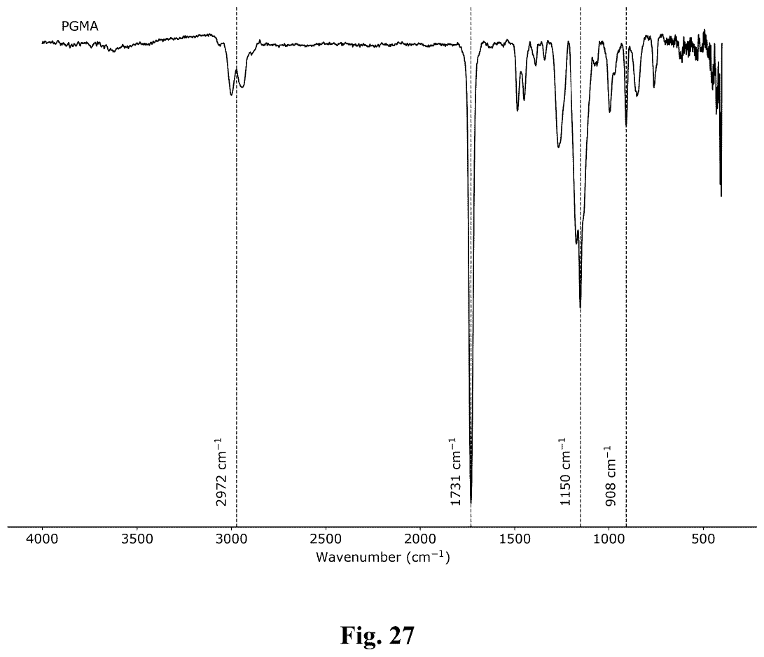

CPTMS-modified substrates (polymerization initiator CPTMS), pre-cleaned as described in Example 1 and modified as described in Example 3, were placed in a reaction container and the reaction composition of Container A was poured into the reaction container. The substrate was left to react for 20 minutes and was subsequently dipped in DI-water, then sonicated in DI-water for 5 minutes, before being flushed by acetone, then sonicated for 5 minutes in acetone. Subsequently, the substrate was left to dry at ambient conditions (ambient temperature and pressure). After cleaning and drying, the substrates were subjected to ellipsometry to measure the average dry film thickness of the formed PGMA surface polymers. The average dry film thickness of all substrates was measured to 94±3 nm. The water contact angle of 6 substrates was found to be 580±0.4°. T-FTIR (FIG. 27) confirmed the structure of PGMA: Peaks at around 2972 cm⁻¹ confirmed presence of —CH₂— (backbone structure), peak at 1731 cm⁻¹ confirmed presence of a carbonyl group (C(O)), peaks around 1150 cm⁻¹ confirmed the presence of C—O groups (found in the ester group of the methacrylate and the epoxide moiety), and peak at 908 cm⁻¹ further confirmed the presence of the epoxide groups.

### Example 8

### Post-Modification of PGMA Surface Polymers

In this example, the PGMA surface polymers were post-modified to ring-open the epoxide group and form a sulfur-containing surface polymer. The glycidyl moieties of PGMA is, as an electrophile, able to undergo reaction with a polysulfide solution to form S—S crosslinks from ring-opening of the epoxide groups on the PGMA surface polymer.

The polysulfide agent for epoxide ring opening was prepared as follows: To a round bottomed flask in an oil bath equipped with a magnet, EtOH (7.00 mL), DI-water (28.00 mL) and Na₂S (34.0 g) were added. The mixture was heated to 60° C. and put on stir for 30 minutes. In small portions, elemental sulfur (19.0 g) was added over the course of 20 minutes. Then, the solution was stirred for 60 minutes at 60° C.

To a reaction container, EtOH (525 mL) and NaHCO₃ (140 mL, aq. sat.) were mixed by stirring with a metal spoon. Polysulfide agent prepared above was carefully added and mixed by stirring.

30 PGMA-modified substrates (prepared according to Example 7) were placed in the reaction container holding the sulfur post-modification chemistry. The substrates were left for 5 minutes. Thereafter, the substrates were withdrawn and flushed with ethanol (EtOH), then dipped in DI-water, and sonicated in acetone for 10 minutes. The post-modified substrates were left to dry at ambient conditions (atmospheric temperature, ambient pressure). After cleaning and drying, the post-modified substrates were subjected to ellipsometry to measure the average dry film thickness of the formed surface polymer. The average dry film thickness was measured to 112±2 nm corresponding to a 20% increase in thickness as compared to the average dry film thickness of the PGMA surface polymer. The water contact angle of 1 point on 3 substrates was found to be 550±2°. The drop in 3 points of the water contact angle indicates a more hydrophobic surface coherent with the opening of the epoxide ring which yields free —OH groups and a polysulfide being formed between adjacent ring-opened epoxide groups.

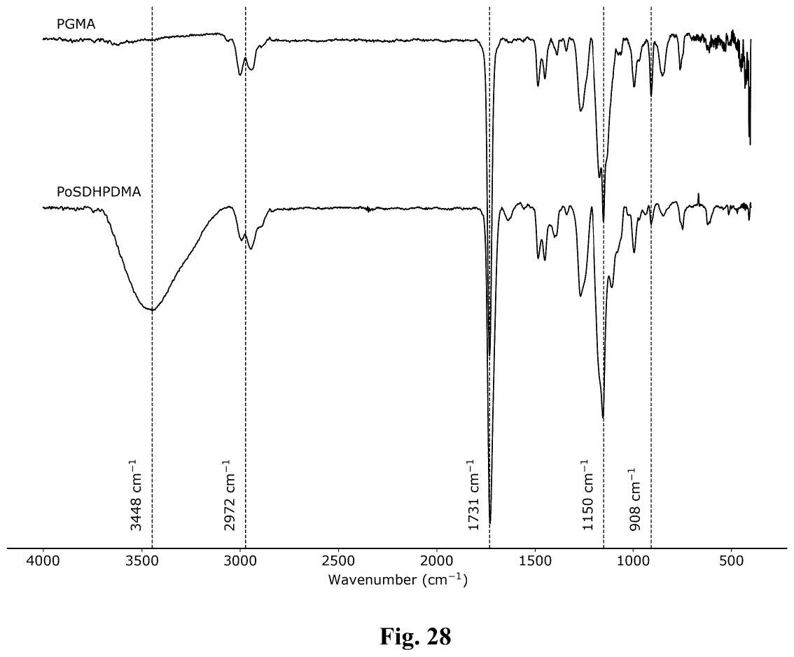

Thus, with an almost full modification of the epoxides of the PGMA repeat units, the post-modified surface polymer is denoted PoSDHPDMA. The abbreviation oSDHPDMA is intended to include both of the possible post-modifications oligo(sulfanediyl)bis(3-hydroxypropane-2,1-diyl) bis(2-methylacrylate) and oligo(sulfanediyl)bis(2-hydroxydpropane-3,1-diyl)bis(2-methacrylate). FIG. 28 shows the T-FTIR spectra of the PGMA surface polymers and the post-modification PoSDHPDMA surface polymers. FIG. 28 is scaled (no y-axis) so as to more clearly show the differences between the two surface polymers. T-FTIR analysis (FIG. 28) confirmed the opening of the epoxide group by polysulfide linkage by disappearance of the peak at 908 cm⁻¹ ascribed to epoxide and the appearance of a new peak at 3448 cm⁻¹ ascribed to —OH group from the opening of epoxide, a by-product of the nucleophilic substitution to the epoxide group. As such the oSDHPDMA repeat unit has been formed by polysulfide linkage between two nearby repeat units containing epoxide groups.

### Example 9

### Post-Modification of PoSDHPDMA Surface Polymer

In this example, the PoSDHPDMA surface polymers prepared in Example 8 were post-modified to thiol groups. The polysulfide of the oSDHPDMA repeat units were in this example reduced to yield thiol groups, thus, denoted 2-hydroxy-3-mercaptopropyl methacrylate (OHMPMA) repeat units.

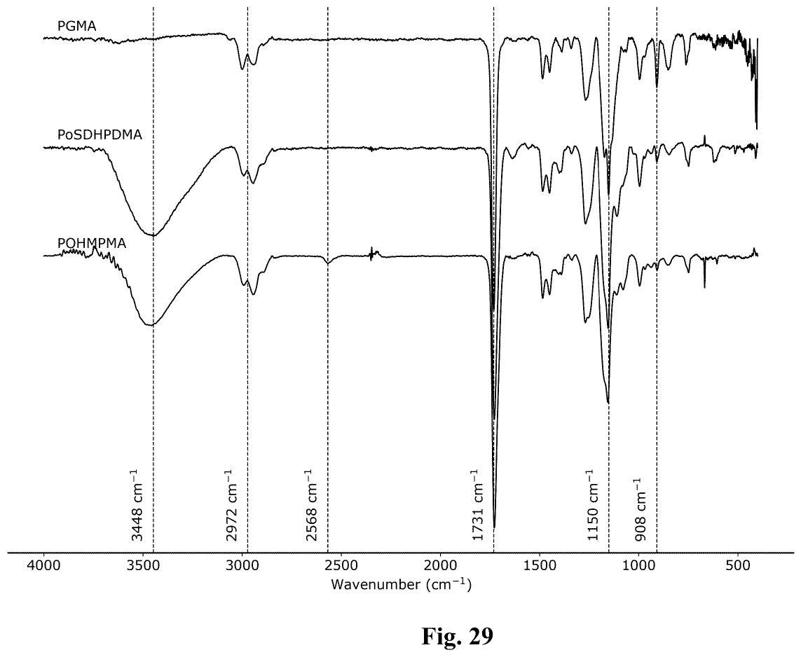

The reductive post-modification chemistry was made as follows: To a reaction container, DI-water (800 mL) was added and the container was purged with argon gas for 30 minutes, while stirring using a magnet stirrer. DTT (3.085 g) was added and stirred until completely dissolved, while purging with argon gas. TEA (2.23 mL) was added and the solution stirred and purged with argon gas for additional 2 minutes. The magnet was removed, and the substrates of Example 8 were placed in the reaction container holding the reductive post-modification chemistry. The headspace of the reaction container was purged with argon gas for 1 minute. The substrates were left for 22 hours. Thereafter, the substrates were withdrawn and dipped into DI-water three times (with a new solution each time), then flushed with acetone, and sonicated in acetone for 10 minutes. The substrates were left to dry at ambient conditions (atmospheric temperature, ambient pressure). By the post-modification, the polysulfide bridges were replaced by SH— (thiol) groups, thus, forming a surface polymer with OHMPMA repeat units (Si-POHMPMA surface polymer). After cleaning and drying, the substrates were subjected to ellipsometry to measure the average dry film thickness of the formed surface polymer. The average dry film thickness was measured to be 108±3 which corresponded to a 4% drop in thickness as compared to the PoSDHPDMA surface polymer of Example 8. The water contact angle of 3 points on 3 substrates was found to be 54±1. FIG. 29 shows the combined T-FTIR spectra of the surface polymers PGMA, PoSDHPDMA and POHMPMA surface polymers. The spectra are scaled (no y-axis) so as to more clearly see the various peaks and the post-modification changes. From the T-FTIR analysis (FIG. 29), a new peak at 2568 cm⁻¹ confirmed the presence of the —SH group resulting from the reduction of the polysulfide. Based on FIG. 29, the inventors conclude that at least some of the plurality of the oSDHPDMA repeat units have been modified to OHMPMA repeat units.

### Example 10

### Post-Modification of Poly(Glycidyl Methacrylate) (PGMA) Surface Polymers

PGMA surface polymers may be post-modified to introduce a plurality of sulfur-containing groups from the epoxide group of the GMA repeat units by hydrolysis to form a surface polymer where the epoxide group is converted into two hydroxyl groups (OH-groups), thus forming a PGMA-OH surface polymer. The OH-groups may subsequently be post-modified to convert at least some of the plurality of OH-groups into thioester groups (sulfur-containing group).

Firstly, the epoxides groups of the PGMA surface polymers may be hydrolyzed to produce two OH-groups by the following procedure: To a reaction container, 35% HCl (17.0 mL) is added to DI-water (800 mL). PGMA surface polymer substrates (e.g., prepared as described in Example 7), are placed in the HCl/DI-water mixture, heated to 60° C. and left for 3.5 hours. Subsequently, the substrates may be immersed in DI-water and sonicated for 5 minutes. Finally, the substates may be left to dry in ambient conditions (ambient temperature, ambient pressure). Following cleaning and drying, the substrates may be subjected to ellipsometry to measure the average dry film thickness of the formed ring-opened surface polymer (PGMA-OH). The average dry film thickness is expected to increase no more than 13% due to the ring opening of the epoxide groups. The water contact angle is expected to decrease, e.g. from 60° to 50°, due to the higher hydrophilicity of —OH groups.

Conversion of the OH groups to thioester groups may be performed as follows: In a glass slide holder, Ph₃P (18.0 g) is added, and the vessel is closed with a septum-lid. A nitrogen atmosphere is introduced, and tetrahydrofuran (THF) (178 mL) is added. The vessel is sonicated in a sonicator until all Ph₃P is dissolved (approx. 1 minute). DIAD (14.0 mL) is added through the septum, and the mixture is agitated on a shaking table (80 rpm) for 1.5 hour. Then, the mixture is cooled to 0° C. in an ice bath. The septum-lid is briefly opened, and substrates (with PGMA-OH surface polymers) are placed in the mixture. The septum-lid is closed, and a nitrogen atmosphere is introduced. AcSH is added through the septum, and the mixture is agitated on a shaking table (80 rpm) for 1 hour with continued cooling. The substrates may be post-cleaned by flushing with saturated aqueous NaHCO₃, sonicating in saturated aqueous NaHCO₃ for 5 minutes, flushing with DI-water, sonicating in DI-water for 5 minutes, flushing with acetone, and sonicating in acetone for 5 minutes. Finally, the substates may be left to dry in ambient conditions (atmospheric temperature and pressure). After cleaning and drying, the substrates may be subjected to ellipsometry to measure the average dry film thickness of the formed sulfur-containing surface polymers (PGMA-SAc). The average dry film thickness is expected to increase no more than 45% due to S-modification of at least some of the plurality of OH-groups. The WCA is expected to increase upon converting PGMA-OH to PGMA-SAc, e.g. approximately from 50° to 70°, due to the lower hydrophilicity of SAc-groups as compared to the OH-groups.

The obtained sulfur-containing surface polymer may be useful as an adhesion promoter for metals, like silver and copper, for example. The inventors suggest that the thioester-modified surface polymer (PGMA-SAc) may be further post-modified to convert the thioester groups to another sulfur-containing group, like thiol groups (SH groups), and that the so obtained sulfur-containing surface polymer may be useful as an adhesion promoter for metals, like silver and copper, for example.

### Example 11

### Formation of Poly(Allyl Methacrylate) (PAMA) Surface Polymers

In this example, PAMA surface polymers were formed. The PAMA surface polymers were pot-modified to introduce a plurality of thioether groups (sulfur-containing groups) into the surface polymer.

The catalyst solution for surface polymer formation was made as follows: To a flask, TPMA (0.256 g), CuOH₂ (24 mg) and DI-water (50 mL) were added, and the flask was capped, equipped with a magnet and left at 50° C. under stirring for 3 hours.

The reaction composition for forming the surface polymer on the substrates was prepared as follows: To a glass container (Container A), DI-water (504 mL), catalyst solution as prepared above (16 mL), EtOH (430 mL) and AMA monomer (30 mL) were added. In a separate container (Container B), a solution of NaAsc (4003 mg in 15 mL DI-water) was prepared. The content of Container B was poured into Container A, and the reaction composition was left for 5 minutes to activate the catalyst/ligand complex for surface polymer formation. CPTMS-modified substrates, e.g., pre-cleaned as described in Example 1 and modified as described in Example 3, were placed in a reaction container and the content of Container A was poured into the reaction container. The substrate was left to react (form surface polymers) for 20 minutes and was then sonicated in DI-water for 5 minutes, before being sonicated for 5 minutes in acetone. Subsequently, the substrates were left to dry at ambient conditions (atmospheric temperature and pressure). After cleaning and drying, the substrates were subjected to ellipsometry to measure the average dry film thickness of the formed (collapsed) surface polymer (PAMA). The average dry film thickness was determined to 60±1 nm.

### Example 12

### Post-Modification of PAMA Surface Polymers

This example shows the post-modification of PAMA surface polymers of Example 11 to form a plurality of the sulfur-containing group thioether.

PAMA surface polymers may be post-modified to introduce a number of 2-(ethylthio)ethyl methacrylate (ETEMA) repeat units into the surface polymer by the following procedure: To a reaction container, ethanethiol (1 mL) and azobisisobutyronitril (0.2 g) is dissolved in 20 mL DMF and degassed for 10 minutes. The solution is heated at reflux and the PAMA surface polymer substrates are immersed into the post-modification chemistry and left for 24 hours under inert atmosphere. The substrates are withdrawn, flushed in DI-water and sonicated for 5 minutes in DI-water. Then, the substrates may be flushed in acetone and sonicated for 5 minutes in acetone. The substrates may be left to dry at ambient conditions (atmospheric temperature and pressure). After cleaning and drying, the substrates may be subjected to ellipsometry to measure the average dry film thickness of the formed PETEMA surface polymers. The average dry film thickness is expected to increase to a maximum 50% as compared to the average dry film thickness of the PAMA surface polymers.

### Example 13

### Formation of Poly(Methyl Methacrylate) (PMMA) Surface Polymers and Post-Modification of Carbonyl Group

In this example, PMMA surface polymers were prepared. The carbonyl group of MMA repeat units were post-modified to replace the double bonded oxygen (C(O)) with a double bonded sulfur.

The reaction composition for forming the surface polymer on the substrate was prepared as follows: To a glass container (Container A), Catalyst M (16 mL of a solution of Me6TREN (76 μL), DI-water (15.924 mL), and Cu(II) (324 mg/L, obtained from a solid copper source by stirring or otherwise mixing prior to mixture with ligand and DI-water), DI-water (484 mL), EtOH (410 mL) and MMA monomer (75 mL) were added. In a separate container (Container B) a solution of NaAsc (4000 mg in 15 mL DI-water) was prepared. The content of Container B was poured into Container A, and the reaction composition was left for 5 minutes to active the catalyst/ligand complex.

14 CPTMS-modified substrates (polymerization initiator CPTMS), pre-cleaned as described in Example 1 and modified as described in Example 3, were placed in a reaction container and the reaction composition of Container A was poured into the reaction container. The substrates were polymerized for 30 minutes and were subsequently dipped in DI-water, then sonicated in DI-water for 5 minutes, before being flushed by acetone, then sonicated in acetone for 5 minutes. Subsequently, the substrates were left to dry at ambient conditions (ambient temperature, ambient pressure). After cleaning and drying, the substrates were subjected to ellipsometry to measure the average dry film thickness of the formed PMMA surface polymer. The average dry film thickness of all substrates was measured to 58±1 nm. The water contact angle of 4 substrates was found to be 65°±0.93°.

### Example 14

### Post-Modification of Acrylic Surface Polymers to Form Thionoesters

Thionoesters may be formed by post-modifying PHEMA surface polymers or PMMA surface polymers.

The agent for the post-modification of PHEMA and PMMA surface polymers into corresponding thionoester surface polymers may be prepared as follows: To a reaction container, Lawesson's reagent (8.089 g, [0.025M]) and DCM (800 mL) is added, and sonicated until dissolved. The substrates (with PHEMA as described in Example 4 and/or with PMMA as described in Example 13) are then submersed and left for between 1 h to 24 h at ambient conditions (atmospheric temperature and ambient pressure). The substrates are withdrawn, flushed with DCM followed by sonication in DCM for 5 minutes, flushed with acetone followed by sonication in acetone for 5 minutes. The substrates may then be left to dry at ambient conditions (atmospheric temperature and pressure).

The double-bonded oxygen of the PHEMA and PMMA is expected to be modified to a double-bonded sulfur, thus, forming a sulfur-containing surface polymer with number of thionoester groups.

The expected increase in average dry film thickness for PMMA and PHEMA is based on mass gain of the surface polymers. The MMA repeat unit has a calculated molecular weight of 116.16 g/mol, whereas the thinoester group-modified MMA repeat unit denoted O-methyl 2-methylprop-2-enethioate has a molecular weight of 132.22 g/mol, corresponding to a 13.8% mass gain. The HEMA repeat unit has a molecular weight of 146.19 g/mol, whereas the thionoester group-modified HEMA repeat unit denoted O-(2-hydroxyethyl) 2-methylprop-2-enethioate has a molecular weight of 162.25 g/mol, corresponding to a 11.0% mass gain. Expected molecular weight is summarized in Table 6.

TABLE 6
Expected increase in molecular weight by post-
modification of PMMA and PHEMA to introduce a thionoester
group. Mₙ denotes molecular weight.

| | Mₙ of repeat unit | Mₙ of repeat unit | |
|---|---|---|---|
| Repeat unit | before post- | after post- | Increase |
| name | modification (g/mol) | modification (g/mol) | (%) |
| MMA | 116.16 | 132.22 | 13.8 |
| HEMA | 146.19 | 162.25 | 11.0 |

The expected change in water contact angle for all sulfur post-modifications is a decrease in water contact angle due to oxygen being more hydrophilic than sulfur.

### Example 15

Controlled incorporation of sulfur-containing repeat units by post-modifying random co-polymers of PHEMA and PGMA

In this example, surface polymers as random co-polymers of PHEMA and PGMA (PHEMA-co-PGMA) are post-modified by specifically post-modifying the GMA repeat units and not the HEMA repeat units.

The catalyst solution was made as follows: To a vial, TPMA (exact amount, see Table 6), CuCl₂ solution (9 mL from a solution of CuCl₂·2H₂O (1513.9 mg) and DI-water (1000 mL)) and EtOH (7 mL) were added, and the vial was capped and sonicated in a sonicator for 5 minutes.

The reaction composition for forming the surface polymer on the substrates was prepared as follows: To a glass container (Container A), DI-water (554 mL), catalyst solution (16 mL), EtOH (340 mL) and GMA monomer and HEMA monomer were added (exact amount, see Table 7). In a separate container (Container B) a solution of NaAsc (exact amount, see Table 7) in 15 mL DI-water) was prepared. The content of Container B was poured into Container A, and the reaction composition was left for 5 minutes to activate the catalyst/ligand complex for surface polymer formation. 3 CPTMS-modified substrates (polymerization initiator CPTMS), modified as described in Example 3, were placed in a reaction container and the reaction composition of Container A was poured into the reaction container. The substrate was left for 20 or 40 minutes in the reaction composition (see Table 7) and was subsequently dipped in DI-water, then sonicated in DI-water for 5 minutes, before being flushed by acetone, then sonicated for 5 minutes in acetone. Additional cleaning was needed, and the substrates were sonicated for 5 min in DMSO, then sonicated for 5 min in acetone. Subsequently, the substrate was left to dry at ambient conditions (ambient temperature, ambient pressure). After cleaning and drying, the substrates were subjected to ellipsometry to measure the average dry film thickness of the formed surface polymer (PGMA surface polymers). The average dry film thicknesses of the 3 substrates are reported in Table 8.

TABLE 7
Composition of reaction compositions
for surface polymer formation.

| | 5% GMA | 20% GMA |
|---|---|---|
| TPMA (mg) | 83.8 | 82.9 |
| GMA (mL) | 22.7 | 90.7 |
| HEMA (mL) | 394 | 332 |
| NaAsc (mg) | 4007.1 | 3997.1 |
| Reaction time (min) | 40 | 20 |

To modify the epoxide groups of GMA into polysulfide repeat units, 3 PHEMA-co-PGMA (5%) and 3 PHEMA-co-PGMA (20%) substrates were subjected to a sulfur post-modification as described in Example 8 (formation of PHEMA-co-PoSDHPDMA (5%) and PHEMA-co-PoSDHPDMA (20%)). The substrates were cleaned as described in Example 8. Ellipsometry was performed on the substrate, and the average dry film thicknesses are reported in Table 8.

To form thiol groups from the polysulfide repeat units, 1 PHEMA-co-PoSDHPDMA (5%) and 1 PHEMA-co-PoSDHPDMA (20%) substrates were subjected to a sulfide reduction bath as described in Example 9, to form thiol post-modification of the above polysulfide-post-modified substrates (formation of PHEMA-co-POHMPMA (5%) and PHEMA-co-POHMPMA (20%)). The substrates were cleaned as described in Example 9. The substrates were subjected to ellipsometry. The average dry film thicknesses are reported in Table 8.

TABLE 8
Average dry film thicknesses.

| | GMA monomer | GMA monomer |
|---|---|---|
| | loading (5%) | loading (20%) |
| PHEMA-co-PGMA | 189 ± 1 | 28 ± 3 |
| PHEMA-co-PoSDHPDMA | 188 ± 1 | 28 ± 3 |
| PHEMA-co-POHMPMA | 191 ± 9 | 23 ± 5 |

For a PHEMA-co-PGMA formed with 5% GMA monomer loading, the average dry film thickness before and after polysulfide modification, does not change significantly (188 to 189 nm).

Similarly, for the reduction of the polysulfide to the thiol group little change is detected. (191 nm) The same trend is observed for PHEMA-co-PGMA formed with a 20% GMA monomer loading: from the polysulfide modification the average dry film thickness does not change from 28 nm and after the reduction of the polysulfide to the thiol the average dry film thickness changes from 28 to 25 nm. Due to the low amount of PGMA repeat units in the surface co-polymer structure, the post-modification thereof yields a very low change to the average dry film thicknesses. Thus, the incorporation of the sulfur-containing groups does not change the overall thickness of the surface polymer significantly, however, the properties of the surface polymer may change significantly in terms of binding of silver (Ag).

### Example 16

### Ag-Addition to Surface Polymers Having a Plurality of Sulfur-Containing Repeat Units

In this example the inventors present a method for binding silver (Ag) to sulfur-containing repeat units of a surface polymer. In this example, post-modified surface polymers, POHMPMA and a PoSDHPDMA, see Example 8 and Example 9, were used for Ag reaction.

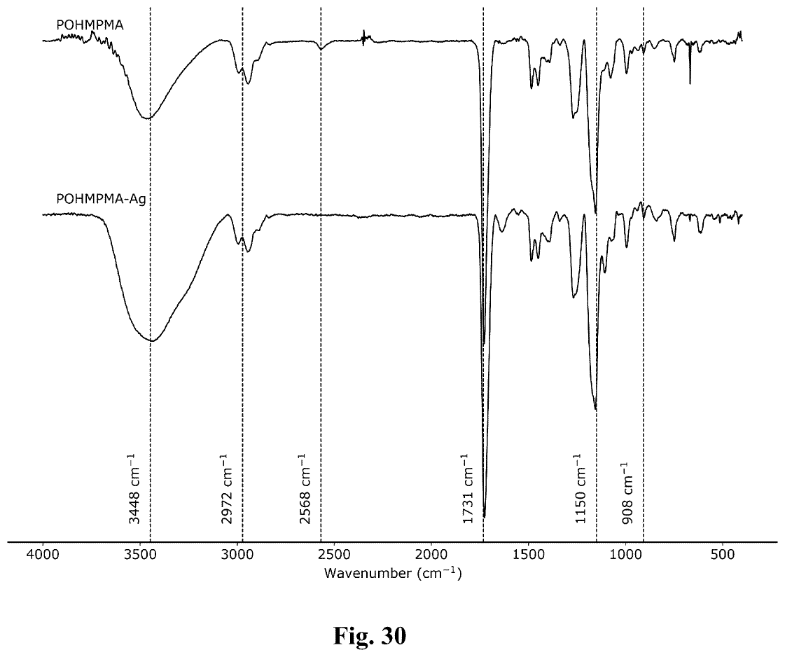

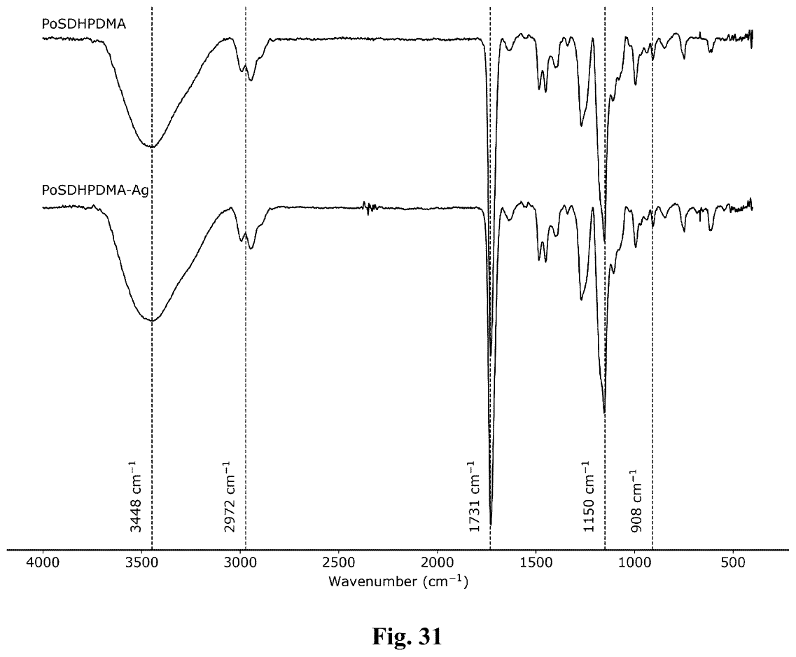

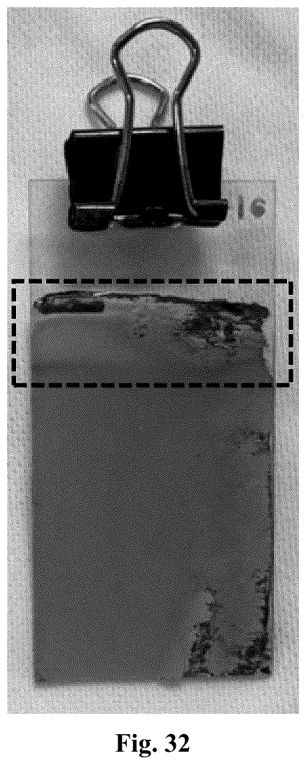

A 1.2 L reaction container, equipped with a lid, wad filled with 1 L DI water and heated to 40° C. under stirring (300 rpm). AgNO₃ (8.49 g) was added to the reaction container. A POHMPMA substrate and a PoSDHPDMA substrate were immersed into the reaction container and left at 40° C. under stirring (300 rpm) for 1 hour. Subsequently, the substrate was cleaned by flushing in DI water, then sonicated for 2 min I DI water before being left to dry at ambient conditions (ambient temperature, ambient pressure). After cleaning and drying, the substrates were subjected to WCA analysis and ellipsometry to measure the average dry film thickness of the surface polymers following Ag reaction, see Table 9. The substrates were also subjected to T-FTIR to analyze the chemical composition of the Ag reacted with the surface polymer. The T-FTIR spectra are shown in FIG. 30 and FIG. 31. The substrates were subjected to WCA to analyze a potential change in hydrophobicity of the surface polymer film after Ag reaction (see Table 9). Finally, the substrates were analyzed using XPS to get an elemental analysis of the surface polymer film and investigate the redox state of the Ag (see Table 10).

TABLE 9
Average dry film thickness and WCA before and after Ag reaction.

| | Average dry film thickness (nm) | | WCA (°) | |
|---|---|---|---|---|
| | Before | After | Before | After |
| Surface | Ag | Ag | Ag | Ag |
| polymer | reaction | reaction | reaction | reaction |
| PoSDHPDMA | 111 ± 3 | 122 ± 4 | 59 | 26 |
| POHMPMA | 110 ± 3 | 131 ± 4 | 53 | 45 |

From Table 9, the results from the Ag reaction with the PoSDHPDMA and POHMPMA substrates are reported. From measurements of the average dry film thickness, a clear change was observed: After Ag reaction the average dry film thickness increased with approximately 10 nm in the case of PoSDHPDMA, and with approximately 20 nm in the case of POHMPMA, which is consistent with Ag being captured in the surface polymer. Furthermore, the WCA drops significantly, from 59 to 26 (PoSDHPDMA) and from 53 to 45 (POHMPMA). This significant drop in WCA indicates that Ag coordinated to the surface polymer, thus, making the surface polymer more hydrophilic.

FIG. 30 and FIG. 31 show the T-FTIR spectra of POHMPMA and POHMPMA-Ag surface polymers, and PoSDHPDMA and PoSDHPDMA-Ag surface polymers, respectively. The T-FTIR spectra are scaled (no y-axis) to better illustrate the differences between the surface polymer before Ag reaction and after Ag reaction. The spectra peak positioned between 1770 and 1660 (the carbonyl peak (C═O)) was used to normalize the spectra by scaling the y-values. From the T-FTIR analysis (FIG. 30 and FIG. 31) changes to the chemical structure were observed.

In FIG. 12. shows the T-FTIR analysis of POHMPMA The peaks at 908, 1150, 1731 and 2972 cm⁻¹ remain constant before and after Ag reaction showing the overall polymer structure was unaffected by the Ag reaction. The peak at 2568 cm⁻¹, the —SH peak (thiol peak), vanishes after reaction with Ag supporting that both the thiol and Ag(+) undergo a redox reaction resulting the formation of disulfide bridges between two POHMPMA repeat units and Ag(0). Additionally, an increase in peak size of the 3448 cm⁻¹ peak, shows changes to the —OH group (the hydroxyl group), indicating that the presence of Ag(0) changed vibrational state of the hydroxyl group. The inventors speculate that upon entering the surface polymer structure, the thiol and Ag(+) undergo a redox reaction resulting in a reduction of the Ag(+) to Ag(0) and an oxidation of the thiol. The oxidation of the thiol is believed to result in the formation of the sulfur-sulfur bridge with a near-by thiol. To summarize, based on the T-FTIR analysis, when Ag(+) enters the surface polymer POHMPMA, Ag(+) is reduced to Ag(0) during formation of sulfur-bridges.

In FIG. 31, the T-FTIR analysis of the PoSDHPDMA surface polymer is shown. The peaks at 908, 1150, 1731 and 2972 cm⁻¹ remain constant showing no change to the overall surface polymer structure. A small change in size of the 3448 cm⁻¹ peak shows changes to the —OH group (the hydroxyl group) as the presence of Ag(+) changes the vibrational state of the hydroxyl group.

TABLE 10
XPS analysis of surface polymers before and after reaction with Ag. Atomic percentage
from elemental analysis of PoSDHPDMA and POHMPMA surface polymer films before
and after Ag reaction. In XPS, Ag metal (Ag(0)) may be differentiated clearly
from Ag salts and Ag oxides by the binding energy, thus, Ag(+) has a binding
energy of 367.5 eV and Ag(0) has a binding energy of 368.2 eV.

| | | | | | Ag 3d peak |
|---|---|---|---|---|---|
| | C 1s (%) | O 1s (%) | S 2p (%) | Ag 3d (%) | position (eV) |
| PoSDHPDMA | 65.1 ± 0.1 | 21.4 ± 0.0 | 13.6 ± 0.1 | — | 367.6 ± 0.2 |
| PoSDHPDMA-Ag | 59.1 ± 0.3 | 23.3 ± 0.4 | 10.6 ± 0.1 | 7.2 ± 0.1 | |
| POHMPMA | 66.0 ± 0.3 | 22.9 ± 0.1 | 9.4 ± 0.2 | — | 368.2 ± 0.1 |
| POHMPMA-Ag | 60.3 ± 0.2 | 23.6 ± 0.1 | 8.8 ± 0.1 | 7.3 ± 0.0 | |

From the XPS analysis (see Table 10), the elemental structure of the surface polymer PoSDHSPDMA before and after Ag reaction was analyzed. After Ag reaction, a content 7% of Ag in the surface polymer was observed, indicating that Ag in fact has been added to the surface polymer film. From the peak position (the binding energy in eV) of Ag infused in the surface polymer film (367.6±0.2 eV), the redox state of Ag was to concluded to be Ag(+).

From the XPS analysis of the POHMPMA surface polymer (see Table 10), an Ag content of 7% in the surface polymer was found. Furthermore, from the peak position (the binding energy) of Ag in the surface polymer film (368.2±0.1 eV), the redox state of Ag was concluded to be Ag(0). This is further supported by the T-FTIR analysis, confirming conversion of the thiol groups to sulfur-bridges and reduction of Ag ions to metallic Ag.

Based on the above, it has been shown that Ag is able to bind to sulfur-containing groups in a surface polymer. Furthermore, the inventors find a unique potential in the addition of Ag to thiol-containing surface polymers. Metallic Ag (Ag(0)) may indeed be formed in the surface polymer. Simultaneously the surface polymer is cross-linked (via polysulfide bridges) resulting in high retention potential of the Ag, as the cross-linking (polysulfide bridges) interlock the metallic Ag in the surface polymer. The inventors, thus, suggest a potential function of Ag (metallic or ionic) as “seeding layer” for electroless deposition of metals (like copper (Cu), for example).

### Example 17

### Ag-Addition to Surface Polymers Having a Plurality of Sulfur-Containing Repeat Units

In this example the inventors present a method for controlling the addition of Ag in surface polymers having a plurality of sulfur-containing repeat units. To control the amount of added Ag, the inventors tested a time skew (5, 10 and 60 minutes) at high concentration of silver (Ag), 0.1M (8.5 g AgNO3), and at low concentration of silver (Ag), 0.01M (0.85 g AgNO3). The surface polymers used for this experiment were POHMPMA and PoSDHPDMA substrates.

A 1.2 L reaction container (one for each of the two AgNO₃ concentrations), equipped with a lid, wad filled with 1 L DI-water and heated to 40° C. under stirring (300 rpm). AgNO₃ in the above specified amounts was added to the reaction containers. POHMPMA substrates prepared as described in Example 9 and PoSDHPDMA substrates prepared as described in Example 8 were immersed into each reaction container and left at 40° C. under stirring (300 rpm) during the reaction time (a substrate from each reaction container was withdrawn at minutes 5, 10, and 60 minutes). Following withdrawal, the substrates were cleaned by flushing with DI water, then sonicated in DI water for 2 min before being left to dry at ambient conditions (ambient temperature, ambient pressure). After cleaning and drying, the substrates were subjected to ellipsometry to measure the average dry film thickness of the surface polymers with Ag (see Table 11). The substrates were further analyzed using XPS to get an elemental analysis of the surface polymer film and investigate the redox state of the Ag (see Table 12).

TABLE 11
Average dry film thickness before and after reaction with Ag (high
and low concentration of AgNO₃). For PoSDHPDMA surface polymer and
POHMPMA surface polymer 3 substrates for each surface polymer were reacted
with AgNO₃ (substrate 1 was withdrawn after 5 minutes, substrate
2 after 10 minutes, and substrate 3 after 60 minutes).

| | Substrate no./ | | | |
|---|---|---|---|---|
| | Average dry film | | Average dry film | |
| | thickness before | Reaction time | thickness after | Difference |
| Substrate | Ag reaction (nm) | (min) | Ag reaction (nm) | (nm) |
| PoSDHPDMA- | 1/113 ± 2 | 5 | 116 ± 3 | 3 |
| Ag (0.1M) | 2/116 ± 2 | 10 | 119 ± 3 | 3 |
| | 3/111 ± 2 | 60 | 118 ± 4 | 7 |
| POHMPMA- | 1/104 ± 2 | 5 | 119 ± 3 | 15 |
| Ag (0.1M) | 2/111 ± 2 | 10 | 126 ± 3 | 15 |
| | 3/111 ± 2 | 60 | 129 ± 2 | 18 |
| PoSDHPDMA- | 1/108 ± 3 | 5 | 110 ± 3 | 2 |
| Ag (0.01M) | 2/112 ± 3 | 10 | 115 ± 3 | 3 |
| | 3/111 ± 3 | 60 | 114 ± 4 | 3 |
| POHMPMA- | 1/107 ± 2 | 5 | 116 ± 3 | 9 |
| Ag (0.01M) | 2/105 ± 2 | 10 | 115 ± 2 | 10 |
| | 3/111 ± 1 | 60 | 126 ± 2 | 15 |

TABLE 12
XPS analysis of substrates following
5 minutes reaction with AgNO₃.

| Substrate | C 1s | 0 1s | S 2p | Ag 3d |
|---|---|---|---|---|
| PoSDHPDMA-Ag | 65.1 ± 0.1 | 21.5 ± 0.1 | 12.9 ± 0.2 | 0.5 ± 0.0 |
| (0.01M) | | | | |
| POHMPMA-Ag (0.01M) | 66.0 ± 0.3 | 22.9 ± 0.1 | 9.4 ± 0.2 | 1.6 ± 0.1 |

In Table 11 the average dry film thicknesses of PoSDHPDMA and POTIMPMA are shown. In case of PoSDHPDMA, it is seen that the increase in average dry film thickness before and after Ag reaction both at high and low Ag concentrations are quite low at reaction times of 5 and 10 minutes, respectively. A significant increase in average dry film thicknesses was observed for 60 minutes reaction times. However, the low Ag concentration ([Ag]=0.01M) seemed in general to result in low Ag uptake.

In case of the POTIMPMA substrates, dip in a high Ag concentration solution ([Ag]=0.1 M), resulted in a significant increase in average dry film thickness for low reaction times (5 and 10 minutes, respectively) and an increase of 18 nm for a reaction time of 60 minutes. This suggests, in the inventors' opinion, a logarithmic uptake of Ag with an initially very fast uptake of Ag followed by a slow accumulation. For POTIMPMA substrates, a solution of Ag in low concentration ([Ag]=0.01M) resulted in a linearly increasing average dry film thickness as a function of reaction time which indicating a linear Ag uptake.

In Table 12 the atomic percentage from the XPS analysis of substrates using low Ag concentration and a reaction time of 5 minutes is shown. From the analysis, the lower limit of achievable Ag content may be estimated. The PoSDHPDMA substrate has the lowest Ag uptake at these conditions ([Ag]=0.01 M and 5 minutes reaction time) with only 0.5% of Ag in the surface polymer. The POHMPMA has a higher Ag uptake of 1.6% ([Ag]=0.01 M and 5 minutes reaction time).

In conclusion, the Ag uptake and, thus, Ag content, may be controlled by varying Ag concentration and/or reaction times.

### Example 18

### Ag-Addition to Surface Polymers Having Sulfur-Containing Repeat Units Presented as Random Block Co-Polymers

In this example, the surface polymers of Example 15 (PHEMA-co-PoSDHPDMA (5%) and PHEMA-co-PoSDHPDMA (20%)) were subjected to reaction with Ag. These surface polymers have a lower portion of sulfur-containing repeat units as compared to the surface polymers in Example 17.

A 1.2 L reaction container, equipped with a lid, was filled with 1 L DI-water and heated to 40° C. under stirring (300 rpm). AgNO₃ (8.5 g) was added to the reaction container. 2 PHEMA-co-PoSDHPDMA (5%) substrates, 2 PHEMA-co-PoSDHPDMA (20%) substrates, 1 PHEMA-co-POHMPMA (5%) substrate, and 1 PHEMA-co-POHMPMA (20%) substrate, prepared according to Example 15 were submersed into the reaction container and left at 40° C. under stirring (300 rpm) for the reaction time of 1 hour. Subsequently, the substrates were cleaned by flushing in DI water, then sonicated for 2 min in DI water before being left to dry at ambient conditions (ambient temperature, ambient pressure). After cleaning and drying, the substrates were subjected to ellipsometry to measure the average dry film thickness of the surface polymers on the substrates (see Table 13). Subsequently, the substrates were analyzed using XPS to get an elemental analysis of the surface polymer film with Ag and investigate the redox state of the Ag (see Table 14).

TABLE 13
Average dry film thicknesses before and after Ag reaction.

| | Thickness before | Thickness after |
|---|---|---|
| Substrate | Ag reaction (nm) | Ag reaction (nm) |
| PHEMA-co-PoSDHPDMA(5%) | 189 ± 7 | 188 ± 19 |
| PHEMA-co-POHMPMA(5%) | 191 ± 9 | 187 ± 20 |
| PHEMA-co-PoSDHPDMA(20%) | 27 ± 3 | 28 ± 4 |
| PHEMA-co-POHMPMA(20%) | 23 ± 5 | 24 ± 5 |

TABLE 14
Atomic percentages from elemental analysis after Ag reaction.

| Substrate | C 1s | O 1s | S 2p | Ag 3d |
|---|---|---|---|---|
| PHEMA-co- | 71.0 ± 0.3 | 27.4 ± 0.4 | 1.1 ± 0.1 | 0.6 ± 0.0 |
| PoSDHPDMA(5%) | | | | |
| PHEMA-co- | 71.0 ± 0.4 | 27.9 ± 0.4 | 0.6 ± 0.1 | 0.5 ± 0.1 |
| POHMPMA(5%) | | | | |
| PHEMA-co- | 68.0 ± 0.1 | 25.7 ± 0.1 | 3.9 ± 0.2 | 2.4 ± 0.0 |
| PoSDHPDMA(20%) | | | | |
| PHEMA-co- | 62.9 ± 4.5 | 26.3 ± 0.4 | 4.4 ± 1.6 | 1.8 ± 0.2 |
| POHMPMA(20%) | | | | |

Table 13 shows the average dry film thicknesses before and after Ag reaction. For all tested co-polymers (PTHMA-co-PoSDHPDMA(5%), PTHMA-co-POHMPMA(5%), PTHEMA-co-PoSDTIPDMA(20%) and PTIEMA-co-POTIMPMA(20%)) changes to the average dry film thicknesses were low to non-existing within the standard deviation. As observed in Example 17 this is expected for surface polymers with a low Ag content.

In Table 14, the atomic percentages from the NXPS analysis of surface polymers with a controlled sulfur-containing repeat units are shown. As expected, the 5% substates (PHEMA-co-PoSDHPDMA(5%) and PHEMA-co-POTIMPMA(5%)) contained the lowest Ag content (0.5-0.6%) independent of the type of sulfur-containing group (polysulfide or thiol). Increasing the content of sulfur-containing groups to 20% (PTIEMA-co-POSDTIPDMA(20%) and PHEMA-co-POTIMNPMA(20%)) resulted in Ag content being increased from 0.6% to 2.4% and 1.8% for PTIEMA-co-POSDTIPDMA(20%) and PTIEMA-co-POTIMPMA(20%), respectively. With these results the inventors have illustrated an alternative method for controlling the Ag uptake.

### Example 19

Copper Deposition with Surface Polymers with Sulfur-Containing Repeat Units

In this example, surface polymers with sulfur-containing repeat units with Ag content were investigated in an electroless copper (Cu)-deposition experiment. In this experiment, no palladium (Pd) sensitizing was used.

Substrate for Cu electroless deposition was prepared as follows: 1 Eagle glass (EG) substrates, pre-cleaned as described in Example 2 and modified with polymerization initiator CPTMS as described in Example 3 was used for formation of PGMA surface polymers as described in Example 8, post-modified into a PoSDHPDMA surface polymer as described in Example 7, and reduced to form a POHMPMA surface polymer as described in Example 9. The so obtained sulfur repeat unit-containing surface polymer was reacted with Ag as described in Example 16.

For depositing of copper on the POHMPMA-Ag surface polymer, the substrates were subjected to electroless Cu-deposition according to the following procedure:
Reduction of any Ag ions to Ag(0): 10 mL of Uyemura ALCUP MAB-435-D was added to 600 mL DI-water. Then, 50 mL of Uyemura ALCUP MAB-435-C was added and the solution was mixed well. Then, 17 mL of Uyemura ALCUP MAB-435-AX was added and the solution was mixed well. DI-water was added until reaching a total volume of 1 L, and the pH of this bath was determined to 6.5. The solution was heated to 35° C. while stirring. Substrates placed vertically in a PTFE rack were immersed into the solution for 120 minutes, with continued stirring. Substrates were then withdrawn and post-cleaned by two consecutive dips into separate vessels containing DI-water while stirring at ambient temperature for 2 minutes and 1 minute, respectively.

Accelerator step: Following the reduction step, 50 mL of Uyemura ALCUP MEL-437-M was added to 950 mL DI-water to reach a total volume of 1 L. The pH was determined to 2. Substrates placed vertically in a PTFE rack were added to the solution for 1 minute with continued stirring at ambient temperature. Substrates were recovered and immediately subjected to electroless copper deposition (see the following).

Electroless Cu-deposition: To 650 mL of DI-water, the following components were added in the mentioned order. Between each component addition, the mixture was mixed thoroughly. 1) 100 mL of Uyemura THRU-CUP PEA-531-A. 2) 50 mL of THRU-CUP PEA-531-B. 3) 14 mL of THRU-CUP PEA-531-C. 4) 12 mL of THRU-CUP PEA-531-D. 5) 50 mL of THRU-CUP PEA-531-E. 6) 5 mL of formaldehyde 37% (15% methanol) from ACME analytical. 7) DI-water was added to a total volume of 1 L, and the solution was heated to 40° C. Substrates were placed vertically in a PTFE rack in the solution for 20 hours while agitating by rocking (±2.5 cm), shocking (agitator with a frequency of 1 cycle per 6 seconds), and bubbling with clean dry air (CDA) at 50-100 mL/minute. Substrates were post-cleaned by two consecutive dips into separate vessels containing DI-water while stirring at ambient temperature for 2 minutes and 1 minute, respectively.

After the electroless Cu-deposition, the deposited Cu layer was evaluated for continuity over the substrate surface. FIG. 32 is a picture of the substrate following electroless Cu-deposition. The substrate appeared shiny and copper-colored (orange), however, defects were observed in the lower right corner of the substrate, possibly due to cutting of the substrate to smaller size substrates (50×25×0.7 mm) before electroless Cu-deposition. By the cutting, the surface polymer layer (which was pre-formed on the full size substrate) may have been damaged, causing the defects seen in the bottom right corner. This is also supported by the substrate being homogenously coated with copper in the middle and lower left part of the substrate. These parts of the substrate have been fully submersed into the electroless deposition solution. The top part of the substrate (marked in a dashed box in FIG. 32) shows signs of defects as well; however, this part of the substrate has only been partially submersed into the electroless deposition solution causing incomplete electroless copper deposition.

### Example 20

Copper Deposition with Sulfur-Containing Surface Polymers

In this example illustrates, surface polymers with sulfur-containing repeat units with a certain Ag content were investigated in an electroless copper (Cu)-deposition experiment. For this experiment, a palladium (Pd) catalyst step was included.

Surface polymers with sulfur-containing groups and Ag were prepared as follows: 2 Eagle glass (EG) substrates, pre-cleaned as described in Example 2 and modified with polymerization initiator CPTMS as described in Example 3 were coated with a PGMA surface polymer as described in Example 8, post-modified into a PoSDHPDMA surface polymer as described in Example 7, and one PoSDHPDMA substrate was reduced to form a POHMPMA surface polymer as described in Example 9. The so obtained surface polymers with sulfur-containing repeat units were reacted with Ag as described in Example 16, forming PoSDHPDMA-Ag and POHMPMA-Ag surface polymer substrates.

The electroless Cu-deposition was performed as described below.

Sensitization step (Pd seeding): Aqueous NaOH (1.5 mL, 50% w/w from ACME analytical) was added to 900 mL DI-water. Then 50 mL of Uyemura ALCUP MAT-433-SP (Product Code 9100468) was added, followed by the addition of water until reaching a total volume of 1 L. The solution was heated to 40° C. for 1 hour while stirring, and the pH was adjusted to 10.5 with NaOH. Surface polymer substrates placed vertically in a PTFE rack were left in the solution for a sensitization time of 5 minutes, with continued stirring. Substrates were post-cleaned by two consecutive dips into separate vessels containing DI-water while stirring at ambient temperature for 2 minutes and 1 minute, respectively.

Reduction step (reduction of Pd ions to Pd(0)): 10 mL of Uyemura ALCUP MAB-435-D was added to 600 mL DI-water. Then, 50 mL of Uyemura ALCUP MAB-435-C was added and the solution was mixed well. Then, 17 mL of Uyemura ALCUP MAB-435-AX was added and the solution was mixed well. DI-water was added until reaching a total volume of 1 L, and the pH of this bath was determined to 6.5. The reaction composition was heated to 35° C. while stirring. Substrates placed vertically in a PTFE rack were added to the solution and left for 3 minutes, with continued stirring. Substrates were post-cleaned by two consecutive dips into separate vessels containing DI-water while stirring at ambient temperature for 2 minutes and 1 minute, respectively.

Accelerator step: Following the reduction step, 50 mL of Uyemura ALCUP MEL-437-M was added to 950 mL DI-water to reach a total volume of 1 L. The pH was determined to 2. Surface polymer substrates placed vertically in a PTFE rack were added to the solution and left for 1 minute with continued stirring at ambient temperature. Substrates were recovered and immediately subjected to electroless Cu-deposition (see below).

Electroless Cu-deposition: To 650 mL of DI-water, the following components were added in the mentioned order. Between each component addition, the solution was mixed thoroughly. 1) 100 mL of Uyemura THRU-CUP PEA-531-A. 2) 50 mL of THRU-CUP PEA-531-B. 3) 14 mL of THRU-CUP PEA-531-C. 4) 12 mL of THRU-CUP PEA-531-D. 5) 50 mL of THRU-CUP PEA-531-E. 6) 5 mL of formaldehyde 37% (15% methanol) from ACME analytical. 7) DI-water was added to a total volume of 1 L, and the solution was heated to 40° C. The substrates were immersed in the solution vertically in a PTFE rack for 20 minutes while agitating by rocking (±2.5 cm), shocking (agitator with a frequency of 1 cycle per 6 seconds), and bubbling with clean dry air (CDA) at 50-100 mL/minutes. The substrates were post-cleaned by two consecutive dips into separate vessels containing DI-water while stirring at ambient temperature for 2 minutes and 1 minute, respectively.

After the electroless copper (Cu) deposition, the deposited Cu layers were evaluated for continuity over the substrate surface using optical microscopy and were found to be satisfactory with no or limited defects such as uneven layers, blisters, or flaking.

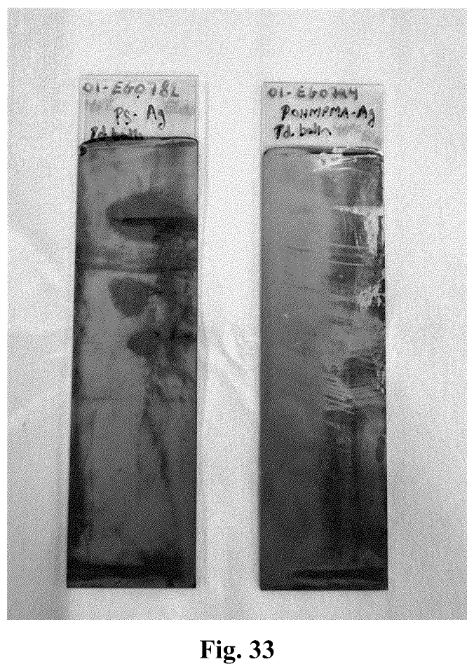

Following the electroless deposition of Cu, the substrates were annealed at 300° C. (vacuum) for 30 minutes using a Yield Engineering Systems PB-450 vacuum cure system. A ramp rate of approximately 3.3° C. per minute was used, and the total anneal time was approximately 275 minutes. After the electroless copper (Cu) annealing, the deposited Cu layers were evaluated for continuity over the substrate surface using optical microscopy. In FIG. 33, the substrates are shown (left—PoSDHPDMA-Ag surface polymer substrate (marked “PS-Ag”), and right—marked POHMPMA-Ag surface polymer substrate (marked“POHMPMA-Ag”)) following electroless Cu-deposition and annealing. The substrates appeared shiny and copper-colored (orange). The darker areas on the substrates shown in FIG. 33 are reflections from photographing. It was concluded that the sulfur-containing surface polymers could indeed facilitate electroless Cu, also following an initial deposition of Pd.

### Example 21

### Comparative Example: Ag-Addition Having No Sulfur-Containing Repeat Units

In this example, surface polymers with no sulfur-containing repeat units were subjected to reaction with Ag. The purpose of this experiment was to confirm that the presence of sulfur-containing repeat units in the surface polymer facilitates and enhances Ag uptake.

A 1.2 L reaction container, equipped with a lid, was filled with 1 L DI-water and heated to 40° C. under stirring (300 rpm). AgNO₃ (8.5 g) was added to the reaction container. 1 PHEMA substrate as prepared according to Example 4 were submersed into the reaction container and left at 40° C. under stirring (300 rpm) for the reaction time of 1 h. Subsequently, the substrate was flushed with DI-water and sonicated for 2 min in DI-water before being left to dry at ambient conditions (ambient temperature and ambient pressure). After cleaning and drying, the substrates were subjected to ellipsometry to measure the average dry film thickness of the surface polymers on the substrates. Subsequently, the substrates were analyzed using XPS to get an elemental analysis of the surface polymer film with Ag.

From ellipsometry measurements little change to the average dry film thickness after Ag reaction was observed (before: 108±2 nm and after: 106±2 nm) indicating that little Ag (0.1%) is bound to the surface. XPS analysis (Table 15) confirmed that no Ag was present.

TABLE 15
XPS analysis of substrate.

| Substrate | C 1s (%) | O 1s (%) | Ag 3d (%) |
|---|---|---|---|
| PHEMA-Ag | 72.3 ± 0.1 | 27.7 ± 0.1 | 0.1 ± 0.0 |

Thus, it was concluded that the presence of Ag in the surface polymer as shown in previous Examples is indeed associated directly linked to the presence of sulfur-containing groups in the surface polymer

### LIST OF REFERENCE NUMERALS

100 System
102 Substrate
103 Substrate displacement device
104 Reaction composition container
105 Reaction composition
106 Container
107 Polymerization initiator chemistry
109 Annealing oven
114 Cleaning container
116 Cleaning agent/device
118 Roll-to-roll processor
120 Roller
121 Sending roll
122 Receiving roll
123 Flexible elongated substrate
310 Substrate
320 Polymerization initiation sites
330 Surface polymer molecules
340 Sulfur-containing groups
350 Surface polymer film
360 Metal-sulfur binding (such as palladium catalyst, copper, etc.)
400 Metal layer
410 Electroless metal (such as copper) deposited within the surface polymer film
420 Electroless metal (such as copper) deposited over the surface polymer film

1. A surface polymer comprising a plurality of repeating units, wherein some of the plurality of repeating units comprises a sulfur-containing group.

2. The surface polymer of claim 1, wherein the sulfur-containing group is a polysulfide group, a thiol group, a thioether group, a thionoester group, or a thioester group.

3. The surface polymer of claim 1, wherein the sulfur-containing group has the formula (I) 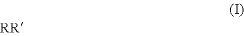
wherein R-R′ is covalently bound to the surface polymer, and wherein R is selected from —(S)ₙ, wherein n is an integer from 1 to 8, —S—C(O), or —C(S)—O, with R′ being selected from a bond (“−”), —H, —CH₃, —CH₂CH₃, —CH₂CH₂OH, and —C(O)—.

4. The surface polymer of claim 3, wherein
the sulfur-containing group is a polysulfide of the formula (Ia): 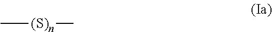
corresponding to formula (I) with R being —(S)ₙ, where n=2 to 8, and R′ being a bond,
the sulfur-containing group is a thiol group of the formula (Ib): 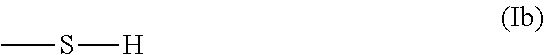
corresponding to formula (I) with R being —(S)ₙ (n=1), and R′ being —H,
the sulfur-containing group is a thioether group with the formula (Ic): 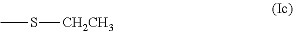
corresponding to formula (I) with R being —(S)ₙ (n=1), and R′ being —CH₂CH₃,
the sulfur-containing group is a thionoester of the formula (Id): 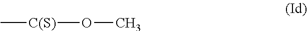
corresponding to formula (I) with R being —C(S)—O, and R′ being —CH₃, or
the sulfur-containing group is a thioester group of the formula (Ie): 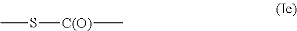
corresponding to formula (I) with R being —(S)ₙ (n=1), and R′ being —C(O)—.

5-6. (canceled)

7. The surface polymer of claim 1, wherein metal atoms and/or metal ions are bound to sulfur of the sulfur-containing group.

8. The surface polymer of claim 7, wherein the metal atoms are selected from copper (Cu), silver (Ag), palladium (Pd), or gold (Au).

9. A device structure comprising:
a substrate with a first surface; and
a surface polymer film comprising surface polymer molecules on at least a portion of a first surface, the surface polymer molecules comprising a plurality of repeating units,
wherein at least some of the plurality of repeating units comprise a sulfur-containing group, and wherein at least some of the sulfur-containing groups bind to metal atoms, and
a metal layer at least partially within, and also over, the surface polymer film,
wherein the layer of metal is attached to the surface polymer film through bonding of metal atoms of the metal layer to metal atom-bound sulfur in the sulfur-containing groups of the surface polymer.

10. The device structure of claim 9, wherein the metal atoms of the sulfur-containing groups are selected from copper (Cu), silver (Ag), palladium (Pd) and/or gold (Au).

11. The device structure of claim 9, wherein the metal layer is selected from copper (Cu), silver (Ag), palladium (Pd) and/or gold (Au).

12. The device structure of claim 9, wherein the metal atoms of the sulfur-containing groups and the metal layer within and over the surface polymer film are bonded through an electroless process.

13. The device structure of claim 9, wherein the metal atoms of the sulfur-containing groups are selected from silver (Ag) and/or palladium (Pd).

14. The device structure of claim 9, wherein the metal layer is copper (Cu).

15. The device structure of claim 9, wherein the sulfur-containing group is a polysulfide group, a thiol group, a thioester group, a thionoester group, or a thioether group.

16. The device structure of claim 15, wherein the sulfur-containing group has the formula (I) 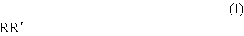
wherein -R-R′ is covalently bound to the surface polymer film, and wherein R is selected from —(S)ₙ, wherein n is an integer from 1 to 8, —S—C(O), or —C(S)—O, with R′ being selected from a bond (“−”), —H, —CH₃, —CH₂CH₃, —CH₂CH₂OH, and —C(O)—.

17. The device structure of claim 16, wherein
the sulfur-containing group is a polysulfide of the formula (Ia): 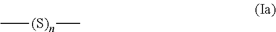
corresponding to formula (I) with R being (S)ₙ, where n=2 to 8, and R′ being a bond,
the sulfur-containing group is a thiol group of the formula (Ib): 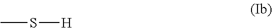
corresponding to formula (I) with R being (S)ₙ (n=1), and R′ being —H,
the sulfur-containing group is a thioether group with the formula (Ic): 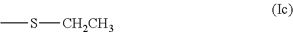
corresponding to formula (I) with R being (S)ₙ (n=1), and R′ being —CH₂CH₃,
the sulfur-containing group is a thionoester of the formula (Id): 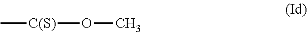
corresponding to formula (I) with R being C(S)—O, and R′ being —CH₃, or
the sulfur-containing group is a thioester group of the formula (Ie): 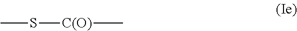
corresponding to formula (I) with R being S, and R′ being —C(O)—.

18-20. (canceled)

21. A method for preparing a surface polymer comprising a plurality of repeating units, wherein some of the plurality of repeating units comprises a sulfur-containing group, the method comprising:
providing a substrate,
exposing at least a portion of the surface of the substrate to a polymerization initiator; and
exposing the substrate to a reaction composition comprising:
a monomer,
a catalyst,
a ligand,
a catalyst activator, and
a solvent,
to form surface polymers on at least the portion of the surface of the substrate; and
post-modifying the surface polymer to form sulfur-containing groups on at least some of the plurality of the repeating units.

22. The method of claim 21, wherein at least some of the —OH groups, carbonyl groups, allyl groups, or epoxide groups of the surface polymer is post-modified to polysulfide groups, thiol groups, thioester groups, thionoester groups, or thioether groups.

23. The method of claim 21, wherein the sulfur-containing group is a thiol group, a thioester group, a thionoester group, or a thioether group.

24. The method of claim 21, wherein the sulfur-containing group has the formula (I) 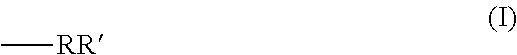
wherein -R-R′ is covalently bound to the surface polymer, and wherein R is selected from (S)ₙ, wherein n is an integer from 1 to 8, S—C(O), or C(S)—O, with R′ being selected from a bond (“−”), —H, —CH₃, —CH₂CH₃, —CH₂CH₂OH, and —C(O)—.

25. The method of claim 21, wherein
the sulfur-containing group is a polysulfide of the formula (Ia): 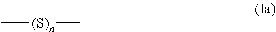
corresponding to formula (I) with R being (S)ₙ, where n=2 to 8, and R′ being a bond,
the sulfur-containing group is a thiol group of the formula (Ib): 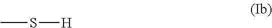
corresponding to formula (I) with R being (S)ₙ (n=1), and R′ being —H,
the sulfur-containing group is a thioether group with the formula (Ic): 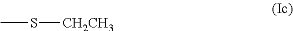
corresponding to formula (I) with R being (S)ₙ (n=1), and R′ being —CH₂CH₃,
the sulfur-containing group is a thionoester of the formula (Id): 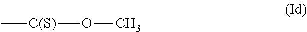
corresponding to formula (I) with R being C(S)—O, and R′ being —CH₃, or
the sulfur-containing group is a thioester group of the formula (Ie): 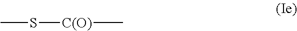
corresponding to formula (I) with R being S, and R′ being —C(O)—.
